(19) United States
(12) Patent Application Publication
(10) Pub. No.: US 2025/0117779 A1
(43) Pub. Date: Apr. 10, 2025

(54) Automated Digital Credit and Credit Control Systems and Methods of Use and Doing Business

(71) Applicant: Koin Mobile, LLC, Las Vegas, NV (US)

(72) Inventors: Gary E. Ellis, Las Vegas, NV (US); Gary Larkin, Las Vegas, NV (US); Maner Puyawan, Las Vegas, NV (US)

(21) Appl. No.: 18/908,729

(22) Filed: Oct. 7, 2024

Related U.S. Application Data
(60) Provisional application No. 63/588,254, filed on Oct. 5, 2023.
(60) Provisional application No. 63/554,842, filed on Feb. 16, 2024.

(51) Int. Cl. G06Q 20/36; G06Q 20/02; G06Q 50/34

(52) U.S. Cl. CPC G06Q 20/363; G06Q 20/027; G06Q 50/34

(57) ABSTRACT

Various aspects of this disclosure relate to a system for use in transferring electronic currency between external funding sources and, for example, a casino to fund wager gaming and to cash out or otherwise transfer winnings or certain types of unused credit, while, in some in some embodiments, restricting the transfer of certain types of credit, such as for example, loan credit provided by the casino or one or more other entities or activities. Various aspects of this disclosure relate to an electronic wallet that provides access to one or more external and/or internal funding sources such as one or more deposit accounts and/or credit accounts; and the electronic wallet is configurable to fund wager gaming or the procurement of other products or services. Such funding is optionally provided to a certain environments, like a casino for example, through a closed system in communication with one or more wager-game providing systems and/or one or more other product or service providing systems.

### COPYRIGHT NOTICE

A portion of the disclosure of this patent document contains or may contain material that is subject to copyright protection. The copyright owner does not object to facsimile reproduction by anyone of the patent document or the patent disclosure, as they appear in the Patent and Trademark Office patent files or records, but otherwise reserves all copyright rights whatsoever.

### TECHNICAL FIELD

The technology of the present application relates to an electronic wallet, a system for transferring electronic currency, and methods of use and doing business. In some embodiments, to an electronic wallet for wager gaming, a system for transferring electronic currency for wager gaming, and methods of use, in which (a) the electronic wallet is configured to decouple the source of electronic currency from the electronic currency and to provide electronic currency from different sources, (b) the system is configured to allow the transfer of electronic currency to and from devices that allow cashless access to games, wager games, other products and services, and, in some instances, to provide a secure, closed system such that records of the transfers are only available on and from the system, and (c) the electronic wallet and system allow for transferring, processing, and/or managing electronic currency provided for use in wager gaming and related activities, including one or more of activity tracking, activity reporting, and responsible wager gaming.

### CROSS-REFERENCE TO RELATED APPLICATIONS

This patent application claims priority to U.S. Provisional Patent Application No. 63/588,254, filed Oct. 5, 2023, and U.S. Provisional Patent Application No. 63/554,842, filed Feb. 16, 2024, each of which Applications is incorporated by reference in its entirety. In the event, however, of any inconsistency between any such prior Applications and this Application, this Application shall prevail

### Background of Some Aspects of this Specification

Traditionally, placing wagers on gaming machines predominantly involved submitting tangible currency such as bills and coins at the time the wagers were placed. In current applications, where players sought to wager across variable gaming verticals (which include, for example, slot machines, table games, sportsbooks, online gaming, and iGaming), they would generally be directed by the individual gaming vertical to access disparate payment platforms, mobile applications, or retail locations. Furthermore, if a player had no cash or coins, the player had to stop playing or otherwise temporarily leave the gaming area to obtain additional currency. Players could historically directly access external funding sources through an automated teller machine (ATM) or by writing a check and indirectly access external funding sources by providing an external account as collateral or by offering the external account as evidence of credit-worthiness in exchange for casino credit. The problems with historical alternatives to tangible currency have long been many.

In respect to casino credit enabled play, for example, the player, once given the cash issued on credit, would physically take the money to the gaming machine to play. This allowed the player to take the cash without requiring any subsequent wager gaming. The player could simply pocket the cash and walk out of the casino. The casino often bore the risk, associated costs, or both of collecting, from the player, credit receivable obligations if the player failed to repay a marker, if the player's check bounced, or both. Further problems for casinos include delays associated with handling and managing traditional credit such as cash flow shortages resulting from the period of time such credit remained uncollected.

At the same time, the prominent use of cash at one or more phases of the gaming process also long presented significant problems. For example, the carrying of cash to and from the casino sometimes increases the occurrence of theft from players, which results in one or more of reducing the quality of the casino experience for patrons, increasing costs to the casino for liability coverage and security, reducing the number and frequency of return player visits, and negatively impacting the reputation of the casino with respect to potential customer perception, community perception, or both. This affects one or more of a revenue impact on the casino, a financial and psychological impact on players, and a negative impact on the ability of casinos to foster a positive community perception that might have assisted in helping to promote pro-casino local, state, and national laws and regulations, as well as pro-casino zoning decisions.

In addition, the absence of efficient and cost-effective external gaming compliant payment management services from the player to the game across gaming verticals and multiple jurisdictions using a common or unified player experience typically placed an added burden on players to procure and manage their cash carry. Players must either establish multiple accounts with each of the respective gaming applications to arrange funding as applicable or first consider when and where to obtain cash and also accurately predict their potential stake for the relevant gaming period to avoid needing to obtain additional cash to continue funding a gaming session. The cash carry must be managed by the player while engaged in gaming, including the submitting of cash to devices, tables, or sports book, the retrieving of cash from devices, tables, or sports book, and the continued need to monitor the cash carry to avoid loss, such as by dropping bills or coins while avoiding prevalent theft within retail gaming establishments. Such overhead often results in a degraded player experience along with an increased player anxiety due to the inability to affordably access cash, the amount of cash carried, and/or the risk of losing a portion of the cash.

For communities, the cash nature of the casino gaming environment may place an increased burden on community services, such as the demands placed on law enforcement, the courts, and other social and health care service providers. For example, with the level of crime resulting, at least in part, from the presence of cash-often massive amounts-inside and outside the casino, the increased presence of police, both for crime prevention and for response to criminal activity, often increases the overall cost of services, which often both burdens taxpayers and impacts the availability of such resources to focus on other pressing criminal activity. Courts and other social and health care services are similarly affected and face, for example, an increased caseload as arrests increase and other related consequences of crime, including diversion and consumption of casino resources, increase commensurately.

The absence of easy player access to cash and the resulting involvement of large quantities of cash in the traditional gaming experience also long-burdened the casino operator. Casinos often handle and manage extraordinarily large cash drops in order to ensure they can cash out players, which involves various labor costs, including, for example, costs associated with moving cash to and from the casino as well as around the casino and among various different casino properties. A further disadvantage has long been the increased risk of casino theft, along with the resulting impact on the cost of security to prevent such theft, both during the transport of cash to and from the casino as well as within the casino.

Consequently, casinos and card clubs have long been vulnerable to money laundering and other financial crimes due to the nature of these operations. These gaming institutions are fast-paced, cash-intensive businesses that often provide a broad array of financial products and services, some of which are similar to those provided by financial depository institutions and money services businesses. Moreover, gaming institutions serve a diverse and transient customer base about whom they often have relatively little knowledge. A subset of players might structure transactions to avoid certain reporting thresholds, and casinos typically bear the responsibility to identify and report such structured transactions.

Country- and state-specific regulatory requirements also directly impact the ability to extend and the burden of managing alternatives to cash. For example, in the United States, casinos became subject to anti-money laundering regulations promulgated under the Bank Secrecy Act in 1985. Federal law requires casinos to report currency transactions over certain threshold amounts, such as $10,000, conducted by, or on behalf of, one person, as well as multiple currency transactions that aggregate to over certain legislated threshold amounts in a single day. These transactions are reported on reports, such as, for example, a Currency Transaction Report by Casinos (CTRC) form. In addition, casinos are required to report suspicious transactions (or patterns of transactions) conducted or attempted at or through the gaming establishment. These laws were passed to safeguard against money laundering and other financial crimes. Historically, it was both labor intensive and systems intensive to track, retrieve, analyze, and report such transactions to the extent it was possible to do so reliably.

To comply with this U.S. law, operators must not only use all available information to detect and report the transactions themselves, but also obtain and include the personal identification information about the individual conducting the transactions such as a social security number, driver's license, or other government issued document, in the filed report. This burdensome requirement applies independent of whether individuals conducting the transactions are wagering on behalf of themselves or others.

Detecting suspicious activity and CTRC report triggering events presents challenges. Even when an operator detects such activity and events, it has been difficult and often manually intensive to collect evidence surrounding such events, collect the necessary player-related information, prepare the required reports, and file the required reports with the casino records-keeping system and with an applicable regulatory agency. Often such challenges result in unfiled reports, which may result in significant legal and financial consequences for casinos failing to use all available information and file such reports.

In the United States, for example, nearly half of the filings made by operator-reported suspicious activities are characterized as “structuring” or “minimal” gaming. These activities involve chip, jackpot, and token redemptions that customers may have structured to avoid currency transaction reporting requirements. Breaking up transactions into smaller amounts for the purpose of evading the reporting requirement constitutes a crime under United States federal law, and detection of such activity can lead to a required report from the operator to the government.

A structured transaction can include, for example, situations such as the following. The player opens a line of credit with the operator for $27,000. The player knows the operator will be required to file a CTRC if the player makes a payment with over $10,000 in currency on a single day. To evade a CTRC filing, the player makes $9,000 payments on the line of credit over different gaming days. Tracking this type of activity to report it in compliance with regulatory requirements presents logistical challenges and cost.

The requirement of using all available information to detect and report places significant burdens on legacy casino systems, which were not designed to optimize such data collection and analysis and may therefore result in increased and inefficient bandwidth usage, excessive data storage demands, wasteful proliferation of computing devices, unsynchronized data and data integrity issues, and the like.

The Applicant further believes it discovered certain disadvantages and drawbacks of gaming even when implemented, for example, with credit lines as described above. Costs are incurred in association with determining whether to grant a credit line to a player; these costs may take the form of a fee for a credit report, the time and effort of operator employees to process credit applications, the time and effort involved in an on-the-spot decision by an employee to grant a credit line without an advance application, and even the expense of establishing and maintaining an electronic system that can make credit determinations without employee involvement. For these and other reasons, the operator often does not want to be in the business of evaluating, providing, and carrying massive credit or be involved in any way with efforts to obtain repayment, including to avoid unpleasantness between the casino and its customers. Operators are therefore often unwilling or unable to serve as a source of funds for players in connection with granting credit lines, particularly on a large scale as the number and type of players requesting credit lines increases, as has long been occurring in the wager gaming industry.

For many years, operators also faced increased pressure to foster, support, and enforce responsible gaming. Many operators take proactive approaches in attempting to address responsible gaming, which approaches have often proven costly, limited in their effectiveness, or both. In many gaming jurisdictions including, for example, the United States and Australia, cash dispensing technologies such as ATMs are required to be located at a minimum distance from the gaming floor. Among other things, regulators hoped that, by requiring players to leave the gaming floor when in need of advancing funds, they would be less likely to engage in irresponsible gaming behavior, having to walk away from the gaming floor for some period of time. This approach presents many disadvantages including disrupting the responsible player's gaming experience, reducing cash velocity even when such reduction lacks usefulness, requiring players to leave a particular machine to which they may have a developed an affinity, and questionable efficacy, for example, because the player may nevertheless return with additional cash and gamble irresponsibly. Additionally, many approaches to encourage and enforce responsible gaming employ the personal involvement of casino personnel, which can be costly, subjective, embarrassing to the player, and inefficient.

Securing and administering credit for purposes of using such credit to place wagers in the context of gaming was traditionally a complex, inefficient, resource-intensive endeavor for one or more of the players, the operator, and the credit provider. Placing wagers on gaming machines historically involved submitting tangible currency such as bills and coins at the time the wagers were placed. If a player lacked cash or coins, then the player had to stop playing or otherwise temporarily leave the gaming area to obtain additional currency. Casino credit such as cashing checks and issuing markers developed as ways for players to obtain cash, on credit, to continue playing. The problems with casino credit were many.

The Applicant believes it discovered certain disadvantages and drawbacks of cashless gaming even when implemented, for example, with credit lines as described above. Costs are incurred in association with determining whether to grant a credit line to a player; these costs may take the form of a fee for a credit report, the time and effort of casino employees to process credit applications, the time and effort involved in an on-the-spot decision by an employee to grant a credit line without an advance application, and even the expense of establishing and maintaining an electronic system that can make credit determinations without employee involvement.

For the patron, a lack of visibility into, and control over, the requesting of, receiving of, drawing of, and paying back of multiple disparate credit lines (if even available) contributes to reduced enjoyment of the gaming experience particularly in the sports, iGaming, and online gaming verticals. This sometimes includes one or more of pauses of gaming activity to request credit in the absence of sufficient available funds, increases in stress due to uncertainty as to when paydown payments were due, the amounts due, late payments, the amount of available credit, and the like. Further, the lack of easily-available access to administration of one or more of the patron's credit accounts, markers, or the like has often contributed to inefficient use of the patron's time, repeated interactions with multiple electronic systems, staff, or both, the inability to responsibly and effectively control and direct the requesting of, drawing of, wagering of, and payment of credit lines and markers, and players carrying larger amounts of cash to, from, and within gaming establishments, leading in turn to other problems with transporting and carrying such cash, including pickpocketing of game players for example.

In addition, there has historically been a separation between banking interfaces and interfaces available for funding wagering accounts. Multiple transactional steps, procedures, and systems were historically involved in even the most basic of payment transactions, which creates frustration and inefficiencies for one or more of the parties involved in the transactions.

Further, the absence of modern regulatorily compliant processes for quickly, efficiently, and cost-effectively funding a wagering account or identifying available credit and credit offers based on a patron's player club status, their current property location, gaming vertical, or current jurisdiction diminishes the player gaming experience and can lead to reduced player activity and often hinders the operators' and credit providers' ability to extend the appropriate amounts of credit in a timely manner to patrons wanting to engage in gaming at a particular property. Manual processes involved in verifying identity further impeded smooth and enjoyable credit administration for one or more of the operator, credit provider, and patron.

Finally, these historically disjointed processes and systems suffered from a variety of technical disadvantages, including one or more of:
slower processing due to the involvement of manual procedures, multiple system integrations, or both;
increased processing, increased memory demands, or both due, at least in part, to data duplication across systems, the need to retrieve data from external systems for validation, or both;
reduced security due to increased data transmission activity resulting, at least in part, from the involvement of multiple intermediary system stopping points;
increased network bandwidth usage due to system traffic due to processes involving, for example, email verifications, file transfers, fax activity, system integrations, scanning activity, and the like; and
patron use inefficiencies including one or more of susceptibility to user error and frustration relating to complex and multiple graphical user interfaces, paper submissions, phone verifications, and staff engagement.

### SUMMARY OF SOME ASPECTS OF THIS SPECIFICATION

The inventors believe that they discovered many of the problems and issues, or at least their severity or importance, with the prior art discussed in the Certain Aspects section above, including variously in some embodiments their cumulative problematic effect for operators, patrons, gaming and financial regulatory authorities, law enforcement, and social and health care service providers, among others, such as financing providers. To the end of solving or at least substantially reducing one or more such problems, including, in some embodiments, in an effort to facilitate cashless gaming while ensuring one or more of safe and responsible gaming, the Applicant developed (a) an electronic wallet that allows wager gaming players to fund wager gaming and related activities from a variety of different financial sources and/or (b) a system configured to achieve one or more of: (i) receiving electronic currency from the electronic wallet and from other financial sources, (ii) transferring gaming credit to devices that allow cashless access to wager gaming machines, table wager games, and related products and services in exchange for electronic currency, (iii) cashing out of gaming credit from such devices, and (iv) transferring electronic currency to the electronic wallet and/or to other financial sources. In this regard, however, it is to be understood that this specification's identification of a given feature or novel or other aspect means that it may incorporated in some embodiments but not necessarily others.

In some embodiments, for example, the electronic wallet provides access to a variety of different financial sources including one or more of third-party bank accounts, wagering or wager gaming related credit accounts, such as, for example, a MarkerTrax® or Moolah Play™ account, third-party credit cards or accounts, and/or accounts opened with either the provider of the electronic wallet or an associated or other financial source. Thus, in some applications, a wager gaming player may select from one or more different financial sources to fund wager gaming or related activity.

In some applications, the electronic wallet may advantageously deidentify a financial source when transferring funds out of the electronic wallet such that the recipient of the funds cannot identify the financial source or otherwise determine, for example, whether the funds originated from a bank account, a credit account, or other source. The electronic wallet may advantageously deidentify a source when transferring funds into the electronic wallet such that a financial institution that extended a third-party account to a wager gaming player cannot identify whether the source of funds transferred into the third-party account originated from wager gaming winnings, a different account of the electronic wallet, or otherwise.

In some embodiments, the system is a secured, closed system that interfaces directly with devices that allow cashless access to wager gaming machines, table wager games, and related products and services such that no digital record of a transaction exists outside of the system. Such systems can advantageously mask wager gaming transactions from third-party financial institutions and payment processors such that third-party financial institutions and payment processors cannot access or collect data, for example, on the gaming history and other transactional history of wager gaming players. Such systems may also advantageously improve the security of the financial accounts of wager gaming players, for example, because transactions may be performed with a system account, which protects account information of third-party financial institutions, and because transactions may be limited to in-system devices such that unauthorized access of a system account of a wager gaming player cannot be used to enter into third-party transactions.

In some embodiments, cashless gaming can be mediated by direct access to an external account. In some instances, the cashless gaming system allows a wager gaming player to log into a new or existing player's club account on a wager gaming machine and, for example, provides one or more of: (i) selecting an option to fund the machine with electronic currency, (ii) authenticating the gaming session with security protocols, such as a strong two-factor authentication for example, and (iii) interfacing with a router that allows the wager gaming machine to draw directly from a conventional bank account or other funding source, optionally mediated by an electronic wallet, and to cash out any winnings or remaining gaming credit back into the conventional bank account or other funding source through a fast, secure, and optionally-hardwired network. In some applications, the external account may be, for example, a conventional deposit account, a conventional credit card account, other electronic access to currency such as an electronic wallet, and/or a MarkerTrax™ or Moolah™ Play account.

Two-factor authentication, when utilized for example, may be mediated by a mobile app on a mobile device to verify the identity of the wager gaming player and authorize direct transactions with the external account or indirect transactions mediated by the electronic wallet. Two-factor or other authentication may include, for example, geolocating the mobile device to the proximity of a wager gaming machine: (i) indirectly, for example, by GPS, (ii) moderately directly, for example, by identifying an ability of the mobile device to connect to nearby Wi-Fi, and/or (iii) directly, for example, by verifying a Bluetooth or other wireless connection and/or by other direct proximity sensing between the wager gaming machine and the mobile device, any one or more of the foregoing may be mediated by a mobile app.

In some embodiments, authentication includes (i) logging into a player's club account and (ii) identifying, tapping, inserting, and/or swiping a bank card, or an equivalent thereof, in the name of the account holder.

Some applications provide tracking of wager gaming velocity of a wager gaming player, for example to enforce responsible gaming. The velocity of electronic currency that enters the wager gaming machine may optionally be throttled or blocked automatically by the system if it identifies an aberrant velocity that might correlate with unresponsible wager game play.

Some applications support or provide a device, such as an operator-supported or -provided mobile or other device, that may, for example, provide a facility for wager gaming players to fund wager gaming at table or other games. In some instances, an operator-provided mobile or other device can be managed by a pit boss or by other pit or other operator personnel, such as, for example, a dealer or croupier, so that the wager gaming player may directly access electronic currency for use at a physical or virtual table game or other game such as craps, roulette, or pai gow.

In some embodiments, an operator-provided mobile device may also be used, for example, to pay for dining at restaurants, products at shops, services at spas, and/or other amenities provide by a casino or other operator or entity, which may advantageously adapt the security failsafes such as two-factor authentication and optionally stricter security measures to fund wager game play to optionally less-rigorous security protocols dependent upon one or both of a baseline security set by the operator or entity and, optionally, user preference. For example, when a hotel guest places an order to their hotel room, then two-factor authentication might only be required at the preference of the guest whereas opening a bar tab against a bank account might provide reason to heighten security either generally, after the bar tab reaches a threshold amount, after a certain time in the evening—or morning—that correlates with elevated risk, or otherwise.

In this disclosure, “casino” and “operator” includes any wager activity operator or provider, including, but not limited to, physical or virtual or online casinos, card clubs, sports books, fantasy sports providers, racinos, animal raceways, etc. A reference to a “game” or “game” unqualified by “wager” or “wagering,” however, means any type of game or chance or competitive activity, including sweepstakes for example, unless the circumstance of use indicates otherwise. Thus, the systems of this disclosure may be advantageously used with “wagering” and “gaming” as well as other such “games” and other activities, products, and services.

In some instances, authentication techniques—for example, two factor authentication—and stronger security protocols, which may include biomarker verification such as facial scanning and fingerprint reading capabilities, can provides security to permit fast, direct access to electronically-available funds at the disposal of a wager gaming player. Security precautions may optionally be implemented, for example, to electronically or physically tether a mobile device of a wager gaming player to a wager gaming machine, which can, in some instances, provide automatic termination of a gaming session and a cash-out event if the mobile device becomes untethered to the wager gaming machine. In some applications, such an arrangement can reduce possibly heightened risk of unauthorized access to funding sources that the system and methods of this disclosure might pose.

In some embodiments, the level of risk that a wager gaming player might wish to bear may advantageously be self-selected by wager gaming players themselves by choosing one or more stringent authentication techniques, such as for example two-factor authentication. Wager gaming players may also mitigate the risk of unauthorized use of their external funding sources, for example, by funneling transactions through one or electronic wallet of this disclosure. Some wallets may be configured, for example, to provide access to only a limited amount of electronic funds such as $1000. Upon exhaustion of the limited amount of electronic funds, in some instances the wager gaming player may only access additional electronic currency from funding sources by logging into the electronic wallet and transferring funds or creating rules that allow additional funding of wager gaming and related activities.

In some applications, the system, electronic wallet, and/or method may advantageously be configured in yet other ways to reduce risk of use of one or more of them. In some applications, a wager gaming player may optionally activate or disable a system account or electronic wallet to correspond to a visit to a casino, for example, such that no unauthorized use of the account may occur when the system account or electronic wallet are disabled. In some embodiments, the security protocols of a system account and electronic wallet may require physical proximity between a wager gaming player and the object of a transaction such as a wager gaming machine, which in some instances can prevent unauthorized use by persons who lack access to a mobile device of the wager gaming player.

In some applications, even if one were to obtain access to a mobile device of a wager gaming player, the robust existing security infrastructure of casinos, which are necessary, for example, to track the massive amounts of cash that casinos manage, can capture or more images and video of the unauthorized user, which minimizes the upside of any unauthorized use of the mobile device. In some embodiments, any winnings of the unauthorized user would be cashed out back to the funding source- and remain unavailable as cash or other physically-available currency-which may disincentivizes unauthorized use.

Various aspects of this disclosure relate to a bilateral payment gateway that enables regulated compliant management and reporting of funds flow between wager gaming players and a wagering system. In some applications, the disclosed systems and methods can support the use of any funds including cash, electronic currency, deposit accounts, credit accounts, conventional funding sources, and contemporary funding sources. Some embodiments of the disclosed systems and methods can also support regulatory requirements under Title 31 of the United States Code as well as, when necessary, any or all applicable gaming control board operator reporting.

In some embodiments, the systems and methods interact with wager gaming machines, for example, to link a card reader with a specific wager gaming machine.

In some embodiments, an electronic wallet is configured to access electronic currency from one or more of third-party bank accounts such as checking and/or savings accounts, wager gaming credit accounts such as MarkerTrax™ or Moolah™ Play accounts, credit card accounts, and/or accounts opened with either the provider of the electronic wallet or an associated financial source.

In some embodiments, a mobile app may allow a mobile device to display accounts of an electronic wallet to a wager gaming player. The mobile app may display, for example, available balance(s) and/or available credit of various accounts in the electronic wallet. A wager gaming player may generally access some or all of the available balance(s) and/or available credit of the various accounts to fund wager gaming and related activities such as shopping and dining in shops and restaurants of a casino.

In some embodiments, a wager gaming player may directly access some or all of the available balance(s) and/or available credit by directing one or more transfers of electronic currency from the electronic wallet to one or more devices that allow cashless access to wager gaming machines, table wager games, and/or related products and services.

In some systems, a wager gaming player may indirectly access some or all of the available balance(s) and/or available credit by directing transfer of electronic currency from the electronic wallet to a system of this disclosure, from which system the wager gaming player may subsequently direct one or more transfers of gaming credit to one or more devices that allow cashless access to wager gaming machines, table wager games, and/or one or more related products and services. In some instance, the transferred electronic currency can be transferred to an operator-associated account, and the system then allows visualization of the transferred electronic currency as credit associated with a system account and/or as credit on a device of the system such as a wager gaming machine; transferring electronic currency to a device, system, or the like therefore refers to transferring electronic currency to an operator-associated account such that the transferred electronic currency may be viewed and used on the device, system, or the like.

Some embodiments of the electronic wallet may advantageously deidentify the source(s) of the electronic currency such that the one or more devices cannot identify the account(s) from which the electronic currency originated and such that the one or more devices cannot identify whether the electronic currency originated, for example, from one or more of deposit accounts and credit accounts. In some instances, the electronic wallet may also advantageously mask the devices to which the electronic currency is transferred such that the financial institution(s) that manage the account(s) of the electronic wallet cannot identify the recipient of the electronic currency. Some applications of deidentification can advantageously protect the gaming history and habits of wager gaming players from the financial institutions that they desire to use to fund wager gaming and related activities as well as avoid scrutiny of cashless wager gaming activity, for example, on corresponding financial statements of such financial institutions. In some embodiments, the system and methods nevertheless remain capable of identifying gaming history and habits that require reporting and remedial measures to both comply with the applicable regulations of a gaming jurisdiction and enforce responsible gaming.

An electronic wallet of this disclosure may be funded, for example, with one or more of a debit card account, credit card account, cash, Venmo, Zelle®, PaPal, Apple Pay, GooglePay, SamsungPay, payroll deposit, automated clearing house (ACH) transfer, real-time payment (RTP), and person-to-person transfer. An electronic wallet may, in some applications, be funded with cash, for example, in a transaction at a casino cage or with a participating retailer as described herein.

A system account of this disclosure may be funded, for example, with one or more of a debit card account, credit card account, cash, mobile wallets (including Venmo, PaPal, Apple Pay, GooglePay, and SamsungPay), payroll deposit, Zelle®, automated clearing house (ACH) transfer, real-time payment (RTP), person-to-person transfer, wire transfers, swift payments, and crypto currencies where permitted by law. A system account may, in some instances, be funded with cash, for example, in a transaction at a casino cage or with a participating retailer.

In some systems, an open application programming interface (API) structure of the system, for example, can be supported so third-party payment vendors can integrate into the API to make their payment system available for gaming activities. A custom integration may also be configured with any third-party payment vendor.

The foregoing Summary provides a brief overview of some aspects of this disclosure. There are other novel advantages and features of this Disclosure, and they will become apparent as this Specification proceeds.

It is further to be understood that the scope of an invention of this Specification shall be determined by the claims as issued and not by whether an aspect or feature is recited in the foregoing Brief Background or Brief Summary sections.

### BRIEF DESCRIPTION OF THE DRAWINGS

The inventors' preferred and other embodiments are disclosed in association with the accompanying Figures, within which, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a system of this disclosure and its integration with funding sources, mobile apps, points of sale, and an administrative control panel.

FIG. 2 is a block diagram that depicts integration of a system of this disclosure with wager gaming machines.

FIG. 3 is a block diagram that depicts an electronic wallet of this disclosure, a payment network that supports the electronic wallet, and integration of the electronic wallet and the payment network with various external systems, entities, and devices including a system of this disclosure.

FIG. 4 is a block diagram of a computer system suitable for implementing, for example, the system of FIG. 1.

FIG. 5 is a flow chart that depicts exemplary steps for a player to log into a system account of this disclosure from a wager gaming machine.

FIG. 6 is a flow chart that depicts exemplary steps for a player to transfer electronic currency from an external funding source to a wager gaming machine as mediated by a system of this disclosure.

FIG. 7 is a flow chart that depicts exemplary steps for a player to cash out gaming credit from a wager gaming machine to an external funding source as mediated by a system of this disclosure.

FIGS. 8-87 are screenshots of various screens of a mobile app that implements at least some of the electronic wallet features of this disclosure.

### DETAILED DESCRIPTION

In this disclosure, the term “closed network” refers to a private network such as an intranet that is designed to only be accessed by authorized devices. In this disclosure, authorized devices include, for example, (1) devices that run an app configured to interact with an application interface of a system of this disclosure, (2) points of sale including wager gaming machines that are controlled either by an operator or on behalf of an operator, and/or (3) control panels that are controlled by an operator or on behalf of an operator. A closed network may also send and receive transaction details from an electronic wallet of this disclosure and/or from third-party funding sources, but some systems of this disclosure are generally configured such that neither an electronic wallet nor a third-party funding source can access the closed network other than by receiving and sending transaction details to the system that comprises the closed network.

In this disclosure, the term “casino” means conventional casinos and the many other types of entities that provide wagering activity, like sportsbooks, horse raceways, racinos, and, whether they involve physical wagering properties or take place in whole or part otherwise, such as online. It should further be appreciated that the systems and/or wallet of this disclosure can be used with other products and services, such as video games where one pays to gain access to the game or social games where winnings are virtual and not useable outside the game and there may or may not be payment to play the social game.

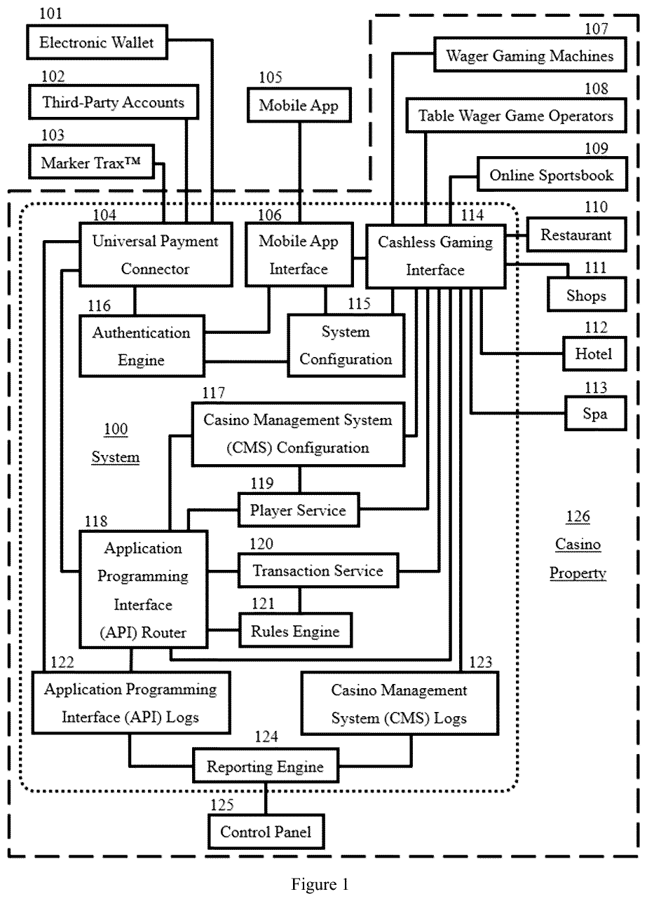

FIG. 1 is a block diagram that depicts a system 100 of this disclosure, which is circumscribed with a dotted line. A system 100 of this disclosure is generally implemented for use on one or more casino properties 126, which have a specific location. Various external funding sources may be used to fund an account of the system 100, including an electronic wallet 101 such as an electronic wallet of this disclosure, one or more third-party accounts 102 such as deposit accounts and credit cards, and a MarkerTrax™ or Moolah™ Play account 103. FIG. 1 is exemplary, and the interfaces between the system 100 of FIG. 1 may vary depending upon the precise configuration of the system. Further, only a subset of the components and connectivities of the system are depicted, for example, as an artifact of a two-dimensional representation of the system. Various components of the system are described in further detail below.

An account of the system 100 of this disclosure is referred to herein as a “system account,” which is held by an “account holder,” who is generally a consumer of products and services of a casino or other entity that provides wager games, which products and services typically include entertainment in the form of wager gaming such as on wager gaming machines 107 that the casino or other entity provide. The casino or other entity typically either operate the system 100 or contract with another entity that operates the system 100 on behalf of the casino or other entity. A system account generally includes information that identifies the account holder including the name, address, and birth date of the account holder. A system account may also include information that the account holder may use to securely access the system account such as a login, pin, password, biometric data, and/or digital keys. A system account may optionally also include information about external funding sources, e.g., 101, 102, 103, that are linked and accessible to the system account.

The universal payment connector 104 creates a common interface with various different funding source vendors. The universal payment connector 104 supports transactions that fund and cash out transactions associated with a system account. As depicted in FIG. 1, a universal payment connector 104 can, in some embodiments, interface with one or more of electronic wallets 101, third-party accounts 102, and, for example, a trackable-credit-providing Moolah™ Play account 103. The one or more electronic wallets 101 may include closed-network electronic wallets, such as an electronic wallet of this disclosure and/or open-network electronic wallets such as GooglePay, ApplePay, Venmo, PayPal, Zelle, CashApp, SamsungPay, and/or others.

Account holders may view their accounts with a mobile app 105, for example, on a mobile device, which is mediated by a mobile app interface 106 of the system 100. Account holders may use their system accounts, for example, to fund wagers on wager gaming machines 107, table games 108, and online sportsbooks 109 as well as to pay for dining at restaurants 110, purchases at shops 111, hotel accommodations 112, and various other products and services such as those provided by a casino spa 113 or other entities, such as other retail products and service providers not necessarily involved with wagering or providing of other games. Transactions are mediated by both the Universal Payment Connector 104 and a cashless gaming interface 114.

The mobile app interface 106 interfaces with a system configuration 115, which limits the functionality of the mobile app interface 106 based upon the nature of the system 100. The system configuration 115 stores the overall configuration of the system, which may include, for example, information about the casino property, time zone, gaming week/day, geofencing, IP whitelisting, and third-party vendors and service providers. The system configuration 115 may limit the mobile app interface 106, for example, to receiving transaction information specific to a casino property 126, for example, and may prevent the mobile app interface 106 from receiving transaction information specific to different casino properties that utilize the same mobile app 105.

An authentication engine 116 interfaces with both the universal payment connector 104 and the system configuration 115, which authentication engine 116 authenticates and establishes secure connections between the system 100 and external funding sources 101, 102, 103. The authentication engine 116 manages security parameters such as IP whitelisting, key management, and token credentials. The authentication engine 116 may use the system configuration 115, for example, to identify the system 100 to the external funding sources 101, 102, 103.

The cashless gaming interface 114 may also interface with the system configuration 115, to limit the functionality of the cashless gaming interface 114 based upon the nature of the system 100. Whereas the cashless gaming interface 114 is generally configured to facilitate any transaction between any point of sale (meaning any point in support of providing a product or service and identified, for example, by 107-113) and any external funding source (for example, 101, 102, 103), the system configuration may limit the cashless gaming interface 114 to accept only classes of pre-authorized transactions. For example, certain wager gaming jurisdictions may, during certain times, days, activities or activity levels, or otherwise, disallow wager gaming players from funding wager gaming activities with one or more certain types of credit cards or other accounts, and the system 100 may be configured such that the system configuration 115 includes a rule that disallows the cashless gaming interface 114 from accepting credit card transaction requests that, for example, would transfer funds to wager gaming machines 107, table wager game operators 108, and online sportsbooks 109, but that may, for example, allows the cashless gaming interface 114 to accept credit card or other account transaction requests, for example, to pay for purchases at restaurants 110, shops 111, hotels 112, and spas 113.

The system 100 also comprises a casino management system (CMS) configuration 117, which interfaces with the cashless gaming interface 114 so that accounts can facilitate transactions that fund wager gaming, sports betting, and various other purchases allowed by the CMS. The CMS configuration 117 stores all of the configuration data needed to establish the connection with the CMS including application programming interface endpoints and credentials, CMS version tracking, and transaction direction mode (push or pull).

The system 100 comprises an application programming interface (API) router 118, which passes transaction messages to and from the appropriate external funding source 101, 102, 103 through the universal payment connector 104. The API router 118 also directs queries to one or more of a player service engine 119, a transaction service engine 120, and a rules engine 121 as described below. The API router 118 interfaces with the universal payment connector 104 to control the transfer of electronic currency between a casino account and external funding sources 101, 102, 103, for example, to fund transactions at various points of sale (for example, 107-113).

The player service 119 through the cashless gaming interface 114 is responsible for validating player accounts using player identification and a form of verification such as a PIN, password, date of birth, or biometric. The player service 119 is also responsible for pulling player information from the cashless gaming interface 114 for use in creating accounts in an account servicing host (ASH), which player information may be sent to a funding source 101, 102, 103, for example, for use in a specific enrollment process when creating a system account and/or for use in facilitating a transaction mediated by a system account. The player service 119 allows the system 100 to track transactions including uploads and downloads associated with an individual system account and a funding source (for example, 101, 102, 103) as well as the destination of electronic currency for each transaction.

The transaction service 120 is a set of APIs responsible for handling and processing financial transactions between the casino and funding sources 101, 102, 103. The transaction service 120 through the cashless gaming interface 114 communicates transaction messages between funding sources 101, 102, 103 and the CMS such as transactions that fund wager gaming machines and transactions that cash out wager gaming machines to transfer funds back to the funding source(s). The transaction service 120 through the cashless gaming interface 114 also communicates transaction messages between funding sources and sales terminals including, for example, points of sale at one or more of hotels 112, restaurants 110, shops 111, and spas 113. The transaction service 120 records all transactions.

The rules engine 121 is a decision tree that determines, for example, the priority of a transaction. An account holder might specify rules, for example, for the priority of funds transfers during a cash out event, or an agreement between the account holder and a funding source might otherwise specify a priority; the rules engine 121 enforces any such priority. The rules engine 121 is a configurable component responsible for determining, allowing, or restricting, the funds flow. For example, in the case of Marker Trax or Moolah Play, the rules engine 121 can provide a rule that will ensure through priority a requirement that the advance or loan of credit be paid off first prior to disbursing the remaining funds or winnings credit, if any. When a Moolah™ Play account provides credit to fund wager gaming and/or other purchases, for example, then the rules engine 121 may be configured to transfer funds back to the Moolah™ Play account to repay the credit during a cash-out event prior to allowing the transferring funds back to any other account such as to a deposit account. When a system account or electronic wallet of this disclosure funds wager gaming pursuant to a “buy now pay later” or overdraft feature, then the rules engine 121 may be configured to repay the funds during a cash-out event prior to transferring funds back to any other account such as to a deposit account. In some embodiments, the rules engine 121 may be thus used to prevent a cash out or other transfer of certain types of trackable debt credit, such as Marker Trax or Moolah Play debt credit for example.

The rules engine 121 can also allow for decision trees that track and determine whether a specific external funding source 101, 102, 103 may be used for a specific or type of transaction. The rules engine 121 may, for example, disallow a type of external funding source from funding wager gaming when disallowed by a regulatory jurisdiction that governs the transfer; the rules engine 121 may nevertheless optionally allow for the or another type of external funding source to fund non-gaming transactions in the regulatory jurisdiction, such as, for example, dining, shopping, or spa services. In some embodiments, the rules engine 121 may further be used in determining allowed usages of certain types of tracked credit, such as, for example, allowing a casino marker or loan credit provided by a casino or other entity to be used only in association with the specific casino entity or casino property, whether, for example, at a physical property or an online virtual “location” entity, or service.

The API router 118 and universal payment connector 104 generate API logs 112, which record information related to the transfer of electronic currency to and from external accounts such as the accounts of one or more electronic wallets 101, one or more third-party accounts 102, and a MarkerTrax™ or Moolah™ Play account 103. Additionally, the cashless gaming interface 114 generates CMS logs 123, which record information related to transactions that use electronic currency from an external funding source 101, 102, 103.

A reporting engine 124 of the system 100 interfaces with the API logs 122 and the CMS logs 123, which reporting engine 124 allows access to the logs 122, 123 through an external control panel 125 and generates statistics and data derived from the logs 122, 123, which statistics and data are viewable on the external control panel 125. The reporting engine 124 generates internal reports and pulls reports from third-party vendors, which can be downloaded and displayed through the control panel 125. The reporting engine 124 may automatically generate reports required, for example, to comply with gaming regulations, and the reporting engine 124 may automatically detect and flag real-time changes in wagering velocity that prompt further scrutiny to enforce responsible gaming. The control panel 125 may be configured as a web-based administration portal that is configurable for different roles and permissions to provide the operator of the system 100 with functionalities required by personnel to operate the system 100.

In some embodiments, the cashless gaming interface 114 is a CMS connector. A CMS connector is a detachable and replaceable component that custom integrates with specific CMS vendors such as Acres Manufacturing (Nevada, United States), Agilisys (Georgia, United States), Century Gaming Technologies (Montana, United States), International Game Technology (United Kingdom), and Konami Gaming (Nevada, United States). The CMS connector is responsible for interfacing and consuming the application programming interfaces for player information and transaction processing. The CMS connector also normalizes the inbound and outbound data structure going in and out of the system 100 to correspond to the software and messaging formats of different CMS vendors. The precise configuration of the cashless gaming interface 114 therefore depends upon the CMS 128 with which the system integrates.

The transaction service 120 may be configured to process transactions, for example, with either a one-step or two-step process. In some embodiments of the one-step process, an account holder initiates a transaction, the transaction service 120 processes the transaction, and a funding source either declines the transaction or the CMS 128 voids the transaction. In some embodiments of the two-step process, an account holder initiates a transaction, the transaction service 120 processes the transaction, the funding source approves the transaction, and the account holder either cancels the transaction or commits to the transaction. A committed transaction may alternatively occur as a one-step process instead of a two-step process, for example, by eliminating the requirement for the account holder to commit to a transaction. The transaction service 120 also creates a transaction report, which optionally validates the time stamps of each step.

In some embodiments of the one-step process, (1) an account holder initiates a transaction using a user interface such as an interface of a wager gaming machine 107, (2) the transaction service 120 acquires account holder information, (3) a request for approval is sent from the universal payment connector 104 to the funding source 101, 102, 103, (4) the funding source 101, 102, 103 accepts the request, (5) the transaction service 120 sends a message to the CMS 128 stating that the request is accepted, (6) the CMS 128 voids the transaction, for example, due to an error or connectivity issue, (7) the CMS 128 sends a message to the transaction service 120 to void the transaction, (8) the transaction service 120 directs the universal payment connector 104 to reverse the transaction, (9) the universal payment connector 104 reverses the transaction with the funding source 101, 102, 103, (10) the transaction service 120 sends a message to the CMS 128 that the transaction has been voided, (11) the voided transaction is time stamped and recorded by the system 100 in one or both of the API logs 122 and CMS logs 123, and (12) the voided transaction is communicated to the account holder through the same interface from which the transaction was initiated. Messages to-and-from the transaction service 120 and the CMS 128 are generally mediated by the cashless gaming interface 114 of the system and optionally by an external controller 127, which interfaces with the CMS.

An example of a request sent from the CMS 128 to the transaction service 120 is:

```
POST /api/v1/processTransaction HTTP/1.1
Host: {{CGI-URL}}
Content-Length: 237
{
  “TransactionId”: “15789-231154”,
  “TransactionType”: “debit”,
  “PlayerId”: “1000057”,
  “ProviderCode”: “KOIN”,
  “Currency”: “USD”,
  “Amount”: 10.00,
  “AssetId”: “S1000”,
  “TransactionTimestamp”:“2023-04-12 20:00:00”
}
```

The transaction service 120 then responds to the CMS 128 that the request was accepted and processed by an external funding source 101, 102, 103, for example:

```
{
  “isSuccess”: true,
  “message”: “Process Transaction Success”,
  “data”: {
    “referenceId”: “1A3B944E-3632-467B-A53A-206305310BAE”
  }
}
```

The CMS 128 then responds to system 100 that the transaction is voided, for example:

```
POST /api/v1/voidTransaction HTTP/1.1
Host: {{CGI-URL}}
Content-Length: 87
{
  “ReferenceId”: “1578922223253”,
  “TransactionTimestamp”: “2023-04-12 20:00:00”
}
```

The transaction service 120 then reverses the transaction and sends a message to the CMS 128, which confirms the voiding and reversal of the transaction, for example:

```
{
  “isSuccess”: true,
  “message”: “Void Success!”,
  “data”: {
    “referenceId”: “1A3B944E-3632-467B-A53A-206305310BAE”
  }
```

In some embodiments of the two-step process, in which the account holder cancels the request, (1) an account holder initiates a transaction using a user interface such as an interface of a wager gaming machine 107, (2) the transaction service 120 acquires account holder information, (3) a request for approval is sent from the universal payment connector 104 to the funding source 101, 102, 103, (4) the funding source 101, 102, 103 accepts the request, (5) the transaction service 120 sends a message to the CMS 128 stating that the request is accepted, (6) the user interface prompts the account holder to confirm the transaction, and the account holder cancels the transaction, (7) the CMS 128 cancels the transaction (8) the CMS 128 sends a second message to the transaction service 120 to cancel the transaction, (9) the transaction service 120 directs the universal payment connector 104 to reverse the transaction, (10) the universal payment connector 104 reverses the transaction with the funding source 101, 102, 103, (11) the transaction service 120 sends a message to the CMS 128 that the transaction has been cancelled, (12) the cancelled transaction is time stamped and recorded by the system 100 in one or both of the API logs 122 and CMS logs 123, and (13) confirmation of cancellation is communicated to the account holder through the same interface from which the transaction was initiated. Messages to-and-from the transaction service 120 and the CMS 128 are generally mediated by the cashless gaming interface 114 of the system and optionally by an external controller 127, which interfaces with the CMS.

An example of a request sent from the CMS 128 to the transaction service 120 is:

```
POST /api/v1/processTransaction HTTP/1.1
Host: {{CGI-URL}}
Content-Length: 237
{
  “TransactionId”: “15789-231154”,
  “TransactionType”:“debit”,
  “PlayerId”: “1000057”,
  “ProviderCode”: “KOIN”,
  “Currency”: “USD”,
  “Amount”: 10.00,
  “AssetId”: “S1000”,
  “TransactionTimestamp”: “2023-04-12 20:00:00”
}
```

The transaction service 120 then responds to the CMS 128 that the request was accepted and processed by an external funding source 101, 102, 103, for example:

```
{
  “isSuccess”: true,
  “message”: “Process Transaction Success”,
  “data”: {
    “referenceId”: “1A3B944E-3632-467B-A53A-206305310BAE”
  }
}
```

The CMS 128 then responds to system 100 that the transaction has been cancelled, for example:

POST /api/v1/cancelTransaction HTTP/1.1
Host: {{CGI-URL}}
Content-Length: 60
{
“ReferenceId”: “1A3B944E-3632-467B-A53A-206305310BAE”
}

The transaction service 120 then reverses the transaction and sends a message to the CMS 128, which confirms the cancellation and reversal of the transaction, for example:

```
{
  “isSuccess”: true,
  “message”: “Cancel Success!”,
  “data”: {
    “referenceId”: “1A3B944E-3632-467B-A53A-206305310BAE”
  }
```

In some embodiments of the two-step process, in which the account holder confirms the request, (1) an account holder initiates a transaction using a user interface such as an interface of a wager gaming machine 107, (2) the transaction service 120 acquires account holder information, (3) a request for approval is sent from the universal payment connector 104 to the funding source 101, 102, 103, (4) the funding source 101, 102, 103 accepts the request, (5) the transaction service 120 sends a message to the CMS 128 stating that the request is accepted, (6) the user interface prompts the account holder to confirm the transaction, and the account holder confirms the transaction, (7) the CMS 128 sends a second message to the transaction service 120 to confirm the transaction, (8) the transaction service 120 sends a message to the CMS 128 to confirm the transaction, (9) the transaction is time stamped and recorded by the system 100 in one or both of the API logs 122 and CMS logs 123, and (10) confirmation is communicated to the account holder through the same interface from which the transaction was initiated. Messages to-and-from the transaction service 120 and the CMS 128 are generally mediated by the cashless gaming interface 114 of the system and optionally by an external controller 127, which interfaces with the CMS.

An example of a request sent from the CMS 128 to the transaction service 120 is:

```
POST /api/v1/processTransaction HTTP/1.1
Host: {{CGI-URL}}
Content-Length: 237
{
  “TransactionId”: “15789-231154”,
  “TransactionType”: “debit”,
  “PlayerId”:“1000057”,
  “ProviderCode”: “KOIN”,
  “Currency”: “USD”,
  “Amount”: 10.00,
  “AssetId”: “S1000”,
  “TransactionTimestamp”: “2023-04-12 20:00:00”
}
```

The transaction service 120 then responds to the CMS 128 that the request was accepted and processed by an external funding source 101, 102, 103, for example:

```
{
  “isSuccess”: true,
  “message”: “Process Transaction Success”,
  “data”: {
    “referenceId”: “1A3B944E-3632-467B-A53A-206305310BAE”
  }
}
```

The CMS 128 then responds to system 100 that the transaction is confirmed, for example:

```
POST /api/v1/commitTransaction HTTP/1.1
Host: {{CGI-URL}}
Content-Length: 227
{
  “TransactionId”: “15789-231154”,
  “ReferenceId”:“1A3B944E-3632-467B-A53A-206305310BAE”
  “TransactionType”: “debit”,
  “ProviderCode”: “KOIN”,
  “AssetId”: “S1000”,
  “TransactionTimestamp”: “2023-04-12 20:00:00”
}
```

The transaction service 120 then sends a message to the CMS 128, which confirms the transaction, for example:

```
{
  “isSuccess”: true,
  “message”: “Successfully processed transaction”,
  “data”: {
    “referenceId”: “1000c180-98cf-4821-89f5-45fe3216f3fd”
  }
}
```

The preceding examples each utilize an electronic wallet of this disclosure Koin™, as set forth by the “ProviderCode”, which is “KOIN”. Such an electronic wallet may advantageously be linked to a system account. The system 100 may nevertheless be configured to accept card-based payments and equivalent payments mediated, for example, by magnetic strips, EMV chips, RFID credentials, NFC credentials, UWB credentials as well as the tap to pay features of a mobile device. Such payments may be implemented, for example, by integrating a card reader into either a controller 127 or a wager gaming machine 107. The CMS 128 then passes account information obtained from the payment method to the transaction service 120. The rules engine 121 may reject the payment method, for example, when the jurisdiction in which the transaction would occur disallows the payment method to fund wager gaming as described above. When the payment method is allowed, then the transaction proceeds as described above.

A system and/or wallet of this disclosure may track credit/funding types. Cash credit and trackable debt credit are discussed herein. The system may accomplish such tracking with the transaction service 120, rules engine 121, API logs 122, and CMS logs 123, among other aspects of this disclosure. Multiple data fields of transactions occurring with a system and/or wallet of this disclosure may be used to track credit/funding types. For example, “Transaction Type,” “ProviderCode,” “AssetId,” and “TransactionId” data fields of a transaction service message 120 may be used in tracking credit/funding types. Further, in some embodiments, “used,” “available,” and “limit” fields for a trackable debt credit may be used, whereas only an “available” field may be used for a cash credit. For example, for sessions that include any Marker Trax Fund. In transaction, the system and/or wallet of this disclosure will look up the Rules Engine 121 and pass the API to Marker Trax for marker re-payments first before transferring any excess funds to other financial wallets. In some embodiments, within the rules engine 121, rules may be set where a trackable debt credit may be used only on certain properties, may be used only in certain ways, and must be returned to the specific funding source. Other data fields and methods of tracking credit types are envisioned, and the foregoing examples are not meant to be limiting.

Cash credit is credit that a system of this disclosure does not track for purposes of type of use and priority in a cash out event. Cash credit could be credit provided to a system or wallet of this disclosure from, for example, a debit account with a bank account, physical cash, or other payment sources. Such a credit may be used or cashed out in any way an account holder of the system of this disclosure desires. For example, cash credit may be used across multiple properties, at any point of sale, or for any wager gaming. For further example, cash credit may be cashed out with a ticket that can be converted to cash by a cashier or by returning the credit to an external funding source, system account, or digital wallet.

Trackable debt credit is credit provided by a debt. In some embodiments, trackable debt credit can be casino markers. Casino markers are short-term, interest-free lines of credit that casinos extend to patrons for the purpose of gambling on the premises. A system of this disclosure may ensure that such trackable debt credit is not cashed out and used at another property, for example.

A system or wallet of this disclosure may track such debt credit for the purposes of use and priority in a cash out event to ensure the trackable debt credit is used as intended, and gets repaid before allowing a transfer of that credit to a different account, funding sources, or conversion of that credit to a physical cash amount.

Tracking and preventing cash out of such debt credit allows for numerous advantages. Lenders of trackable debt credit, such as MarkerTrax™ or a casino, may ensure that their lines of trackable debt credit are used on the appropriate property, for example. For another example, a casino owner may extend trackable debt credit to be used specifically at the casino pool.

Numerous important differences differentiate the systems and methods of this disclosure from existing payment methods. First, each transaction requires an account holder to be logged into a system account at the point of sale, which inherently accomplishes two-factor authentication, the first factor being the login and the second factor being the payment method. Second, each system account includes identifying information to allow for regulatory compliance, which generally includes a copy of a government-issued identification such as a driver's license or passport required to (1) verify the age of the account holder and/or (2) comply with mandatory reporting as required, for example, by tax and gaming laws. Third, each system is optionally configured to reject certain payment methods as may be required to comply with gaming laws or as may otherwise be implemented at the discretion of a casino or the account holder for any number of reasons such as to reduce the risk of fraud. Fourth, each system is optionally configured to deidentify the use of funds, for example, such that a bank or credit card company associated with the payment method recognizes, or otherwise only reports to at least certain parties such as certain or all funding sources, the transaction as, for example, a generic transaction with a casino property instead of as a specific transaction with a specific point of sale system at the property or elsewhere. Deidentification avoids the classification of the transaction as related to, for example, one or more of wager gaming, dining, shopping, or other use(s) in third-party records and associated financial statements. Fifth, when used for wager gaming, the system inhibits theft by unauthorized users by reversing any remaining balance or winnings to the payment method, and, when winnings exceed funding, by optionally distributing the winnings by a ticket or receipt that requires identification of the account holder at a casino cage or other location prior to distribution of the winnings. Sixth, the system identifies all funding and cash-out events for wager gaming at a casino property and optionally across different casino properties that allows the detection of unusual, high-risk, potentially fraudulent, or reportable activity as well as real-time intervention to enforce responsible gaming and/or automated reporting to improve regulatory compliance. Seventh, when the system is implemented across different casino properties, it allows for the collection of data on the wager gaming behavior of individual account holders, which allows for targeted marketing to the individual account holders, for example, based on wager games that an individual account holder plays at one casino property to market the same or different wager games offered by a different casino property. Eighth, the system can identify patterns in wager gaming behavior in the aggregate, for example, to allow the creation of dynamic marketing opportunities to better incentivize wager gaming during off-peak hours and better monetize wager gaming during peak hours.

The system 100 depicted in FIG. 1 provides four, controlled external access points: (1) the universal payment connector 104, which interfaces with external accounts and payment processors, (2) the mobile app interface 106, which interfaces with account holders, (3) the cashless gaming interface 114, which interfaces with terminals that support transactions with system accounts, and (4) the reporting engine 124, which allows for monitoring and management of the system. These four access points may be tightly controlled as described herein to maintain a closed, secure system that provides some or all of the advantages described in this disclosure.

In some instances of the system 100 of FIG. 1 does not distinguish between at least some of the sources used to fund transactions once electronic currency enters the system. In such embodiments, individual account holders generally fund activity through the system from one or more external accounts 101, 102, 103 such that all funds are equivalent with respect to the system. Such funding provides numerous advantages to both account holders and operators of the system. In this fashion, or otherwise such as, for example, by deidentification as further disclosed herein, the account holders can advantageously mask the individual in-system transactions from third-party processors and financial institutions, for example, such that third parties lack insight into whether funds are used for wager gaming, dining, retail transactions, hotel accommodations, services, or otherwise.

Similarly, in some embodiments any joint account holders of external accounts lack the ability to identify how funds are used, for example, by accessing third-party statements. In some applications, the funds accessed through the system are only accessible for in-system purchases, which may be generally limited to a casino property, and the funds may only be transferred to accounts that are linked through the same system account, which inhibits third parties from accessing and fraudulently using the funds.

The system 100 of FIG. 1 allows transfer of funds between an operator account and third-party accounts to be queued and/or timed to enhance security, efficiently use computing resources, minimize transaction costs, and/or achieve another benefit. A transfer of funds initiated by an account holder may be postponed, for example, to verify whether the transfer is fraudulent based on analysis of the API logs 122 or CMS logs 123 by the reporting engine 124. A transfer of funds may similarly be delayed or queued for transfer in a batch process, for example, to favor judicious consumption of one or both of computing resources and human resources. A transfer may be postponed, for example, to occur at a certain frequency such as once per day such that transfers to and from the same accounts may be combined to conserve computer resources and/or reduce transaction fees. An account holder might fund one or both of wager gaming and purchase, for example, from the same external account with multiple transactions and/or return funds from wager gaming cash-out events to the same external account in one or more additional transactions; the systems and methods of this disclosure allow for processing the multiple and additional transactions as a single transaction rather than as different transactions. An account holder might fund wager gaming through the system, for example, with a $500 transfer from an external account in the morning, use the entire $500, and then transfer an additional $500 from the same external account in the afternoon. The account holder might then receive winnings from wager gaming and transfer the winnings back to the external account in the evening. If the system processes the transactions once per day such as at 5 AM on the following day, then the system only needs to process a single transfer for the external account, which conserves computer resources and may also save third-party transaction fees. Such aggregation and delayed processing is entirely optional, however, and may only be commercially advantageous in special cases.

In some embodiments, any gaming session that a player funds through the system 100 will default any cash out event back into the system. In some specific embodiments, any gaming session that a player funds through the system 100 will default any cash out event back into the system 100, in which the rules engine 121 determines the priority of the funds transfer(s) to one or more external funding sources 101, 102, 103. It should be appreciated that in some embodiments, when the wager gaming player presses a cash out button or other cash out activation feature on the wager gaming machine or otherwise associated with a wager game, a traditional physical cash out process may occur, or for example, a ticket with a credit amount may be printed or otherwise provided, such as digitally for example, from or for or in connection with the wager gaming machine. In such an embodiment, the system of this disclosure will perform a priority check with the rules engine and ensure the remaining debt credit balance is first transferred, or otherwise reserved, to, or for the benefit of, external funding source(s) before issuing an actual or virtual ticket with any excess remaining winnings credit that can be cashed out or otherwise transferred to or for the ticket bearer, for example, by a cashier function.

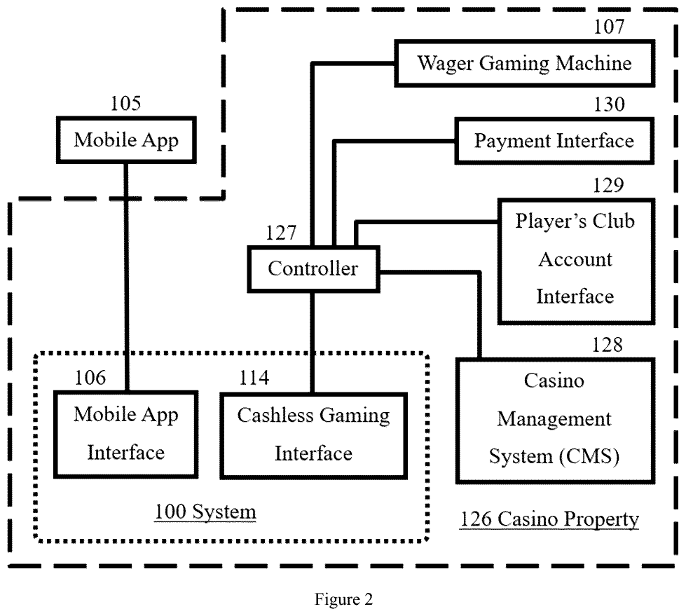

FIG. 2 depicts how the cashless gaming interface 114 of a system 100 of this disclosure interfaces with a wager gaming machine 107 in additional detail. In FIG. 2, the cashless gaming interface 114 of a system 100 interfaces with a controller 127, which interfaces with each of a wager gaming machine 107, a CMS 128, and a player's club account interface 129. A wager gaming player may add funds available to a system account, for example, using a mobile app 105, which interfaces with a mobile app interface 106 of the system 100. The wager gaming player accesses the funds for use on the wager gaming machine 107 by logging into the system account using a player's club account interface 129. The controller 127 processes transactions that credit the funds to the wager gaming machine 107, which transactions are mediated by both the system 100 and the CMS 128. When the player cashes out of a wager gaming machine 107, then the controller 127 processes the cash out, which is mediated by the system 100 and the CMS 128.

The controller 127 may be, for example, a commercial-of-the-shelf (COTS) single board computer. The controller 127 primarily manages communications between one or more wager gaming machines 107 and a back-end system that facilitates applications (such as cashless gaming applications) independent of the native system of a gaming machine 107 such as a slot machine interface board (SMIB). In some embodiments, the back-end system is the cashless gaming interface 114 although the back-end system may instead comprise a computer system such as a server that facilitates compatibility between the cashless gaming interface 114 and the controller(s) 127 such as the Evolve gaming platform (Nektan, Gibraltar). The controller 127 transmits and receives messages to and from the cashless gaming interface 114 of a system 100, the CMS 128, a player's club account interface 129, and a wager gaming machine 107. Each message may have a standard format as defined, for example, in a controller/system protocol document. Exemplary messages have the same header information and include one or more of (1) a header (HDR), (2) the address of a wager gaming machine (MUX), (3) the slot accounting system address (SAS), (4) the game ID (GID), (5) the message identification number (MID), (6) the message length (Len), (7) a command code (CMD), and (8) a message cyclic redundancy check (CRC). A specific message will follow the header information as defined for each individual message types. All messages have two parts that make up a single transaction event. The first part is defined as a “RX” message that is received by the controller 127, and the second part is a “TX” message that is transmitted by the controller 127. The RX message and the TX message are ordered based on whether the controller 127 initiates the message. Message types include, for example, enrollment validation messages, login-validation messages, funds—in messages, and funds-out messages.

To initiate system-mediated transactions, a wager gaming machine 107, point of sale (POS) system (for example, 108 or 109-113), or other interface (for example, 109) may first send a message to the cashless gaming interface 114, to create a session token, for example:
POST/api/v1/token HTTP/1.1
Host: {{CGI-URL}}
   The message might be sent directly from the wager gaming machine 107, POS system, or other interface, or the message might be sent, for example, by a controller 127 in communication with both (1) the wager gaming machine 107, POS system, or other interface and (2) the cashless gaming interface 114. In response, the system 100 creates a session token and sends a response to the wager gaming machine 107, POS system, or other interface, for example:

```
{
  “isSuccess”: true,
  “message”: “Token has been successfully generated.”,
  “data”: {
    “token”:
“eyJhbGciOiJIUzI1NiIsInR5cCI6IkpXVCJ9.eyJ1bmlxdWVfbmFtZSI6Im
xlbSIsIm5iZiI6MTY4MTM5NDM5MCwiZXhwIjoxNjgxNDgwNzkwLC
JpYXQiOjE2ODEzOTQzOTB9.CI_Vc62vSHdmTmXoYcyo97N9KGDo
p690VIwh7ASsIhE”,
    “expiresIn”: “2023-10-04T14:59:50.058835Z”
  }
}
```

As shown in the code above, the session token may optionally have an expiration date, which enhances security. The foregoing messages may optionally be shared by other external components that interface with the system 100 including, for example, a mobile app 105, which typically obtains a session token that allows for ongoing authentication of a specific mobile app 105 associated with a specific account holder.

A login-validation message is used to validate whether an account holder has logged into a wager gaming machine 107 using a player's club account login. Once validated, the login-validation message allows account holders to perform cashless transactions. After generating a session token, the wager gaming machine 107, POS system, or other interface must identify a system account to access functionality of the system 100. The wager gaming machine 107, POS system, or other interface may send a message to the system 100, for example:
GET/api/v1/player/{{player_id}} HTTP/1.1
Host: {{CGI-URL}}

The message might be sent directly from the wager gaming machine 107, POS system, or other interface, or the message might be sent, for example, by a controller 127 in communication with both (1) the wager gaming machine 107, POS system, or other interface and (2) the cashless gaming interface 114. In response, the system 100 identifies whether a system account is associated with a specific player ID and returns a confirmation message if such a system account exists, for example:

```
{
  “isSuccess”: true,
  “message”: “Successfully get information.”,
  “data”: {
    “id”: 2,
    “playerid”: “371200170”,
    “firstname”: “RICHARD”,
    “middlename”: “PAUL”,
    “lastname”: “ASTLEY”,
    “dob”: “”,
    “address1”: “”,
    “address2”: “”,
    “city”: “”,
    “state”: “”,
    “zip”: “”,
    “country”: “”,
    “phonenumber”: “2484345508”,
    “status”: “A”
  }
}
```

The content of the response is not limiting, and the foregoing response includes content that allows, for example, a CMS 128 to verify that the system account corresponds to a player's club account. The foregoing messages may optionally be shared by other external components that interface with the system 100 including, for example, a third-party mobile app 105 that is configured to interface with the system 100.

An enrollment validation message is used during an enrollment process and is sent from the cashless gaming interface 114 of a system 100 to the controller 127 when a new account holder enrolls an external funding source such as an electronic wallet, a MarkerTrax™ or Moolah™ Play account, or another funding source 101, 102, 103. The controller 127 responds to an enrollment validation message by providing demographic information about the member from the CMS 128 to the cashless gaming interface 114 of the system.

When a player is not yet enrolled with a system account, then the wager gaming machine 107, POS system, or other interface may directly enroll a new account, for example, based upon player's club account information from the CMS 128. The wager gaming machine 107, POS system, or other interface may send a message to the system 100, for example:

```
POST /api/v1/player HTTP/1.1
Host: {{CGI-URL}}
Content-Length: 361
{
  “PLAYERID”:“100000812345”,
  “FIRSTNAME”:“Richard”,
  “MIDDLENAME”:“Paul”,
  “LASTNAME”:“Astley”,
  “DOB”:“1966-02-06”,
  “ADDRESS1”:“123 Never Gonna Street”,
  “ADDRESS2”:“”,
  “CITY”:“ Newton-le-Willows”,
  “STATE”:“ Lancashire”,
  “ZIP”:“WA12”,
  “COUNTRY”:“ England”,
  “EMAIL”:“SuperRick@koinmobility.com”,
  “PHONENUMBER”:“2484345508”,
  “PROVIDERCODE”:“KOIN”
}
```

In response, the system 100 creates a system account and sends a confirmation message, for example:

```
{
  “isSuccess”: true,
  “message”: “Success registration”,
  “url”: “https://kmportal-test.koinmobility.com/casinotrac-koin/3rd-
party/enrollment?linkedId=REs2N0JLVVpYWlUyQktXUw==”
}
```

Following the establishment of a secure connection, which is optionally mediated by a session token, and verification or enrollment of a system account, the wager gaming machine 107, POS system, or other interface may optionally request information about the external funding sources 101, 102, 103 accessible by the system account including, for example, balances. The wager gaming machine 107, POS system, or other interface may request, for example, the identity of external funding sources 101, 102, 103 accessible by the system account:
GET/api/v1/payment_provider HTTP/1.1
Host: {{CGI-URL}}

In response, the system 100 returns the identities of the external funding sources 101, 102, 103:

```
{
  “isSuccess”: true,
  “message”: “Successfully get payment providers”,
  “data”: [
    {
      “providercode”: “KOIN”,
      “providername”: “Koin Wallet”
    },
    {
      “providercode”: “MTX”,
      “providername”: “Markertrax”
    }
  ]
}
```

The foregoing computer code identifies that the system account may access an electronic wallet 101 (the Koin Wallet) and a MarkerTrax™ account 103.

The wager gaming machine 107, POS system, or other interface may optionally request information about all external funding source 101, 102, 103 balances, for example:
GET/api/v1/balance/{{player_id}} HTTP/1.1
Host: {{CGI-URL}}

In response, the system 100 returns the balances of all available external funding sources 101, 102, 103:

```
{
  “isSuccess”: true,
  “message”: “Successfully get information.”,
  “data”: {
    “markertrax”: {
      “used”: 0,
      “available”: 0,
      “limit”: 0
    },
    “koinwallet”: {
      “available”: 0
    }
  }
}
```

The wager gaming machine 107, POS system, or other interface may optionally request information about a specific external funding source 101 balance, for example:

GET /api/v1/balance/{{player_id}}/{{provider_code}} HTTP/1.1
Host: {{CGI-URL}}

In response, the system 100 returns the balances of the single external funding source 101:

```
{
  “isSuccess”: true,
  “message”: “Successfully get information.”,
  “data”: {
    “koinwallet”: {
      “available”: 0.35
    }
  }
}
```

A funds-in message is a message to initiate a transfer from a funding source (for example, 101, 102, 103) to a wager gaming machine 107. The cashless gaming interface 114 of a system 100 will send to the controller 127 defined information that will be used to verify that the account holder completed a transfer of electronic currency to the wager gaming machine 107.

A funds-out message is a message to initiate a cash-out transaction that supports repayment of cash transfers and credit to one or more external funding sources 101, 102, 103. A cash out is generally performed by pressing a cash-out button on a wager gaming machine 107.

Each message typically also contains an error status code, which determines the success or failure of the message. An error status code of zero, for example, may indicate success, and a non-zero error status code will indicate that an issue of some type occurred that prevented the message transaction from being completed. A reason for failure may differ for different message types, and the non-zero error status codes are generally defined in a protocol document. A non-zero error status code may indicate, for example, that only a partial transfer was successful, that the transfer is pending and not complete, the transfer was cancelled by the host, that a transaction identifier is not unique, the transfer function is invalid or unsupported, the transfer amount is invalid, the transfer amount exceeds a wager gaming machine limit, the transfer amount is not an even multiple of the wager gaming machine denomination, the wager gaming machine is unable to perform transfer (for example, because the machine is being serviced, the machine is disabled, or a cash out is in progress), the wager gaming machine is unregistered for debit transfers, and the like.

New system account holders may be enrolled, for example, based upon an existing or new player's club account. Following identification of an existing player's club account or enrollment of a new player's club account, the new account holder will complete enrollment requirements for a third-party funding source. During the enrollment process, an Enrollment Validation message is sent through the system 100 to the controller 127, which Enrollment Validation message contains the player's club account login and PIN or password as well as information related to a government-issued identification such as an image of a driver's license of the new account holder, which information is used to verify the existence of the player's club account. The CMS 128 will reply through the controller 127 to the system 100 with available member demographic information such as name, address, birth date, and gender, which is used to create a system account in the Account Servicing Host (ASH) of the system 100, which newly-created system account then exists in the system 100 in a pending state. A non-zero error status code may be returned if the received member data does not match what exists in the CMS 128. Once verified, the external funding source will use the new account holder's information to access an account. The system 100 will receive confirmation from the external funding source 101, 102, 103 to link the external funding source 101, 102, 103 to a system account. The external funding source 101, 102, 103 will generally provide a unique identifier that links the external funding source 101, 102, 103 to the system account, which unique identifier is recorded by the ASH, and the newly-created account will then exist in the system 100 in an active status.

An account holder begins a cashless wagering session on a wager gaming machine 107 either by first entering a player's club account login and pin into a user interface on the wager gaming machine 107, by inserting a player's club card into a card reader of the wager gaming machine 107, by tapping a player's club card on a card reader of the wager gaming machine 107, or by other similar method. The account holder will then log into the mobile app 105 to initiate the cashless gaming session. The player service 119 of the system 100 will then verify that the account holder is logged into the player's club account using the login-validation message.

When an account holder initiates a transfer from an external funding source 101, 102, 103 through a wager gaming machine 107 or other user interface or POS, then the wager gaming machine 107 or other user interface or POS will send an API call to the system 100 with a funds-in message, the unique identifier, and the amount of the transfer. The system 100 will look up the unique identifier in the ASH and request transaction authorization from the funding source 101, 102, 103 associated with the unique identifier. If the funding source 101, 102, 103 is found and processes the requested transfer of the amount to an operator account associated with the wager gaming machine 107, then the system 100 will send a funds-in message to the controller 127, which funds-in message includes the player's club account login, a unique transaction ID generated by the system 100, and the amount of the transfer. The controller 127 will process the funds-in message and reply to the system 100 with a zero-error status code if the account holder commits to the transaction or a non-zero error status code, for example, if the transfer is cancelled, in which case the system 100 will direct the universal payment connector 104 to return the electronic currency to the funding source 101, 102, 103. Upon receipt of the reply from the controller 127, the system 100 will record the transaction in one or both of the CMS and API logs 122, 123.

When an account holder initiates a cash-out transaction, for example, using a cash-out button on a wager gaming machine 107, then the cashless gaming session is terminated, and the controller 127 will send a funds-out message to the system 100 containing the player's club account login of the account holder and the amount of the cash-out transaction if funds remain on the credit meter of the wager gaming machine 107. The system 100 will look up the player's club account login in the ASH and check the rules engine 121 to determine an order of priority of payments. If the rules engine 121 determines that a single external funding source 101, 102, 103 has priority over the entire amount of the cash-out transaction, then the API router 118 initiates a transaction to send the amount of the cash-out transaction from the operator account associated with the wager gaming machine 107 to the external funding source(s) 101, 102, 103. If the rules engine 121 determines that multiple external funding sources 101, 102, 103 have priority over the amount of the cash-out transaction, then the transaction service 120 will assign a unique transaction ID per external funding source, associate the unique transaction IDs with an original transaction ID received from the controller 127, and then process each transaction as an individual transaction.

The payment interface 130 also allows account holders to initiate transactions using a debit card, credit card (when allowable), other bank card, or other payment method as mediated, for example, by RFID, NFC, or UWB credentials such as a tap to pay feature of a mobile device. FIG. 2 depicts the payment interface 130 as a separate component, but the payment interface 130 may optionally be integrated into the wager gaming machine 107, the controller 127, or the player's club account interface 129. When an account holder initiates a transfer using a payment interface 130, then the payment interface 130 will send an API call to the system 100 with a funds-in message, the information transmitted to the payment interface 130, and the amount of the payment. Depending upon the payment method, the API router 118 may optionally direct the player service engine 119 to verify the transmitted information against the ASH. The API router 118 may also optionally direct the rules engine 121 to verify that the payment method is valid, for example, to exclude the funding a wager gaming machine 107 with a credit card when disallowed by a gaming jurisdiction or otherwise. If the player service engine 119 verifies the information and the rules engine 121 validates the payment method as may be required, then the API router 118 may direct the universal payment connector 104 to process the payment against the third-party account 102 associated with the payment method. When the player service engine 119 cannot verify the transmitted information, for example, because the information is encrypted, then the universal payment connector 104 may optionally provide information from the ASH such as the player name, zip code, and/or address to the processor of the third-party account 102 to allow external verification when allowed by the processor. If the third-party account 102 allows and processes the requested payment, then the electronic currency is transferred from the third-party account 102 to an operator account associated with the wager gaming machine 107, and the system 100 will send a funds-in message to the controller 127, which funds-in message includes the player's club account login, a unique transaction ID generated by the system 100, and the amount of the payment. The controller 127 will process the funds-in message and reply to the system 100 with a zero-error status code if the account holder commits to the payment or a non-zero error status code, for example, it the payment is cancelled, in which case the system 100 will direct the universal payment connector 104 to return the electronic currency to the third-party account 102. Upon receipt of the reply from the controller 127, the system 100 will record the payment in one or both of the CMS and API logs 122, 123. The system 100 may optionally record the information provided or a portion thereof in the ASH and/or assign a unique identifier to the information, for example, to allow the account holder to cash out any unused electronic currency and/or winnings back to the original payment method.

When an account holder initiates a cash-out transaction following payment mediated by a payment interface 130, then the cashless gaming session is terminated, and the controller 127 will send a funds-out message to the system 100 containing the player's club account login of the account holder and the amount of the cash-out transaction if funds remain on the credit meter of the wager gaming machine 107. The system 100 will look up the player's club account login in the ASH and check the rules engine 121 to determine an order of priority of payments. If the rules engine 121 identifies that the ASH contains sufficient information to reverse a portion or all of a prior payment mediated by the payment interface 130, then the system 100 may determine that the prior payment method has priority over a portion or all of the cash-out transaction. If the rules engine 121 determines that multiple external funding sources 101, 102, 103 have priority over the amount of the cash-out transaction, then the transaction service 120 will assign a unique transaction ID per external funding source, associate the unique transaction IDs with an original transaction ID received from the controller 127, and then process each transaction as an individual transaction.

A first advantage of the foregoing methods is enhanced security. The system 100 of this disclosure allows for rigorous two-factor authentication. The operator may maintain records that include a copy of government-issued identification for each account holder and other identifying personal information such as a social security number, for example, to allow for compliance with government reporting requirements. The system 100 may be configured to only accept payment methods that match the name of the account holder and optionally other identifying information such as the zip code and/or address of the account holder. When a transaction occurs on a property controlled by the operator, then the operator may record video of the individual initiating the transaction, for example, with existing surveillance equipment already in widespread use throughout most modern casinos such as video surveillance equipment integrated into a CMS 128. Any individual who attempts to use a system account of another account holder in conjunction with a payment method of the same account holder will inevitably be recorded on video committing a crime. Further, they system 100 may be configured to reverse any remaining credit and/or winnings back onto the original payment method instead of cashing out, for example, currency such that unauthorized use of a system account and payment method of another would be unlikely to result in any benefit. The system 100 further may be configured to provide a ticket or receipt for any winnings in excess of the electronic currency used to fund, for example, a wager gaming machine 107, which ticket or receipt may only be paid by a cashier who can independently verify the identity of the account holder such as with reference to as a photograph on file for the account holder. The system 100 may further be configured to require additional security measures, for example, such as two-factor authentication mediated by a mobile device and/or biometric identifier. The system 100 or system accounts thereof may require an account holder to acknowledge use of a payment method or third-party account 101, 102, 103, for example, on a mobile app 105 associated with the account holder to allow use of a payment method mediated by the payment interface 130 and/or a third-party account 101, 102, 103, which mobile app 105 may optionally require a biometric identifier such as a fingerprint, face scan, palm print, iris scan, retina scan, palm vein scan, and the like. The mobile app 105 may also allow for geolocation confirmation, for example, to confirm that the account holder is in physical proximity to a payment interface 130, controller 127, player's club account interface 129, or wager gaming machine 107. The system 100 may provide a biometric reader to receive a biometric identifier such as a fingerprint, face scan, palm print, palm vein scan, and the like, which biometric reader may optionally be integrated into a player's club account interface 129, payment interface 130, controller 127, and/or wager gaming machine 107. A CMS 128 in communication with a system 100 may identify and/or track an account holder on a casino property 126, for example, by facial recognition or otherwise thereby allowing a system 100, CMS 126, or controller 127 to verify or cross-check the identity of an account holder when entering into a cashless transaction mediated by a payment interface 130 or by an account saved to the ASH of the system 100.

A second advantage of the foregoing method is enhanced monitoring, analytics, and reporting capabilities. Contemporary casinos generally require cash payments and offer, for example, ATMs to dispense cash to wager gaming players. Even if ATMs could monitor the amount of cash that an individual wager gaming player withdraws, they provide little actionable intelligence into the use of the withdrawn currency for gambling activity, other entertainment, dining, or otherwise. A wager gaming player may intentionally or unintentionally evade efforts to track the use of cash, for example, by simply failing to login to a player's club account during a wager gaming session. A wager gaming player who is intoxicated, for example, may intentionally or unintentionally evade tracking by failing to login to a player's club account as a result of intoxication, and it is precisely this type of wager gaming player who benefits from tracking to ensure responsible wager gaming activity. A wager gaming player who is too intoxicated to remember the pin associated with his or her player's club account or too intoxicated to otherwise login to the player's club account may nevertheless remain fully capable of feeding physical currency into a wager gaming machine. Allowing cashless transactions mediated by either a payment interface 130 or account stored in the ASH of a system 100 therefore reduces the probability that an account holder will unintentionally evade efforts to track the use of cash.

In compliance with gaming regulators' requirements, the reporting engine 124 may be configured to produce reports selected from (1) an activity report, (2) an audit trail report, (3) a cashier transaction report, (4) an error and exception report, (5) a failed transaction report, (6) a liability report, (7) a month end reconciliation, (8) a wagering account transfer (WAT) in reconciliation report, (9) a WAT out reconciliation report, (10) a user access listing, (11) a wagering balance summary report for each system account, (12) a wagering balance summary report for the overall system, (13) a wagering detailed report for every system account, (14) patron/player account summary and details reports, (15) cashier summary and detail reports, (16) a significant event log, (17) an access control report/log, (18) a data alteration report/log, (19) a WAT detail report by gaming area, (20) a WAT summary report by gaming area, (21) an overall WAT summary report, (22) a gaming revenue report, (23) user access logs, and (24) an exception report/log. Reports generated by the reporting engine 124 may be viewed, for example, on a control panel 125, downloaded directly, or pushed to an SFTP such as in a PDF, XLS, or CSV format. Certain reports are expanded upon below to provide context and example structure, but these reports may not necessarily be included and may be structured any number of different ways.

An Activity Report may offer a comprehensive account of a day's transactions in a player's wagering account. It may track the opening balance, deposits, transfers to and from gaming devices (cash-in and cash-out), withdrawals, and any adjustments made throughout the day. The ending balance provides a clear, final tally. This report gives a snapshot of player account activity, aiding in financial management and compliance, and ensuring account integrity. Key terms for such an activity report may include: “Beginning Balance” is the amount of money in the wagering account at the start of the day. “Deposits” are additional funds added to the account during the day. “Cash In” is the money moved from the wagering account to a gaming device to place bets. “Cash Out” is the money moved back to the wagering account from a gaming device when the player wins. “Withdrawals” are funds removed from the account by the player. “Adjustments” could be any corrections or modifications made to the account balance during the day, for example due to a system error. “Ending Balance” is the amount of money in the wagering account at the end of the day. Static Reporting structure: This report, once generated, remains static regardless of when it's generated.

An Audit Trail Report may provide a complete, static snapshot of cashless adjustments at a casino. It can capture all pertinent details, including player data, transaction type, values, adjustments, and overseeing cashier ID. Crucial for error detection and transaction tracking, and serves as a valuable resource for auditing practices and regulatory compliance. Key terms for such an audit trail report may include: “Property ID” refers to the unique identifier for the specific property where the transaction took place. “Property Name” is the actual name of the property where the transaction took place. “Player Card Number” is the unique identification number assigned to a player's card. “Player First Name” and “Player Last Name” are the names of the player involved in the transaction. “Transaction Type” indicates the nature of the transaction. “Gaming Device ID” is the unique identifier for the specific gaming device involved in the transaction. “Previous Transaction Value” is the amount of money involved in the transaction before any adjustments were made. “Adjusted Transaction Value” is the amount of adjustment applied to the transaction, either adding to or subtracting from the previous transaction value. “Final Transaction Value” is the total value of the transaction after the adjustment has been made. “Adjustment Date” is the date when the adjustment was made to the transaction. “Transaction Time” is the exact time when the transaction took place. “Cashier ID” is the unique identifier for the cashier or system operator overseeing the transaction. “Source” indicates where the transaction originated from, such as the host system or a specific gaming device. “Grand Total” is the aggregate of all the final transaction values. Static Reporting structure: This report, once generated, remains static regardless of when it's generated.

A Liability Report may provide an overview of a casino's cashless wagering activity, including unique identifiers for properties and players, transaction details, wagering instrument types, and the total amount transferred in and out of gaming devices. Crucially, it can also calculate the casino's liability, representing the total unredeemed cashless wagers. This succinct yet comprehensive report can serve as an essential tool for audit, management, and regulatory purposes, enabling transparency and control over cashless gaming transactions. Key terms for such a liability report include: Property ID: Include the unique identifier assigned to a particular gaming property or location. Retrieve this information from the database or property records. Property Name: Provide the actual name of the gaming property or location. Retrieve this information from the database or property records. Player Card Number: Include the unique number associated with the player's card involved in the transaction. Retrieve this information from the player records or transaction logs. Player First Name/Last Name: Include the names of the player involved in the transaction. Retrieve this information from the player records or transaction logs. Transaction #: Assign a unique number to each transaction for tracking purposes. This number should be generated and assigned when the transaction occurs. Date Issued: Include the date when a particular transaction or wagering instrument was issued. This information should be recorded at the time of the transaction. Wagering Instrument Type: Indicate the type of cashless instrument used for wagering, such as a mobile app, player card, or other form. This information should be logged or stored in the transaction records. Total Cashless-In: Calculate the total amount of money that has been transferred from a player's account to the gaming devices. Retrieve this information from the transaction records or logs and calculate the sum. Total Cashless-Out: Calculate the total amount of money that has been transferred from the gaming devices back to a player's account. Retrieve this information from the transaction records or logs and calculate the sum. Casino Liability: Calculate the amount of unused cashless wagers that the casino is responsible for. This includes the money that players have in their accounts or in play that they have yet to cash out. Calculate this by subtracting the Total Cashless-Out from the Total Cashless-In.

A Cashier Transaction Report can provide a concise record of all player transactions handled by casino cashiers. It can track key information such as the gaming property, cashier, player involved, transaction details, and the amounts debited or credited. Aggregated data, presented as daily, monthly, and yearly totals, offer a timeline of financial activity. This report can serve as an invaluable tool for auditing and financial oversight, ensuring transparency and accuracy in the casino's monetary exchanges. Key terms for such a cashier transaction report may include: Property ID: Include the unique identifier assigned to the gaming property or location. Retrieve this information from the database or property records. Property Name: Provide the actual name of the gaming property. Retrieve this information from the database or property records. Cashier ID: Include the unique identifier for the cashier overseeing the transaction. Retrieve this information from the cashier records or transaction logs. Cashier Name: Provide the actual name of the cashier overseeing the transaction. Retrieve this information from the cashier records or transaction logs. Player Card Number: Include the unique number associated with the player's card involved in the transaction. Retrieve this information from the player records or transaction logs. Player First Name/Last Name: Include the names of the player associated with the transaction. Retrieve this information from the player records or transaction logs. Date & Time: Include the specific time and date when the transaction took place. This information should be recorded in the transaction logs or records. Transaction Details: Provide a brief description of the transaction, such as ‘Deposited by Player’. Retrieve this information from the transaction records or logs. Transaction Type: Indicate the category of the transaction, such as ‘Cash In’ or ‘Cash Out’. This information should be logged or stored in the transaction records. Debit ($)/Credit ($)/Transaction Total ($): Calculate the amount of money involved in the transaction, distinguishing between debits (funds removed from the cashier's balance by the player) and credits (funds added to the cashier's balance by the player). The Transaction Total represents the net balance after the transaction (Credits-Debits). Grand Totals: Calculate the aggregated amounts for all transactions, including debits, credits, and transaction totals, over a certain period. This provides an overview of financial activity. Cashier Summary: Generate an overview of the total debits, credits, and transaction totals handled by each cashier. This summary should provide a breakdown of their financial activity. Summary (Current Day Totals, Month-to-Date Totals, Year-to-Date Totals, Previous Year Totals): Provide summarized transactional data over various periods, including the current day, month-to-date, year-to-date, and the previous year. This allows for a comparative and chronological view of financial activity.

An Error and Exception Report may offer a detailed record of system errors or exceptions in cashless transactions at a gaming property. It captures specifics such as the time, involved player, gaming device, and nature of the error or exception. This report is essential for understanding transactional issues, troubleshooting errors, and enhancing system integrity. It also assists regulators and auditors in ensuring adherence to operating standards and maintaining transactional accuracy. Once generated, this report remains unchangeable, preserving data integrity for future review. Key terms for such an error and exception report may include: Date & Time: Include the date and time when the system error or exception occurred. This information should be logged or stored in the system error records. Property ID: Include the unique identifier assigned to the gaming property or location. Retrieve this information from the database or property records. Property Name: Provide the name of the gaming property or location. Retrieve this information from the database or property records. Player Card Number: Include the number on the player's card that is used to track their play and offer rewards. Retrieve this information from the player records or transaction logs. Player First Name: Include the first name of the player involved in the transaction. Retrieve this information from the player records or transaction logs. Player Last Name: Include the last name of the player involved in the transaction. Retrieve this information from the player records or transaction logs. Gaming Device ID: Include the unique identifier for the gaming device where the error or exception occurred. Retrieve this information from the gaming device records or logs. Player ID: Include the unique identifier for the player involved in the transaction. Retrieve this information from the player records or transaction logs. Transaction No.: Include the unique identifier for the transaction during which the error or exception occurred. This information should be logged or stored in the transaction records or error logs. Error/Exception Type: Describe the type of error or exception that occurred, such as “Invalid PIN” or “Account Unknown”. This information should be logged or stored in the error records or exception logs. Error Message/Description: Include the message that was displayed or logged when the error or exception occurred. Retrieve this information from the error logs or exception records. Attempts: Include the number of attempts that were made before the error or exception was logged. This information can be logged or stored in the error records or exception logs. Socket ID: Include the identifier for the network socket or connection that was in use when the error or exception occurred. This information can be helpful for diagnosing network-related errors or exceptions. Retrieve this information from the system logs or error records. Static Reporting Structure: Clarify that once the report is generated, it remains static and does not change regardless of when it is accessed or viewed.

A Failed Transactions Report can be a critical tool for monitoring transactions within a gaming property. A failed transaction report can record all instances where a transaction attempt was unsuccessful, detailing the player information, gaming device ID, attempted transaction amount, and the reason for failure. This report provides transparency on failed transactions, which is crucial for identifying recurring issues, pinpointing devices that might require maintenance or system errors that need rectification. By tracking the number of attempts per transaction, it can provide insight into potential operational inefficiencies or issues impacting player experience. This report, being static once generated, can be a reliable source for auditors and regulators to verify the integrity of the casino's transaction system and ensure adherence to gaming regulations. Key terms for such a failed transaction report may include: Date & Time: Include the date and time when the failed transaction occurred. This information should be logged or stored in the transaction records or error logs. Property ID: Include the unique identifier assigned to the gaming property or location where the failed transaction occurred. Retrieve this information from the database or property records. Property Name: Provide the name of the gaming property or location. Retrieve this information from the database or property records. Player Card Number: Include the number on the player's card that is used to track their play and offer rewards. Retrieve this information from the player records or transaction logs. Player First Name: Include the first name of the player involved in the failed transaction. Retrieve this information from the player records or transaction logs. Player Last Name: Include the last name of the player involved in the failed transaction. Retrieve this information from the player records or transaction logs. Gaming Device ID: Include the unique identifier for the gaming device where the failed transaction occurred. Retrieve this information from the gaming device records or logs. Player ID: Include the unique identifier for the player involved in the failed transaction. Retrieve this information from the player records or transaction logs. Transaction No.: Include the unique identifier for the failed transaction. This information should be logged or stored in the transaction records or error logs. Error/Exception Type: Describe the type of error or exception that occurred during the failed transaction, such as “Invalid PIN” or “Account Unknown”. This information should be logged or stored in the error records or exception logs. Error Message/Description: Include the message that was displayed or logged when the error or exception occurred during the failed transaction. Retrieve this information from the error logs or exception records. Attempts: Include the number of attempts that were made before the error or exception was logged during the failed transaction. This information can be logged or stored in the error records or exception logs. Socket ID: Include the identifier for the network socket or connection that was in use when the error or exception occurred during the failed transaction. This information can be helpful for diagnosing network-related errors or exceptions. Retrieve this information from the system logs or error records. Static Reporting Structure: Clarify that once the report is generated, it remains static and does not change regardless of when it is accessed or viewed.

A Month-End Casino Cashless Transaction Report can provide a snapshot of a casino's cashless wagering activity for a month. It covers the liabilities carried over from the previous month, total cashless wagers in and out, and the outstanding liabilities for both the casino and patrons. The report can offer a comprehensive view of all cashless transactions, assisting auditors and regulators in ensuring compliance and financial integrity of the casino's cashless wagering operations. Key terms for such a month-end casino cashless transaction report may include: Previous Month Liability Balance: Include the total liability from cashless transactions carried forward from the previous month. This balance serves as the starting point for the current month's cashless transactions. Retrieve this information from the previous month's records or logs. Total Cashless Wagered In: Calculate the cumulative total of all cashless funds that were wagered into the casino's gaming devices during the month. Retrieve this information from the transaction records or logs and calculate the sum. Total Cashless Wagered Out: Calculate the cumulative total of all cashless funds that were paid out by the casino's gaming devices during the month. Retrieve this information from the transaction records or logs and calculate the sum. Total Liability to the Casino: Calculate the total amount of unused cashless wagers that the casino is liable for. This includes funds that are still in play, funds in expired player accounts, or funds in accounts that have been inactive for a significant period. Calculate this by subtracting the total cashless wagers paid out from the total cashless wagers wagered in. Total Liability to the Patrons: Calculate the total amount of unused cashless wagers that the patrons are holding. This includes funds in active player accounts that have not been played or cashed out. Retrieve this information from the player records or account balances. Total Cashless Transactions: Calculate the sum of all cashless transactions, both wagered in and wagered out, during the month. Retrieve this information from the transaction records or logs and calculate the sum. Net Cashless Liability: Calculate the casino's final liability at the end of the month. This is calculated as the previous month's liability balance plus the total cashless wagers wagered in, minus the total cashless wagers wagered out. Adjust for any liability changes due to expired, voided, or unused cashless wagers. Static Reporting Structure: Clarify that once the report is generated, it remains static and does not change regardless of when it is accessed or viewed. Grand Totals: Calculate the total cashless transactions for the period, which is the sum of all cashless transactions (both in and out) during the month. Calculate the net cashless liability, which represents the final liability of the casino at the end of the month.

A WAT In Recon Report can provide a comparison between the cash value recorded by each gaming device and the system's records, helping to identify discrepancies. This static snapshot of data can assist auditors and regulators in detecting anomalies, ensuring accuracy, and identifying potential issues in cashless transactions. Key terms in such a WAT In Recon report may include: Gaming Device ID: This refers to the unique identifier assigned to each gaming device. Retrieve this information from the device records or logs. Total WAT In (Device): Calculate the cumulative monetary value logged by a gaming device's cashless meter. This value represents the total transactions and corresponding financial value recorded by the device. Retrieve this information from the device logs or cashless meter data. Total WAT In (System): Calculate the total monetary value recorded by the system for a particular device. This value is used to track and validate the transactions logged by the device. Retrieve this information from the system logs or transaction records. Variance: Calculate the difference between the total monetary value logged by the device's cashless meter (Total WAT In (Device)) and the total value recorded by the system (Total WAT In (System)). A negative discrepancy indicates that the system has recorded more than what the device's meter has logged, while a positive discrepancy means the device has logged more than the system has recorded. Calculate this difference for each device by subtracting the system value from the device value. Percentage Variance: Calculate the percentage variance for each device. For negative variances, the percentage is also negative to indicate that the system's recorded amount is higher than the device's recorded amount. Calculate the percentage variance by dividing the discrepancy by the Total WAT In (Device) and multiplying by 100. Note that the percentage values may vary depending on the precise values in each row. Static Reporting Structure: Clarify that once the report is generated, it remains static and does not change regardless of when it is accessed or viewed.

A WAT Out Recon Report can compare the total cashless payouts by each gaming device with the system's records. Discrepancies are highlighted via variance calculations. This unchanging data snapshot can be valuable for auditors and regulators, assisting in anomaly detection, ensuring transaction accuracy, and identifying potential issues in the cashless gaming system. Key terms for such a WAT Out Recon Report can include: Gaming Device ID: This refers to the unique identifier assigned to each gaming device. Retrieve this information from the device records or logs. Total WAT Out (Device): Calculate the cumulative monetary value logged by a gaming device's cashless meter for WAT Out transactions. This value represents the total transactions and corresponding financial value recorded by the device. Retrieve this information from the device logs or cashless meter data. Total WAT Out (System): Calculate the total monetary value recorded by the system for a particular device's WAT Out transactions. This value is used to track and validate the transactions logged by the device. Retrieve this information from the system logs or transaction records. Variance: Calculate the difference between the total monetary value logged by the device's cashless meter (Total WAT Out (Device)) and the total value recorded by the system (Total WAT Out (System)). A negative discrepancy indicates that the system has recorded more than what the device's meter has logged, while a positive discrepancy means the device has logged more than the system has recorded. Calculate this difference for each device by subtracting the system value from the device value. Percentage Variance: Calculate the percentage variance for each device. For negative variances, the percentage is also negative to indicate that the system's recorded amount is higher than the device's recorded amount. Calculate the percentage variance by dividing the discrepancy by the Total WAT Out (Device) and multiplying by 100. Note that the percentage values may vary depending on the precise values in each row. Static Reporting Structure: Clarify that once the report is generated, it remains static and does not change regardless of when it is accessed or viewed.

The control panel 125 may be used, for example, to obtain transaction history for a system account by sending a message to the reporting engine 124:
GET/api/v1/transactions/{{player_id}} HTTP/1.1
Host: {{CGI-URL}}

An example response message from the reporting engine 124 to the control panel 125 follows:

```
{
  “isSuccess”: true,
  “data”: [
    {
      “transactionId”: “9999912345”,
      “referenceId”: “4a56610b-8fb8-46d7-9019-7c6932f9a18c”,
      “transactionType”: “debit”,
      “playerId”: “371005193”,
      “providerCode”: “KOIN”,
      “currency”: “USD”,
      “amount”: 100,
      “assetId”: “S1000”,
      “transactionTimestamp”: “2023-06-26 14:30:30”,
      “transactionStatus”: “A”
    },
    {
      “transactionId”: “9999912346”,
      “referenceId”: “c5cac014-f0af-4179-b21a-3a30e4c6c5d8”,
      “transactionType”: “debit”,
      “playerId”: “371005193”,
      “providerCode”: “KOIN”,
      “currency”: “USD”,
      “amount”: 500,
      “assetId”: “S1000”,
      “transactionTimestamp”: “2023-06-26 14:32:23”,
      “transactionStatus”: “A”
    }
  ]
}
```

Such reporting may similarly be available to an account holder using, for example, either a mobile app 105 or an interface of a wager gaming machine 107.

Where applicable, the software of the system generally and reporting engine specifically, which reporting engine prepares various reports such as those in the foregoing paragraph, is submitted for certification testing, interoperability, and/or gaming approvals. In some embodiments, the certification testing, interoperability, and/or gaming approvals mature into one or more of registrations and licenses, which set forth regulatory permissions to deploy a system of this disclosure in a gaming jurisdiction.

Additionally, the system 100 may be configured based on an open integration strategy, for example, such that external funding sources 101, 102, 103 can set up reports to be displayed on the control panel 125 and such that the casino property 126 may have a single user interface for the operator for all of its external funding sources 101, 102, 103, which may advantageously support open API or batch upload processes.

All transactions, API logs, access and event logs may optionally be stored, for example, in a local database of the system 100. Any reports not identified as part of a regulatory compliance report may be generated by the reporting engine 124 and formatted if the data exists in the database.

In some embodiments, a system of this disclosure is located entirely on the property of a casino, which improves electronic security by improving physical security of the system. Various components of the system may nevertheless be installed and run off-site; various databases and/or software, for example, may be installed and run on an off-site data center.

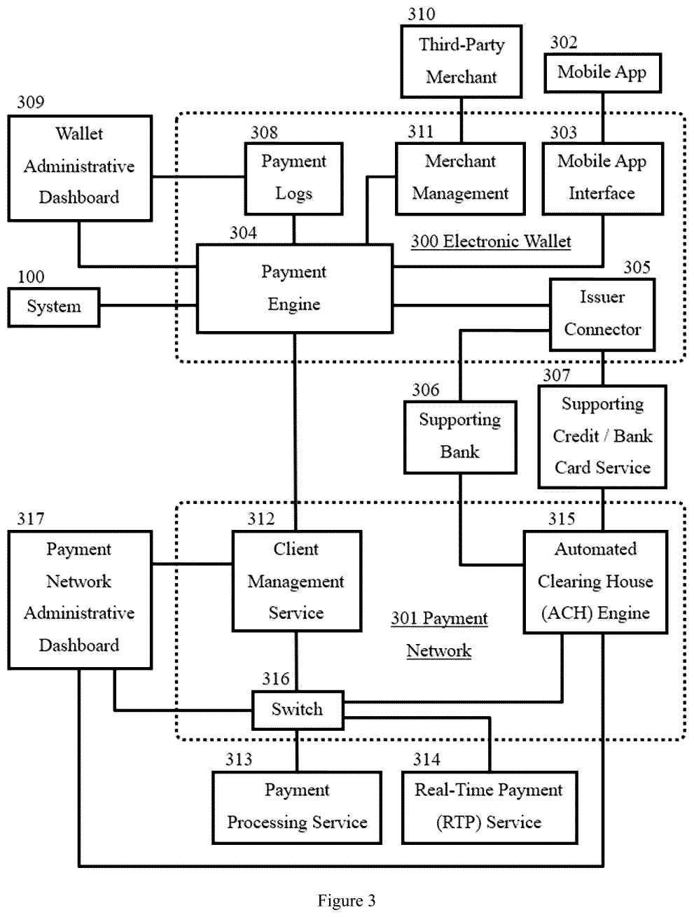

FIG. 3 depicts an electronic wallet 300 of this disclosure as well as supporting infrastructure. An electronic wallet holder may access his or her electronic wallet 300 with a customer portal such as with the mobile app 302 depicted in FIG. 3. The mobile app 302 allows a consumer to direct transactions that fund the wallet, for example, with a payment engine 304. When the electronic wallet 300 holds electronic currency that is transferred into the electronic wallet 300, then the electronic currency is deposited into a supporting bank 306, and an issuer connector 305 of the electronic wallet 300 mediates such deposits. In some embodiments, the issuer connector 305 also mediates communications with a supporting credit/bank card service 307, which issues one or both of virtual bank cards and physical bank cards to mediate payment of funds from the electronic wallet 300. Exemplary supporting credit/bank card services include, for example, Qolo (Florida, United States). An electronic wallet 300 of this disclosure may be used, for example, to transfer funds into a system 100 of this disclosure, which funds transfer(s) are mediated by the payment engine 304. Funds transfers are recorded in payment logs 308 of the electronic wallet 300, which payment logs 308 are accessible by the provider of the electronic wallet 300 through an external wallet administrative dashboard 309. The payment engine 304 may advantageously interface with a merchant management service 311 of the electronic wallet 300 to mediate transactions with one or more third-party merchants 310. The electronic wallet 300 may be configured to transfer cash paid to third-party merchants 310, for example, to fund the electronic wallet 300, and the third-party merchants 310 may also accept electronic currency from the wallet for payment of goods and services. The payment engine 304 also interfaces with a payment network 301, which is operated either (1) by the provider of the electronic wallet 300 or (2) for the benefit of the provider of the electronic wallet 300. The payment network 301 generally includes a client management service 312, which receives funds transfer requests from a plurality of electronic wallets 300 and directs the processing of such requests by third parties. The client management service 312 interfaces with a switch 316, which routes funds transfer requests to the appropriate third party. The provider of the payment network 301 may engage any number of different third-party payment processing services 313 such as PNM® (New Mexico, United States), Shift4 (Pennsylvania, United States), and the like as well as real-time payment (RTP) services 314 such as Ren and Dandelion, which are provided by Euronet® (Kansas, United States). The payment network 301 may also advantageously comprise an automated clearing house (ACH) engine, which may process funds transfers with the supporting bank 306 and supporting credit/bank card service 307 as well as funds transfers with any other bank that supports ACH transfers. The provider of the payment network 301 may generally monitor and control the payment network 301 through a payment network administrative dashboard 317.

The collecting of relevant personal information as a prerequisite for obtaining an electronic wallet or system account of this disclosure combined with monitoring and tracking of gaming activity can provide improved identification of events triggering reporting requirements related to suspicious activity and currency transaction amounts. In some embodiments, credentials, such as, for example, a driver's license can be scanned and submitted as part of an electronic application process, allowing for the storage of the driver's license image and data, which may be used in submission as part of an activity or transaction report to a regulatory authority. In some implementations, the method and rules for monitoring transactions mediated by one or both of the electronic wallet and system can one or both of identify and prevent suspicious activities and reportable transactions.

In some embodiments, the systems and methods of this disclosure may throttle the funding of wager gaming from external sources, which increases the control that casinos wield over gaming behavior. In some instances, the system may be used to enforce responsible gaming, for example, by controlling access to external funds thereby limiting wager gaming by limiting access to funds instead of by directly confronting an account holder. In some instances, the systems and methods of this disclosure accelerate access to external funds to provide just-in-time access to electronic currency to continue game play, for example, without requiring an account holder to have previously withdrawn funds from an external account. This can, in some embodiments, achieve the desired goal of controlling gaming behavior for responsible gaming purpose without the undesirable consequence of making the player seek out a cash advance machine or cashier to obtain additional funds when desired where there is no responsible gaming issue. In some instances, this can result in an improved gaming experience as well as improved velocity of cash entering the casino floor while simultaneously improving responsible gaming management.

Additional benefits and advantages can include the ability to allocate electronic currency to wager gaming activity in advance, during play, or both, thus improving on floor funds management, reducing friction for player fund access, and increasing velocity of cash entering the casino floor. Each of the system and electronic wallet can, in some embodiments, reduce cash management overhead costs for a casino as well, including one or more of reducing or eliminating the depositing of funds, reducing labor demands such as cage, vault, drop, and count teams, floor attendants, security personnel, and audit personnel, reducing the need for count machines and bank machines, reducing the costs associated with paper management, and reducing interest to the casino associated with large cash floats.

A further advantage of providing easily accessible electronic currency is the reduction or elimination of players needing to carry cash. By this reduction or elimination in the cash carry, incidence of theft of player funds can be reduced, resulting in one or more of improving the quality of the casino experience for patrons, decreasing costs to the casino for liability coverage and security, increasing the number and frequency of return player visits, and improving the reputation of the casino with respect to potential customer perception, community perception, or both. This can have a positive revenue impact on the operator, reduce player losses due to theft, and foster a positive community perception that can promote pro-casino local, state, and national laws and regulations, as well as pro-casino zoning decisions.

In addition, the presence of easily obtained electronic currency can reduce the burden on players by reducing or eliminating the need procure and manage a substantial cash carry. Players can be free from having to consider where to obtain cash, and also having to consider the potential stake needed in advance for the relevant gaming period. Further, the presence of easily obtained electronic currency can reduce or eliminate the player burden of managing the cash carry while engaged in gaming, including the inconvenience of submitting cash to devices, tables, or sports book, retrieving of cash from devices, tables, or sports book, and the continued need to monitor cash not being played to avoid loss, such as by dropping bills or coins. The reduction or elimination of this overhead can improve the player experience, along with decrease player anxiety associated with one or both of carrying cash and the risk of losing cash.

The reduction to the cash-only nature of the casino gaming environment can have additional advantages and benefits applicable to communities. The reduction in the cash nature of the activity can reduce the burden on community services such as the demands placed on law enforcement, the courts, social and health care services, and the like.

When casinos reduce the presence of cash inside and outside of their properties, then the need for security and police presence can be reduced, which reduces the overall cost of services and can reduce both the burden on taxpayers as well as improve the ability for such resources to focus on other more pressing criminal activity. Similarly, courts can experience a decreased caseload as the number of arrests decline.

Each of the system and electronic of this disclosure also allow greater transparency into the sources of funds used by account holders, which reduces the operator's exposure to liability for regulatory compliance lapses for failing to report source of funds violations. Further, such source of funds issues can be addressed in advance of arrival at the casino, which improves player experience and reduces the cost to the operator of manually managing such issues on the casino property.

In some embodiments, the operator enters into a relationship with a supporting bank, which holds electronic currency deposited, for example, into an electronic wallet, and which may extend credit accounts such as credit card accounts to electronic wallet holders. The supporting bank can alleviate casinos from managing electronic currency and credit that belong to its patrons. Additional benefits to the operator can include one or more of; a) managing of at least some player account status communications, such as, for example, notices, statements, and the like, b) real-time or near-real-time transactional online reporting, oversight, or both, c) treasury management and reporting, and d) credit account settlement and financial accounting support.

The system and electronic wallet of this disclosure can provide one or more of a variety of technical advantages including, but not limited to, reducing the memory storage and bandwidth demands by providing a single channel to process transactions, improving privacy and security of personal information through reuse of collected information with limited information proliferation, improving system user interface efficiencies through the streamlined electronic wallet and mobile app, and rule-based cash-out management features, each of which reduce multi-system processor load through the introduction of real-time or near real-time, at-game, electronic currency management, and the like.

Further, the system and electronic wallet address various inefficiencies existing in contemporary technologies and procedures relating to the administration of electronic currency associated with gaming activity by allowing patrons to control and direct the transfer of electronic currency into a wager game from a mobile app.

This approach can, in some embodiments, yield high efficiencies across systems and processes, including one or more of:
Faster processing due to the reduction or elimination of manual procedures, reduced system integrations, or both.
Reduced processing and memory demand due, at least in part, to the reduction or elimination of data duplication across systems.
Reduced processing and memory demands through optimized identity and verification procedures and reduced data retrieval and replication using one or more of device verification methods, email verification methods, linking with bank accounts, linking with player's club accounts, linking with operator CRM systems, and the like.
Improved security due in part to reduced data transmission activity resulting, at least in part, from the reduction of involvement of multiple intermediary system stopping points.
Reduced network bandwidth usage due to a reduction in system traffic resulting from the elimination of some ad hoc processes such as email verifications, file transfers, fax activity, system integrations, scanning activity, and the like.
Reduction in patron user error and frustration through a single, simplified, unified graphical user interface, reducing or eliminating paper transactions, phone verifications, and staff engagement.

Additional benefits and advantages in some embodiments can include the ability to transfer electronic currency in advance, during play, or both, thus improving on floor-funds management, reducing friction for player fund access, and increasing the velocity of currency entering the casino floor. This electronic-based transaction facilitation can reduce the cash management overhead costs as well, including one or more of reducing or eliminating the depositing of funds, reducing labor demands such as cage, vault, drop, and count teams, floor attendants, security personnel, and audit personnel, reducing the need for count machines and bank machines, reducing the costs associated with paper management, and reducing interest to the casino associated with large cash floats.

In some embodiments, the increased visibility in and control over electronic currency can contribute to responsible gaming by allowing account holders to easily monitor and control amount and timing of funds transfers and cash-out events. This can also provide benefit to the account holder as the ease and real-time nature of the mobile experience allows the player just-in-time electronic currency to continue game play and access to electronic currency without the need to obtain cash prior to entering the casino floor.

In some embodiments, a single party provides and/or controls the system, mobile app, the backend infrastructure, wager gaming machines, etc. For example, a casino or other wager gaming establishment can provide all of these aspects of the system. In yet other embodiments, a third-party entity may provide the electronic wallet and manage transactions between the electronic wallet and external funding sources without involvement of the wager gaming establishment except the cooperation needed to make the electronic wallet compatible, for example, with a system of this disclosure.

In some embodiments, the electronic wallet can be used to provide a cashless gaming experience at wager gaming establishments. The mobile application allows the wager gaming player to request, use, and manage wager gaming credit while the player from any location including on a gaming floor, standing in front of a wager gaming machine, home, or the like. The player can use the electronic currency from the electronic wallet play any suitable wager game in the wager gaming establishment. This includes games played on wager gaming machines, wager gaming tables (roulette, poker, etc.), and the like. Cashless gaming provides a number of advantages including reducing the risk of theft of money, employee embezzlement, and the like.

It should be appreciated that the term “casino” includes any establishment where wagering occurs. This can include sports and race books, bingo, keno, and the like. For example, the electronic wallet may be used by players at sports games to place wagers on the game. An account holder can transfer electronic funds for the purpose of wagering on sports at any time during a game and make a wager with a sports book establishment.

In some embodiments, the electronic wallet can be used to facilitate coordination with the sports book to give the user the ability to obtain electronic currency without the risk of giving out credit card information online, which is generally an inherent risk with making a wager through an Internet website. The electronic wallet, which can be a mobile application in some embodiments, also allows the sports book to monitor usage patterns that indicate whether an account holder is a problematic gamer for whom remedial measures might be appropriate. The electronic wallet also can provide an expanded possible revenue source for the sports book both by increased wagering and earning at least a portion of the loan fee (usually with this app, a portion of the credit granted or of a fixed fee for granting credit).

Certain embodiments of the system and electronic wallet are described with reference to methods, apparatus (systems), and computer program products that can be implemented by computer program instructions. These computer program instructions can be provided to a processor of a general-purpose computer, special-purpose computer, or other programmable data processing apparatus to produce a machine, such that the instructions, which execute via the processor of the computer or other programmable data processing apparatus, create means for implementing the acts specified herein to transform data from a first state to a second state.

These computer program instructions can be stored in a computer-readable memory that can direct a computer or other programmable data processing apparatus to operate in a particular manner, such that the instructions stored in the computer-readable memory produce an article of manufacture including instruction that implement the acts specified herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified herein.

The various illustrative logical blocks, modules, circuits, and algorithm steps described in connection with the embodiments disclosed herein can be implemented as electronic hardware, computer software, or combinations of both. The various illustrative logical blocks, modules, and circuits described in connection with the embodiments disclosed herein can be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The blocks of the methods and algorithms described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

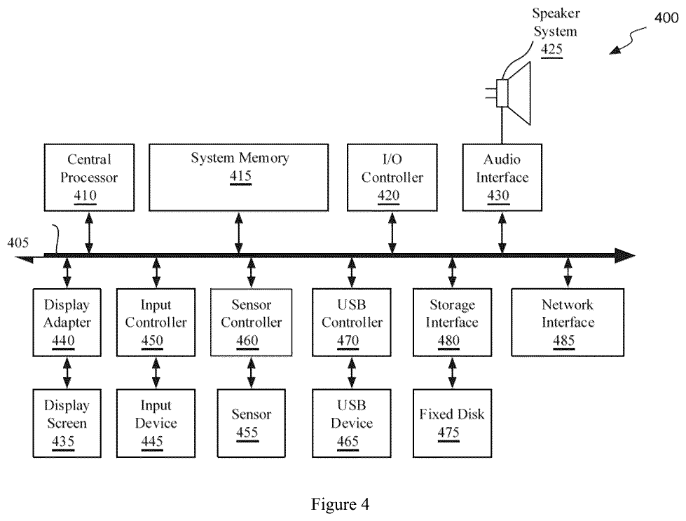

Referring now to FIG. 4, in one configuration, a computing device 400 includes a bus 405 which interconnects major subsystems of computing device, 400, such as a central processor 410, a system memory 415 (typically RAM, but which may also include ROM, flash RAM, or the like), an input/output controller 420, an external audio device, such as a speaker system 425 via an audio output interface 430, an external device, such as a display screen 435 via display adapter 440, an input device 445 (e.g., remote control device interfaced with an input controller 450), one or more USB devices 465 (interfaced with a USB controller 470), and a storage interface 480. In some instances, the computing device 400 includes one or more sensors 455 connected to bus 405 through a sensor controller 460 and a network interface 485 (coupled directly to bus 405).

Bus 405 allows data communication between central processor 410 and system memory 415, which may include read-only memory (ROM) or flash memory (neither shown), and random access memory (RAM) (not shown), as previously noted. The RAM is generally the main memory into which the operating system and logic instructions are loaded. The ROM or flash memory may contain, among other code, the Basic Input-Output system (BIOS) which controls basic hardware operation such as the interaction with peripheral components or devices. Instructions resident with the credit wager system with loan and warrantying computing devices are generally stored on and accessed via a non-transitory computer readable medium, such as a hard disk drive (e.g., fixed disk 475) or other storage medium. Additionally, applications may be in the form of electronic signals modulated in accordance with the application and data communication technology when accessed via interface 485.

Storage interface 480, as with the other storage interfaces of controller 400, may connect to a standard computer readable medium for storage and/or retrieval of information, such as a fixed disk drive 475. Fixed disk drive 475 may be a part of computing device 400 or may be separate and accessed through other interface systems. Network interface 485 may provide a direct connection to a remote server via a direct network link to the Internet via a POP (point of presence). Network interface 485 may provide such connection using wireless techniques, including digital cellular telephone connection, Cellular Digital Packet Data (CDPD) connection, digital satellite data connection, or the like. In some embodiments, one or more sensors connect to computing device 400 wirelessly via network interface 485.

Many other systems or subsystems may be connected in a similar manner. Conversely, all of the components of FIG. 4 need not be present to practice the present systems and methods. The systems and subsystems may be interconnected in different ways from that shown in FIG. 4. The aspect of some operations of a system such as that shown in FIG. 4 are readily known in the art and are not discussed in detail in this application. Computer instructions to implement the present disclosure may be stored in a non-transitory computer-readable medium such as one or more of system memory 420 or fixed disk 475. The operating system provided on computing device 400 may be, for example, iOS™, ANDROID™, MS-WINDOWS™, UNIX™, LINUX™, OSX™, or another known operating system.

The configuration of FIG. 4 is not limiting, and various other systems or subsystems may be used to perform the various embodiments of this disclosure such as on-premises physical servers or virtual servers as well as on-cloud infrastructure such as Amazon Web Services, Google Cloud, Azure, and the like.

Depending on the embodiment, certain acts, events, or functions of any of the methods described herein can be performed in a different sequence, can be added, merged, or left out altogether (e.g., not all described acts or events are necessary for the practice of the method). Moreover, in certain embodiments, acts or events can be performed concurrently, e.g., through multi-threaded processing, interrupt processing, or multiple processors or processor cores, rather than sequentially. Moreover, in certain embodiments, acts or events can be performed on alternate tiers within the architecture.

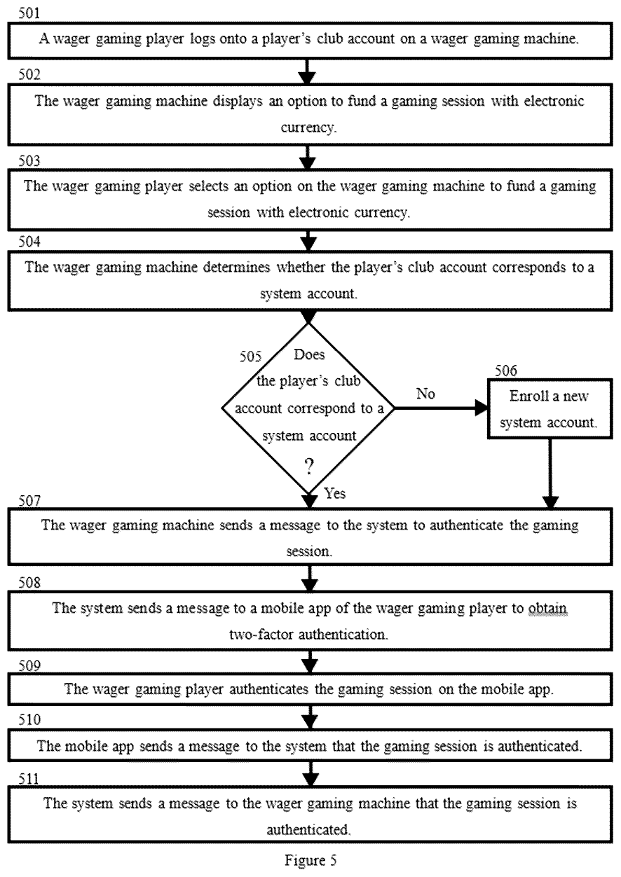

FIG. 5 is a flow chart that depicts exemplary steps for a player to log into a system account of this disclosure from a wager gaming machine. At 501, a wager gaming player logs onto a player's club account on a wager gaming machine. At 502, the wager gaming machine displays an option to fund a gaming session with electronic currency. At 503, the wager gaming player selections an option on the wager gaming machine to fund a gaming session with electronic currency. At 504, the wager gaming machine determines whether the player's club account corresponds to a system account. At 505, a decision is made based on whether the player's club account corresponds to a system account. If the player's club account does not correspond to a system account, then the flow proceeds to 506 where a new system account is enrolled. After enrollment of a new system account, the flow proceeds to 507. If the player's club account does correspond to a system account, then the flow proceeds to 507 where the wager gaming machine sends a message to the system to authenticate the gaming session. At 508, the system sends a message to a mobile app of the wager gaming player to obtain two-factor authentication. At 509, the wager gaming player authenticates the gaming session on the mobile app. At 510, the mobile app sends a message to the system that the gaming session is authenticated. At 511, the system sends a message to the wager gaming machine that the gaming session is authenticated.

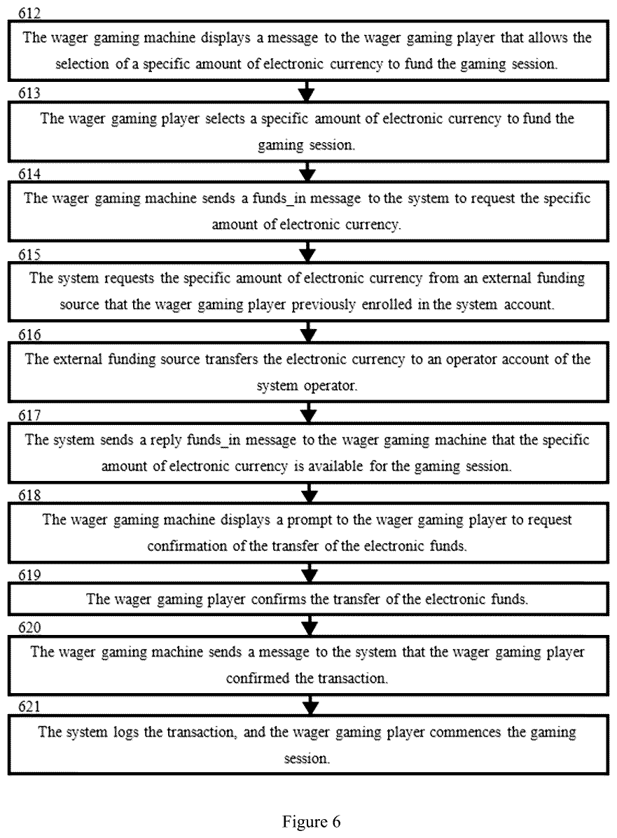

FIG. 6 is a flow chart that depicts exemplary steps for a player to transfer electronic currency from an external funding source to a wager gaming machine as mediated by a system of this disclosure. At 612, the wager gaming machine displays a message to the wager gaming player that allows the selection of a specific amount of electronic currency to fund the gaming session. At 613, the wager gaming player selects a specific amount of electronic currency to fund the gaming session. At 614, the wager gaming machine sends a funds_in message to the system to request the specific amount of electronic currency. At 615, the system requests the specific amount of electronic currency from an external funding source that the wager gaming player previously enrolled in the system account. At 616, the external funding source transfers the electronic currency to an operator account of the system operator. At 617, the system sends a reply funds_in message to the wager gaming machine that the specific amount of electronic currency is available for the gaming session. At 618, the wager gaming machine displays a prompt to the wager gaming player to request confirmation of the transfer of the electronic funds. At 619, the wager gaming player confirms the transfer of the electronic funds. At 620, the wager gaming machine sends a message to the system that the wager gaming player confirmed the transaction. At 621, the system logs the transaction, and the wager gaming player commences the gaming session.

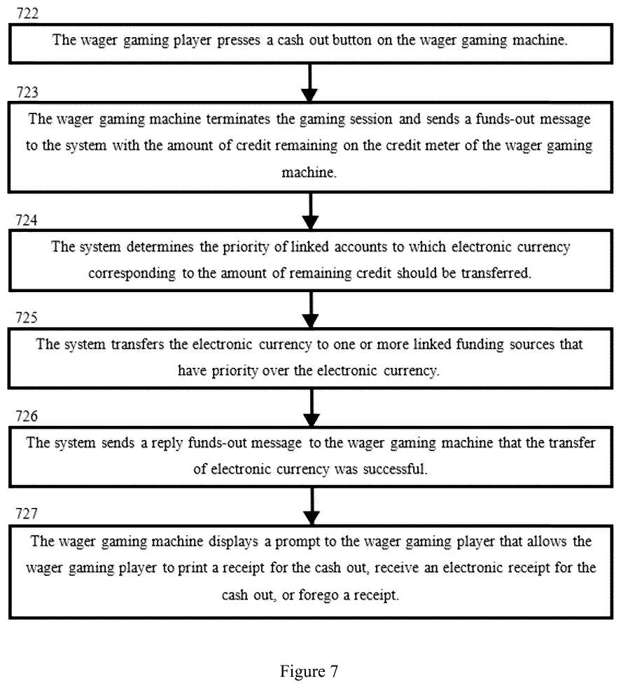

FIG. 7 is a flow chart that depicts exemplary steps for a player to cash out gaming credit from a wager gaming machine to an external funding source as mediated by a system of this disclosure. At 722, the wager gaming player presses a cash out button on the wager gaming machine. At 723, the wager gaming machine terminates the gaming session and sends a funds-out message to the system with the amount of credit remaining on the credit meter of the wager gaming machine. At 724, the system determines the priority of linked accounts to which electronic currency corresponding to the amount of remaining credit should be transferred. At 725, the system transfers the electronic currency to one or more linked funding sources that have priority over the electronic currency. At 726, the system sends a reply funds-out message to the wager gaming machine that the transfer of electronic currency was successful. At 727, the wager gaming machine displays a prompt to the wager gaming player that allows the wager gaming player to print a receipt for the cash out, receive an electronic receipt for the cash out, or forego a receipt.

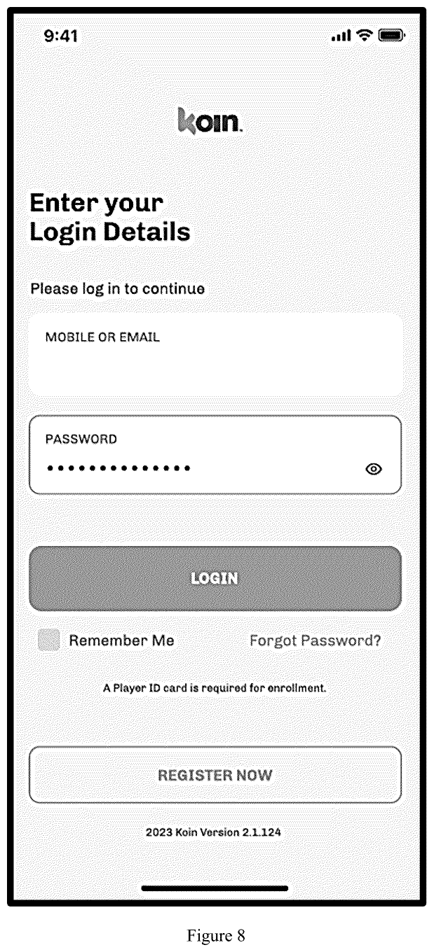

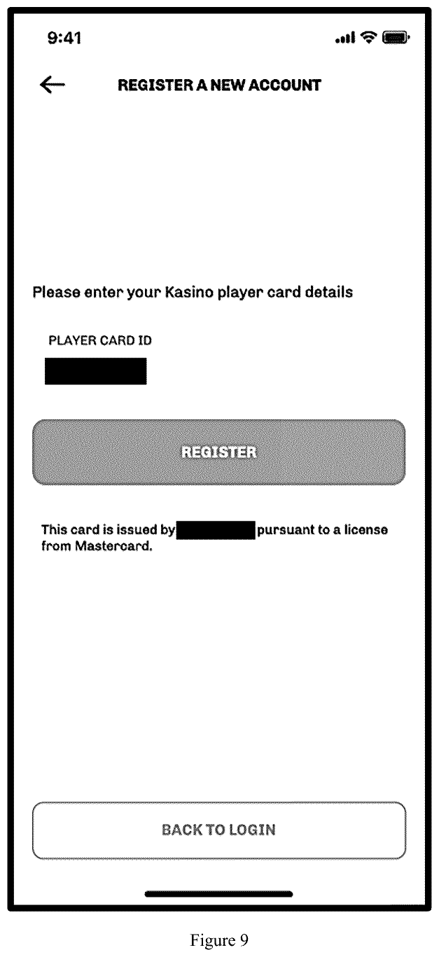

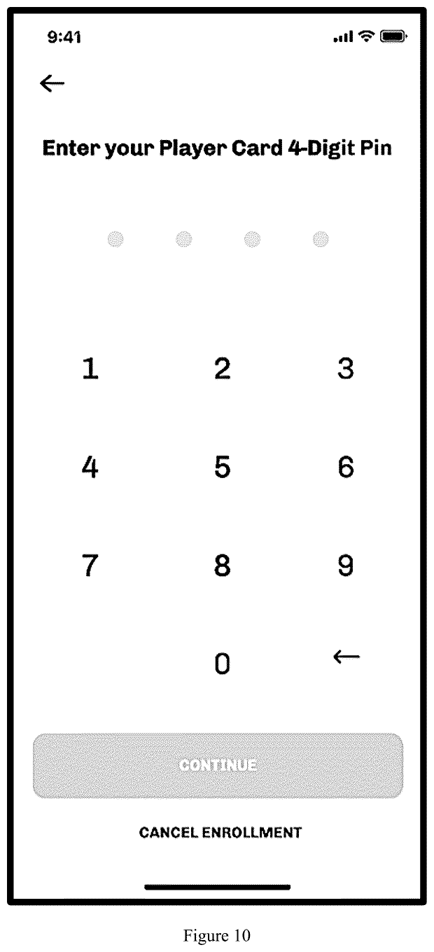

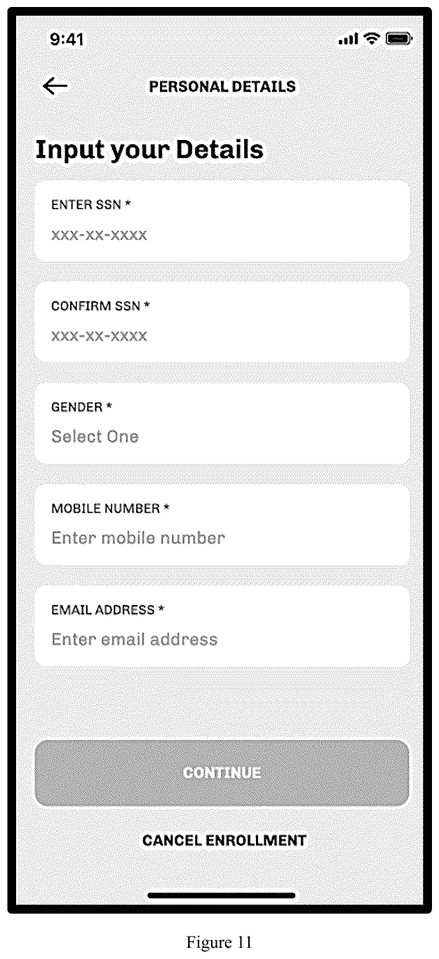

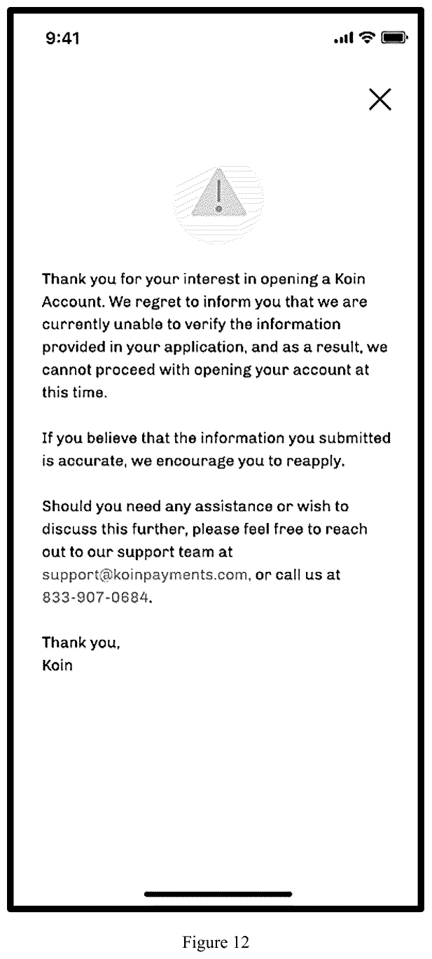

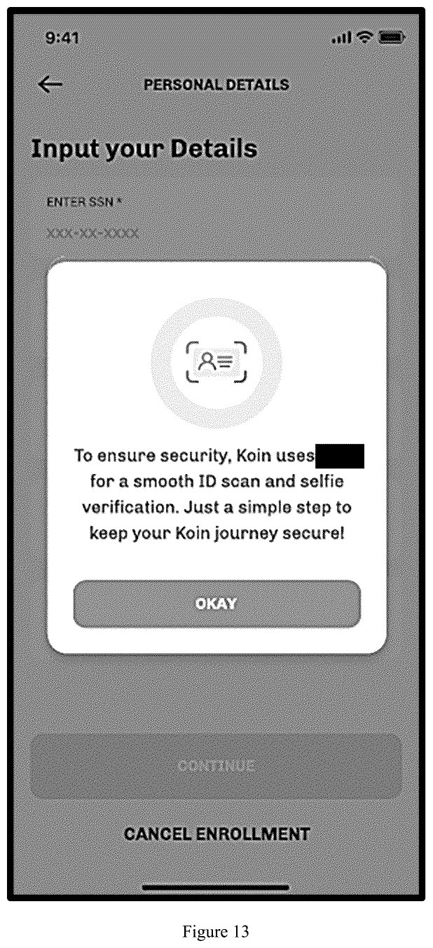

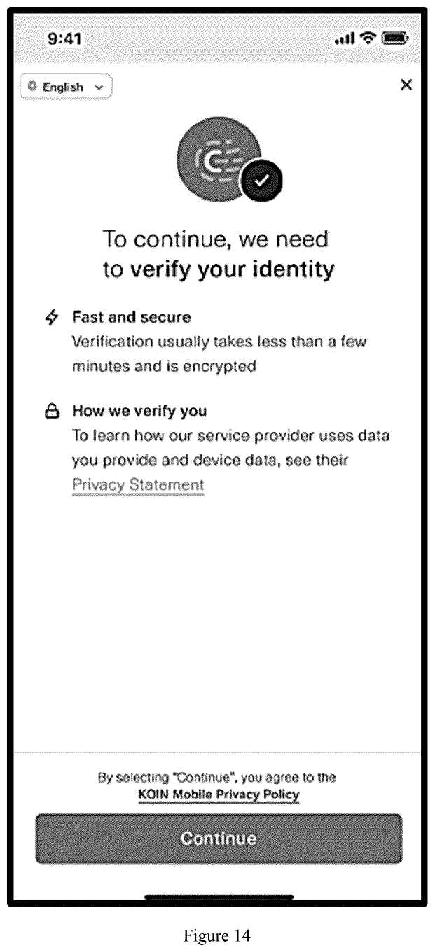

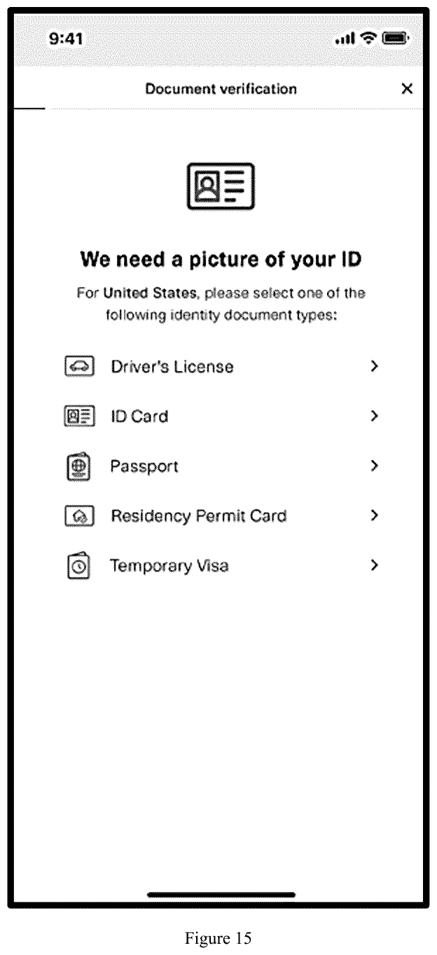

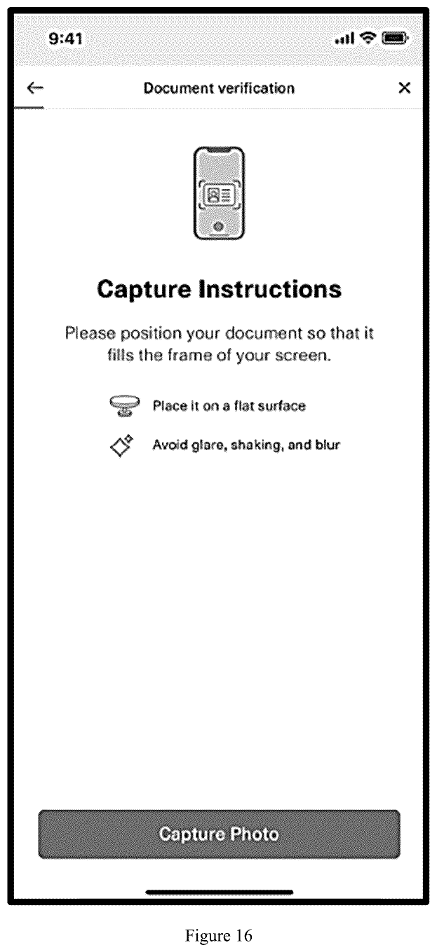

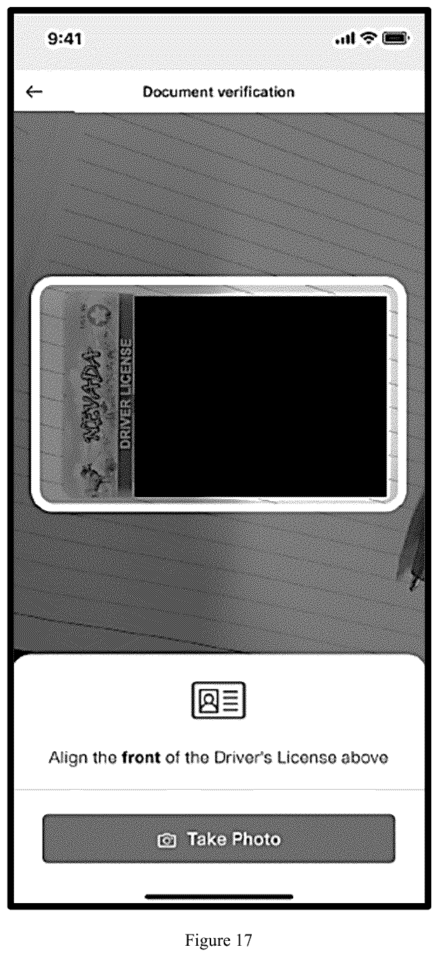

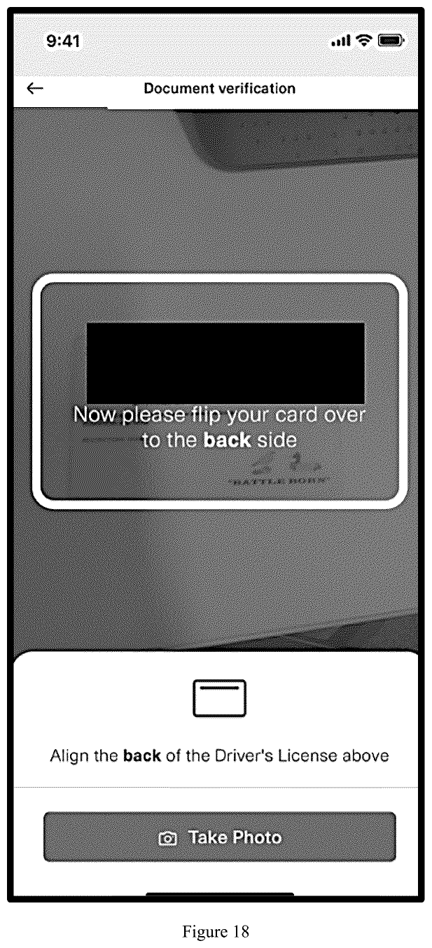

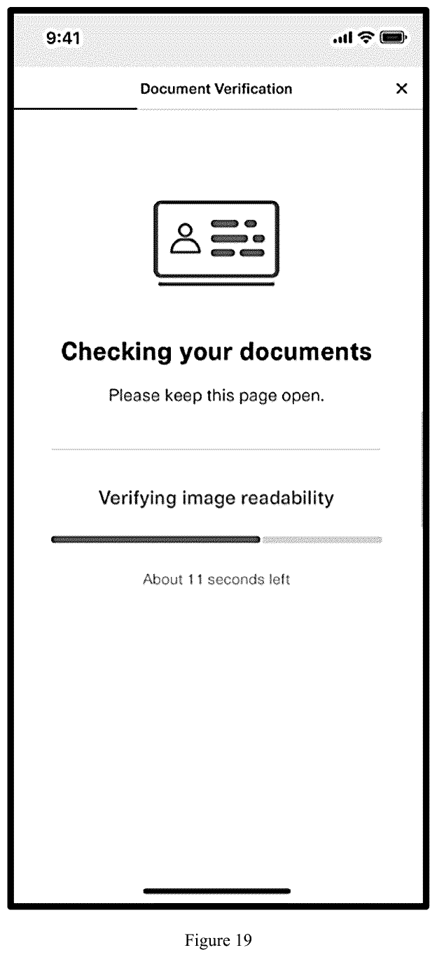

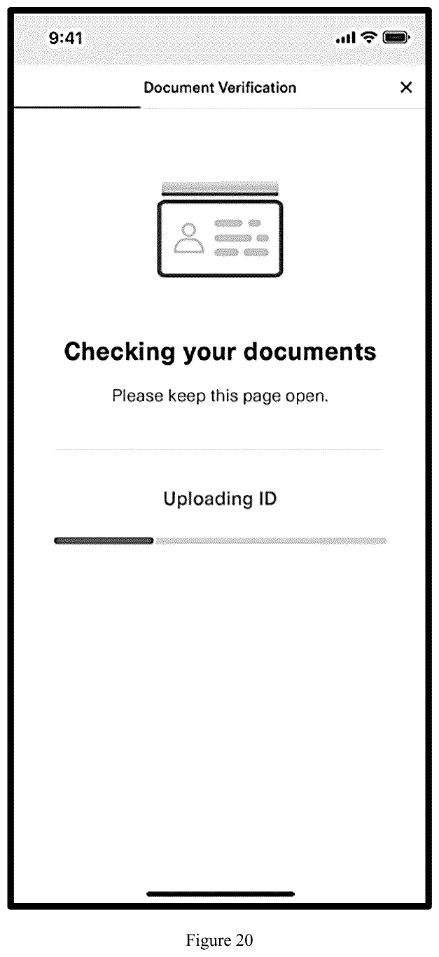

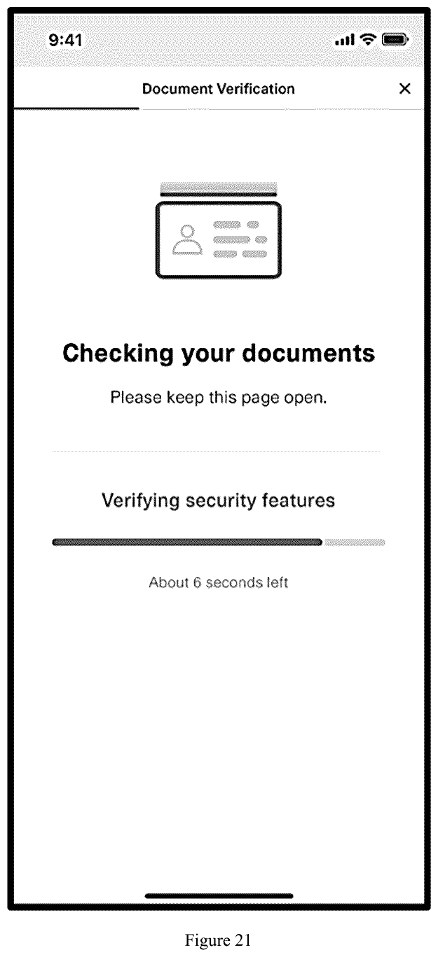

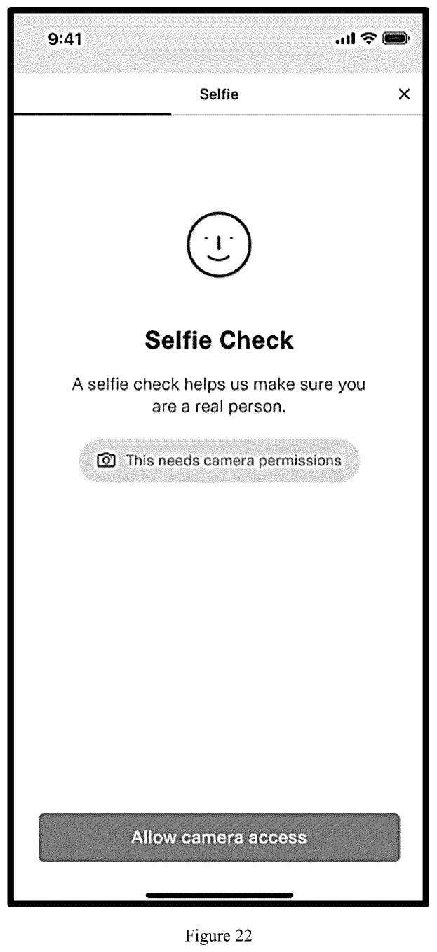

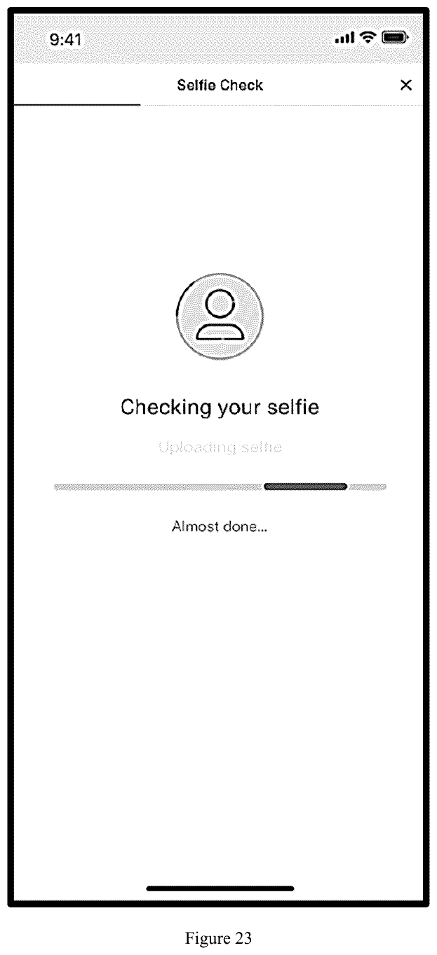

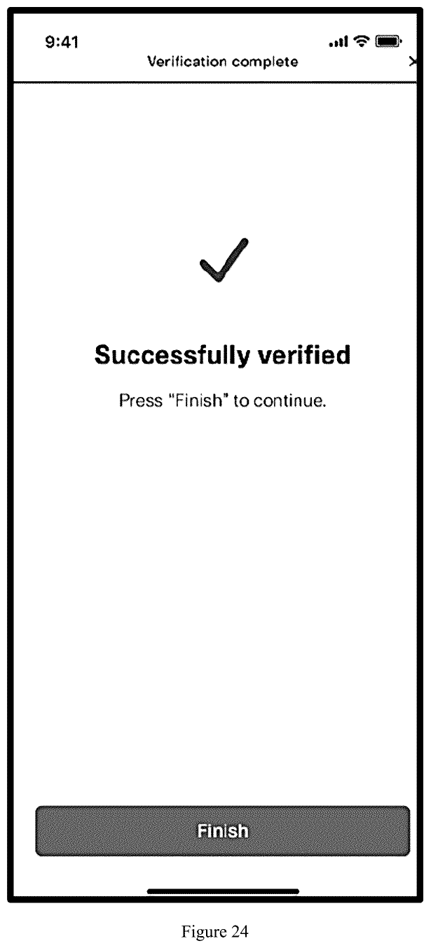

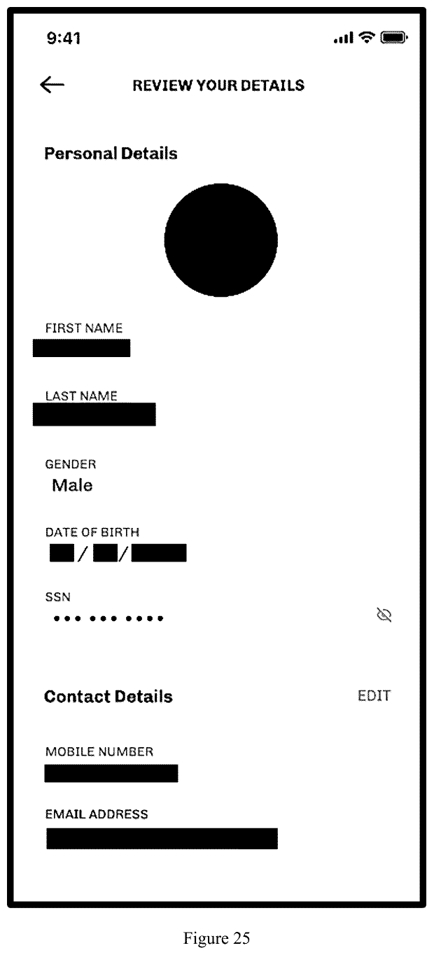

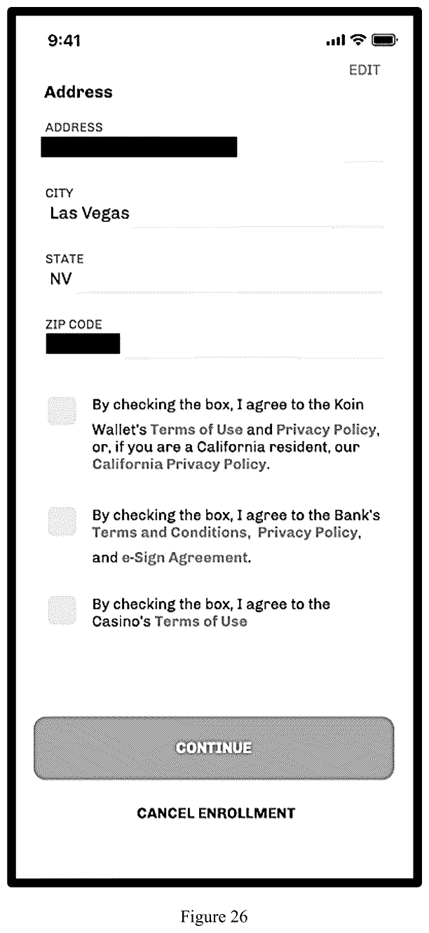

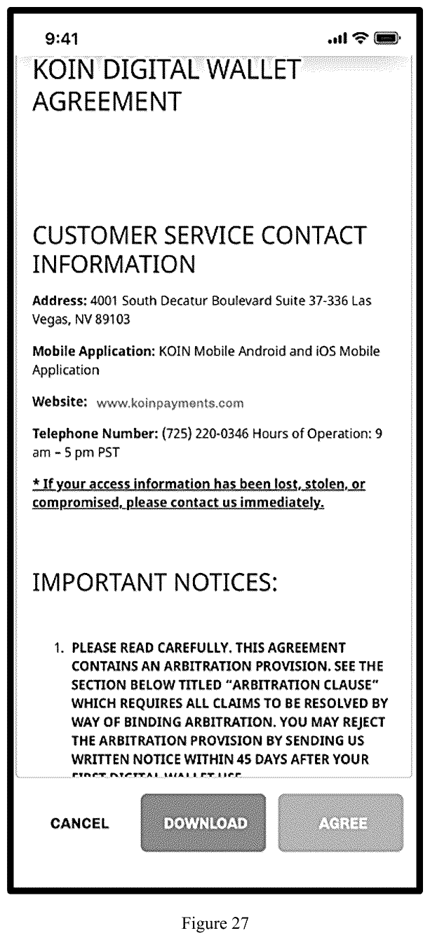

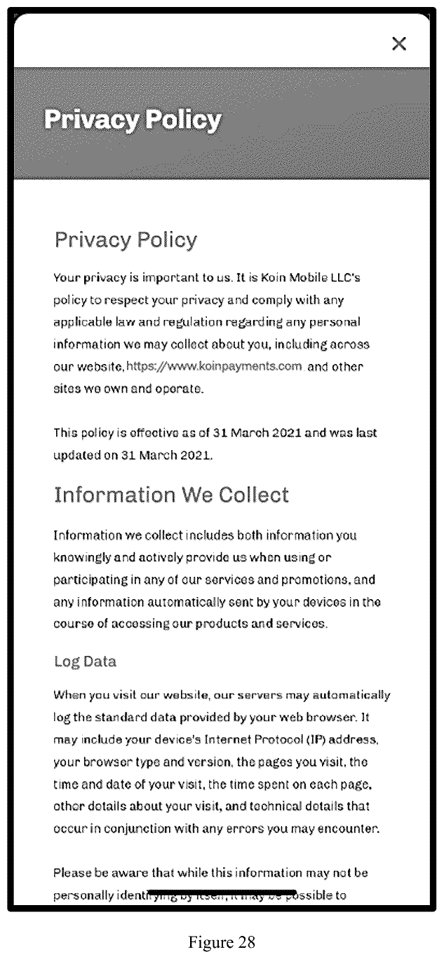

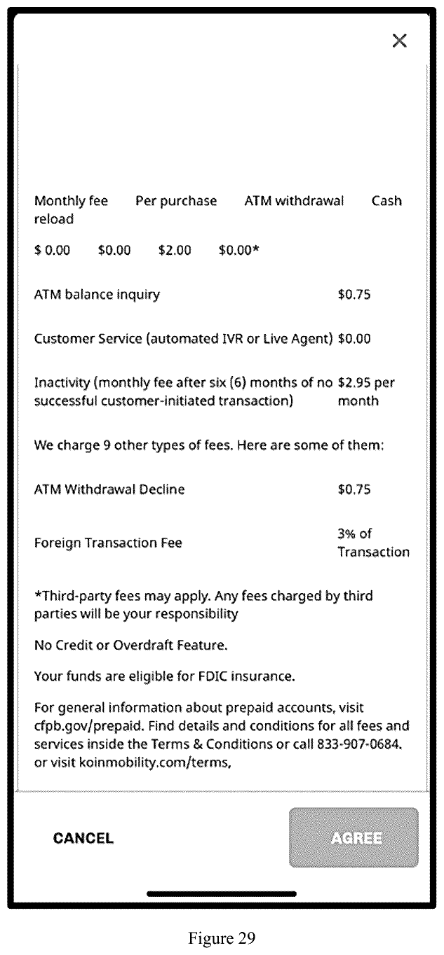

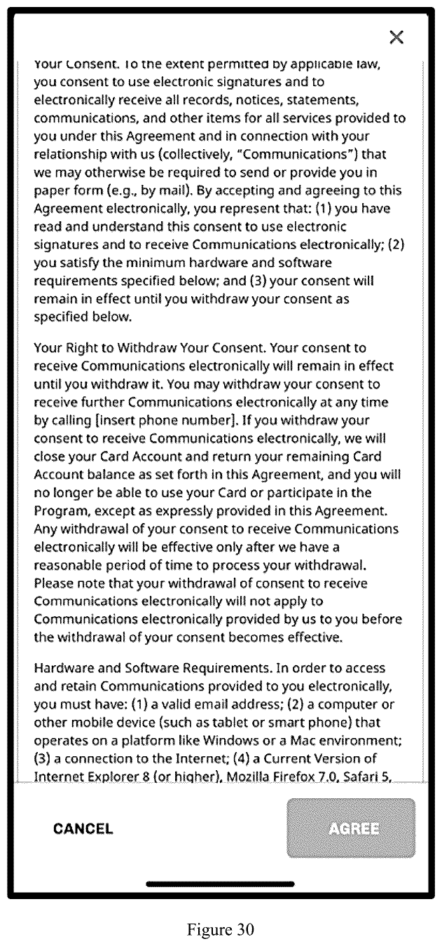

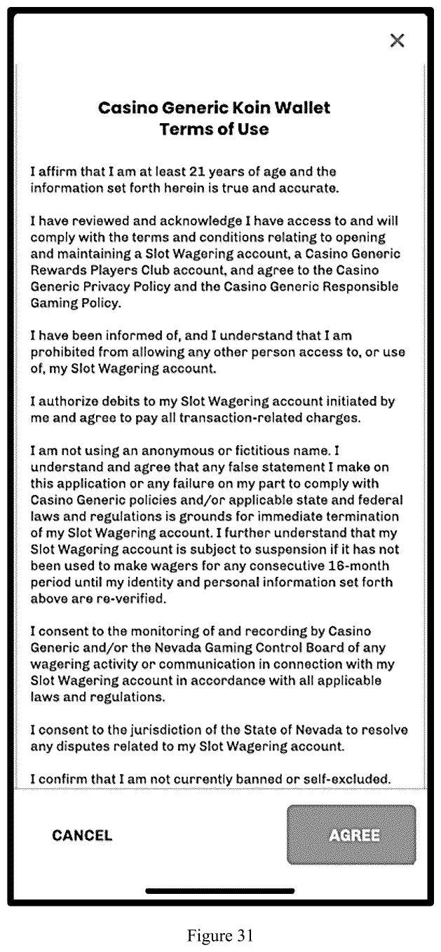

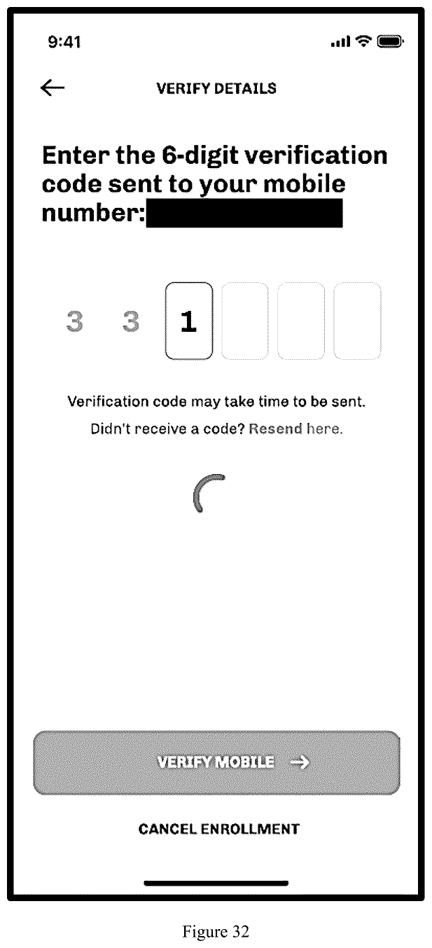

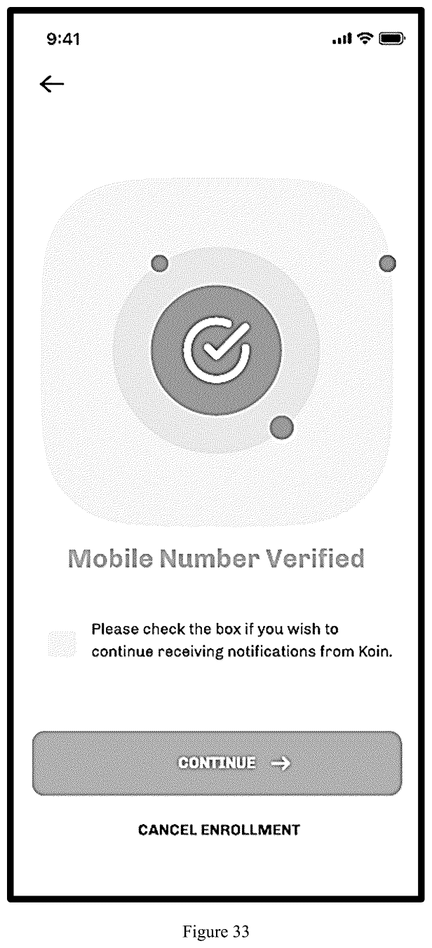

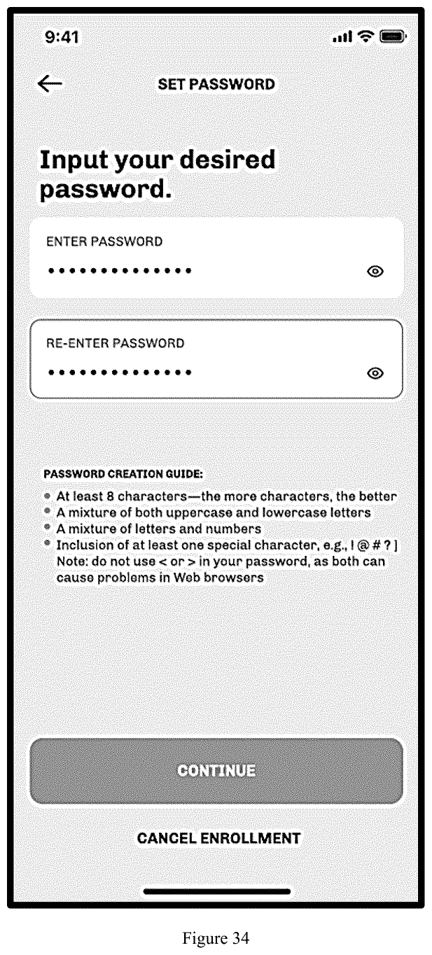

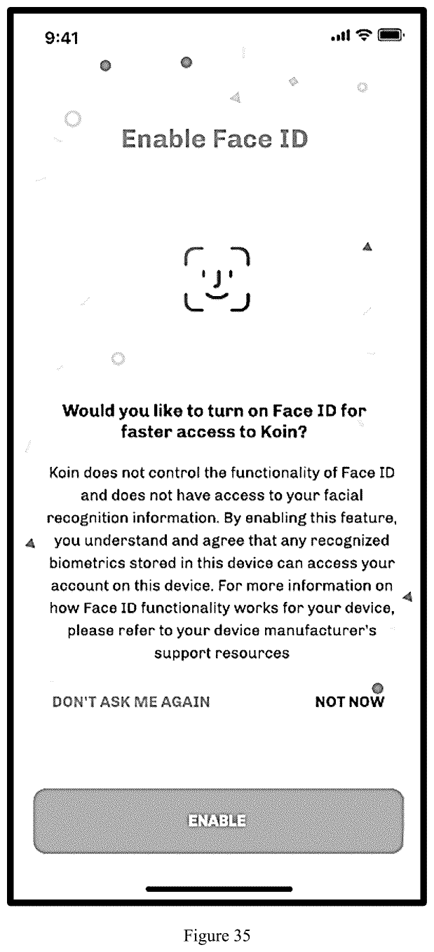

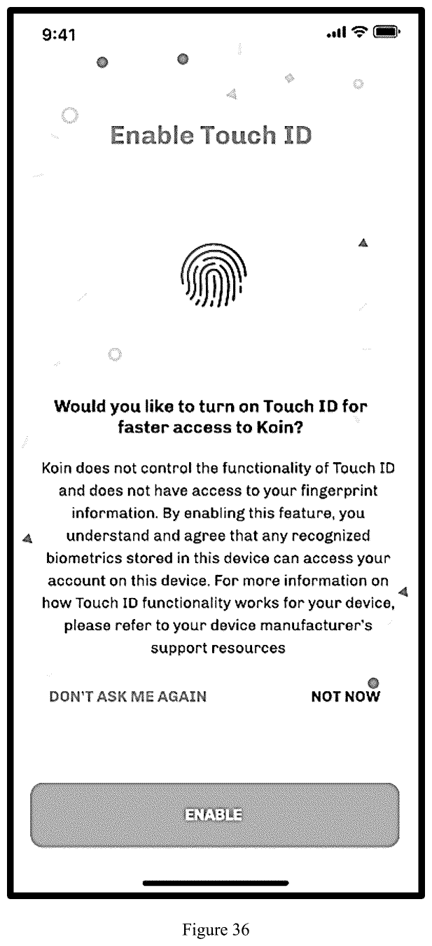

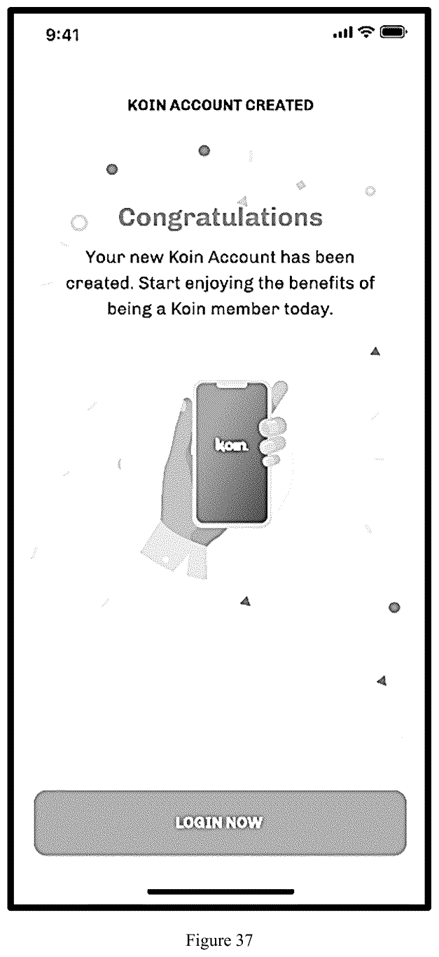

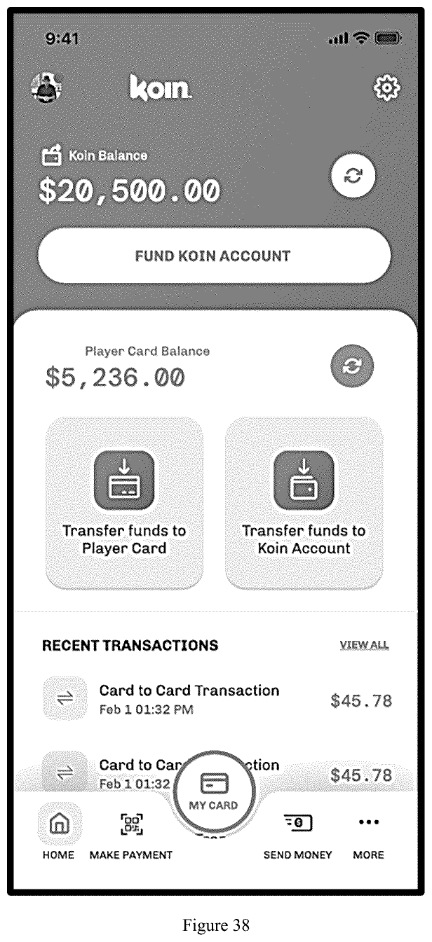

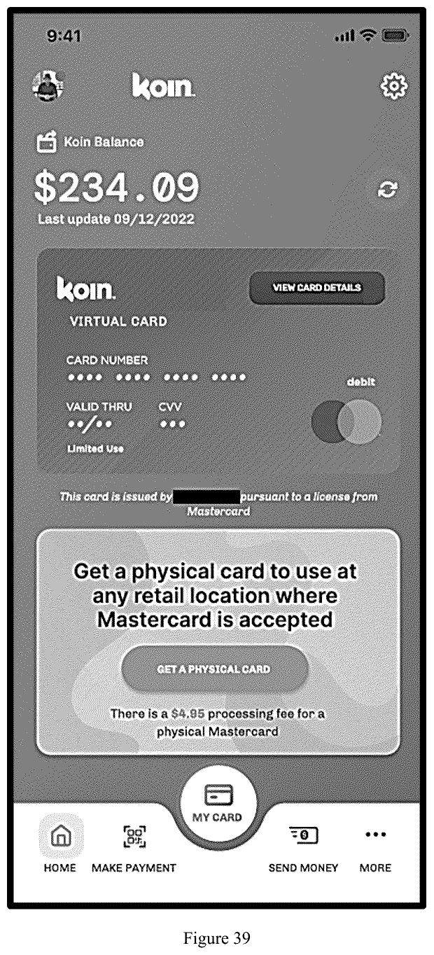

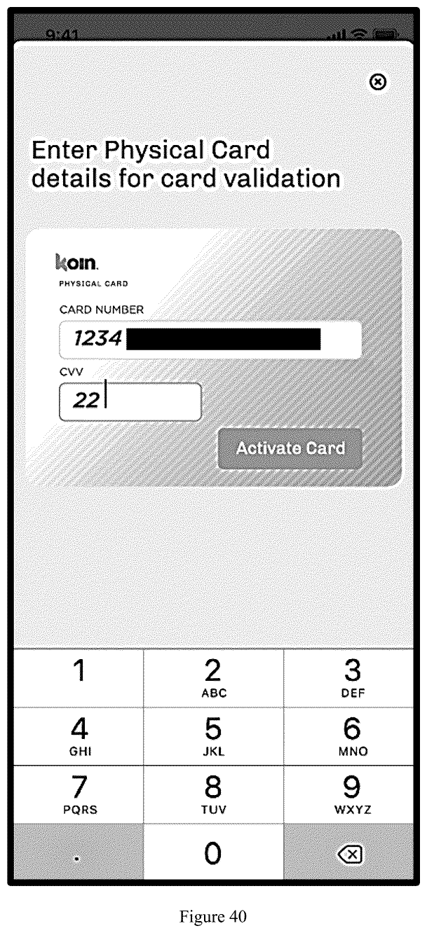

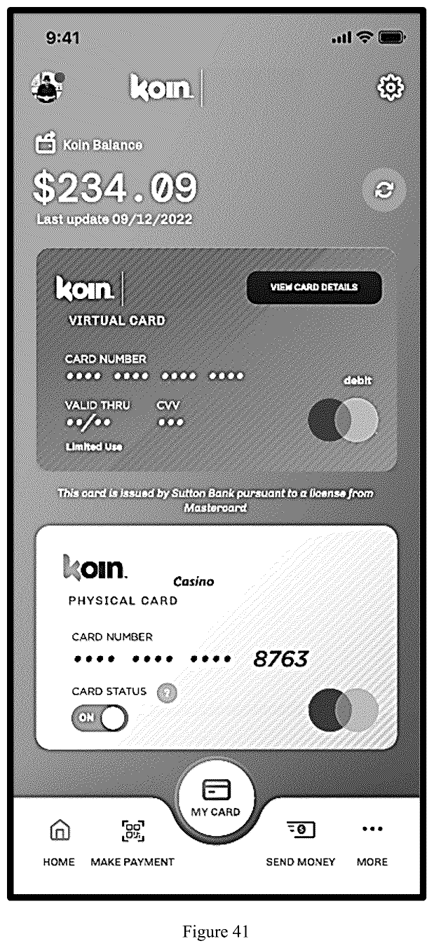

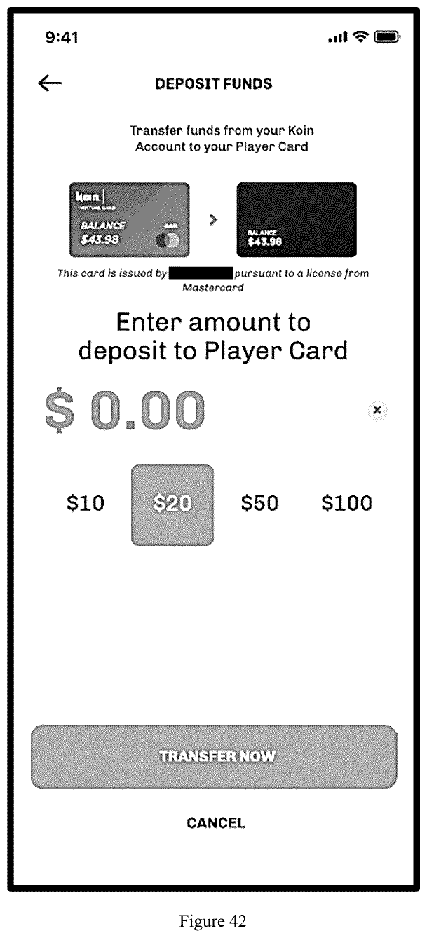

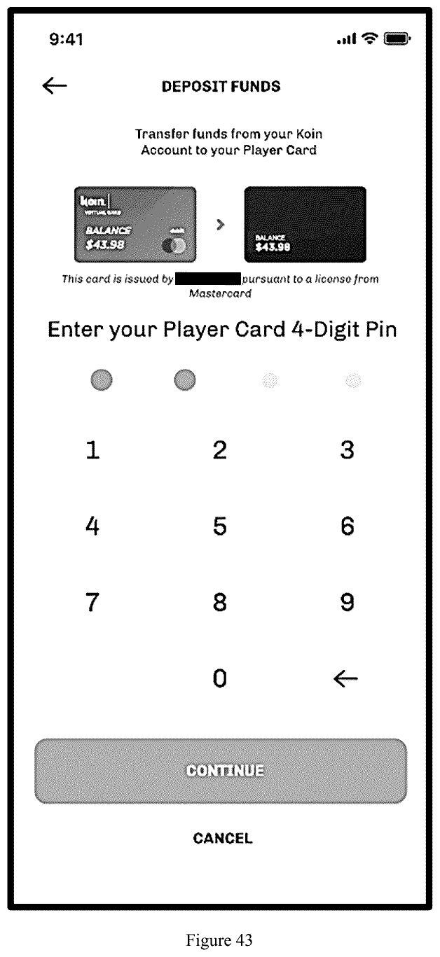

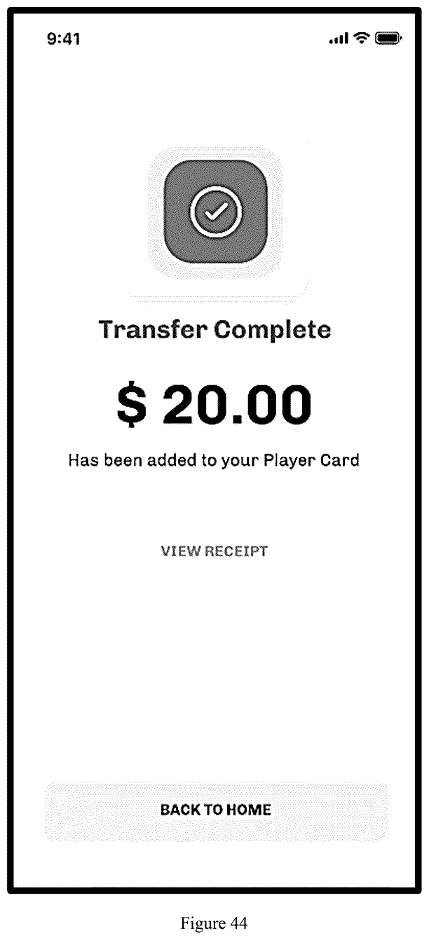

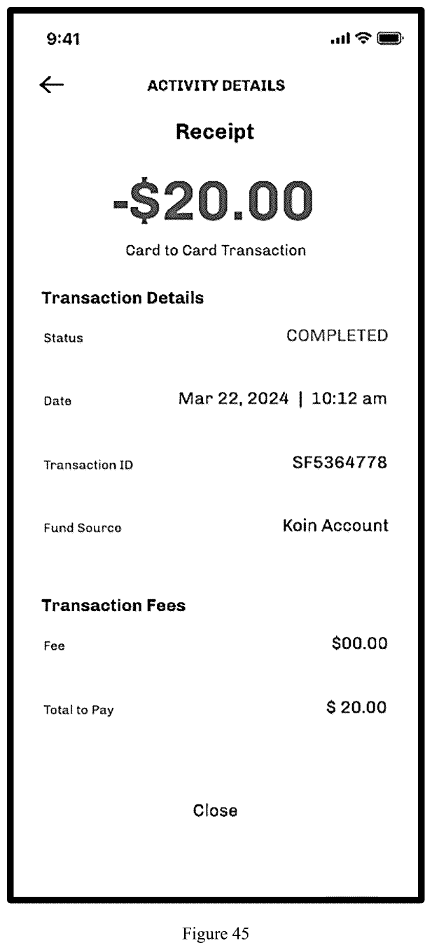

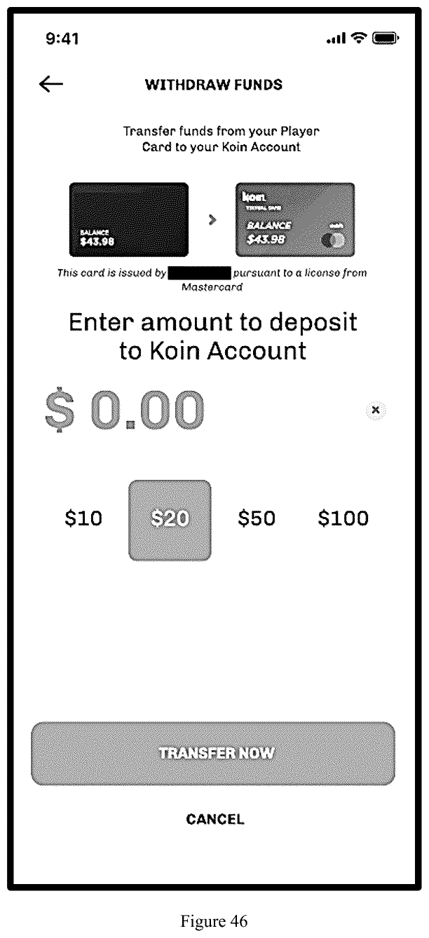

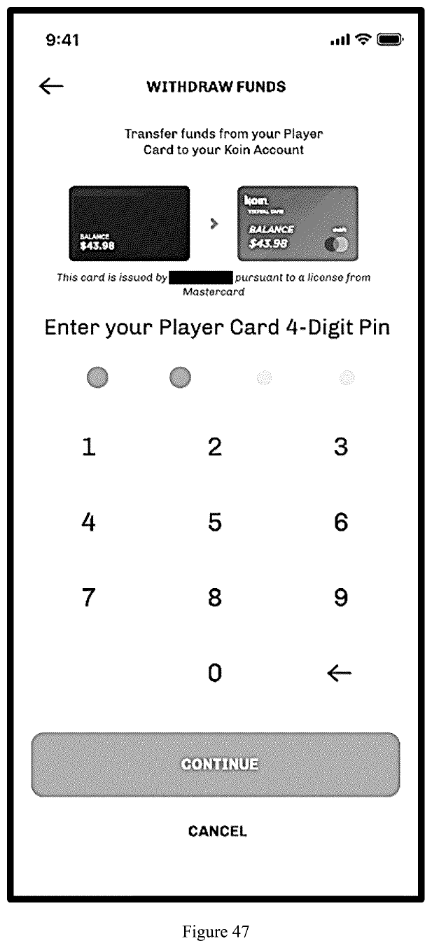

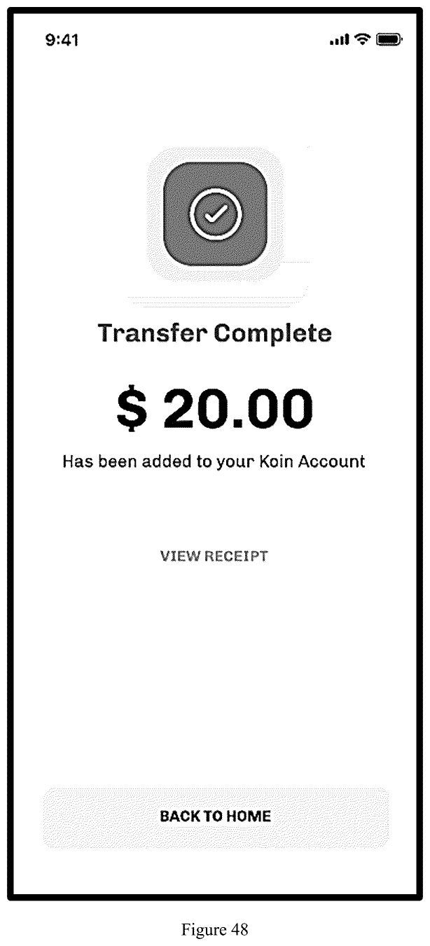

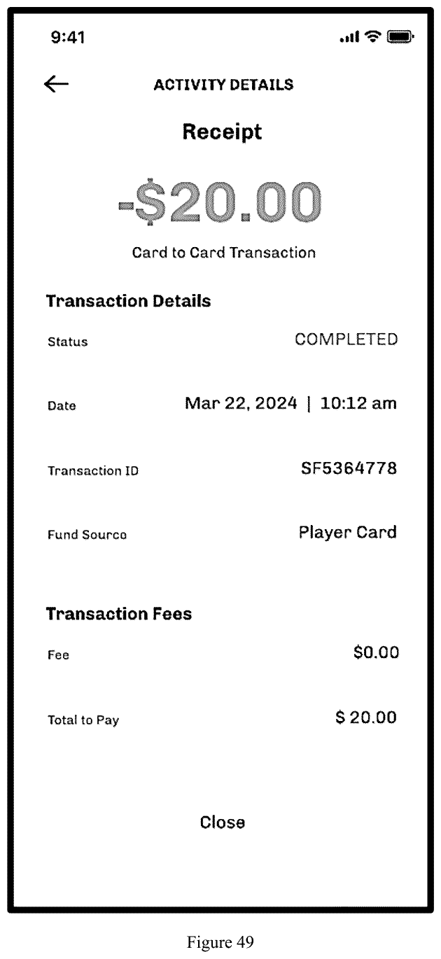

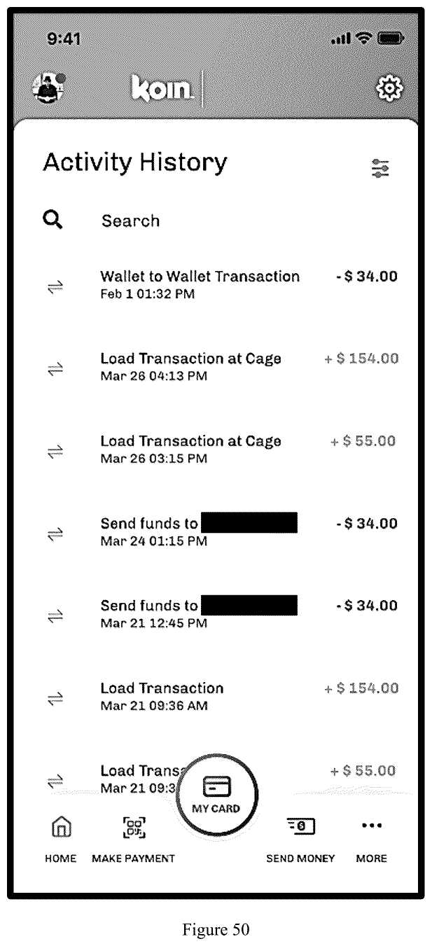

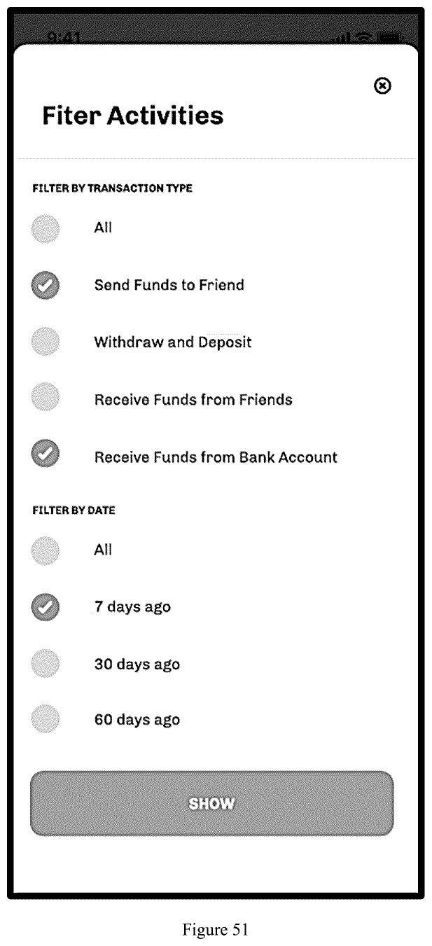

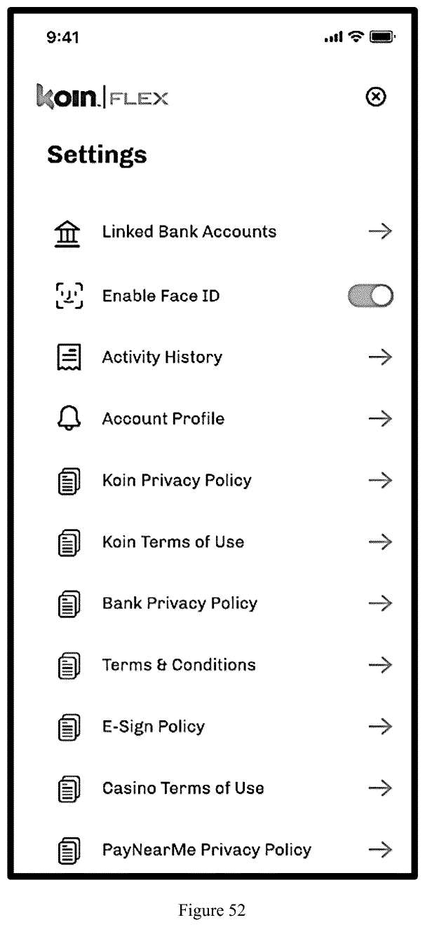

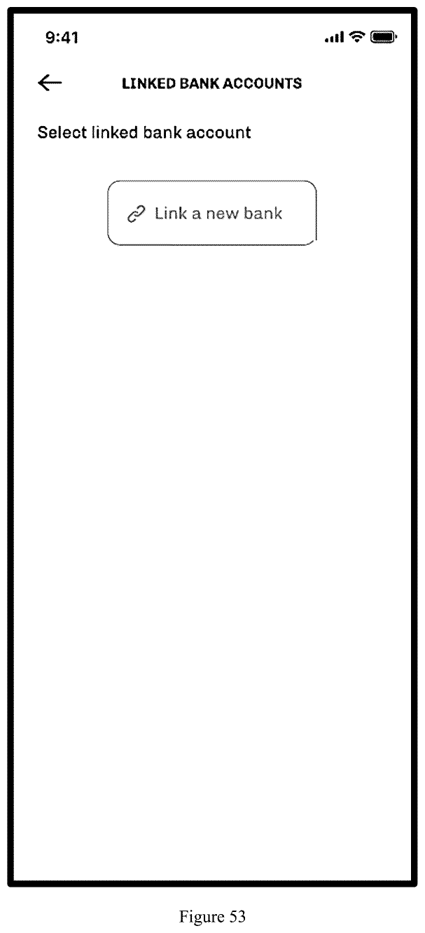

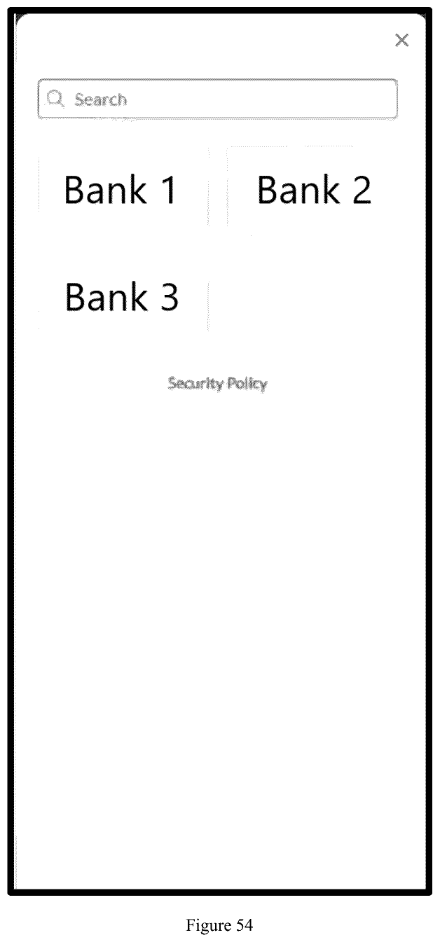

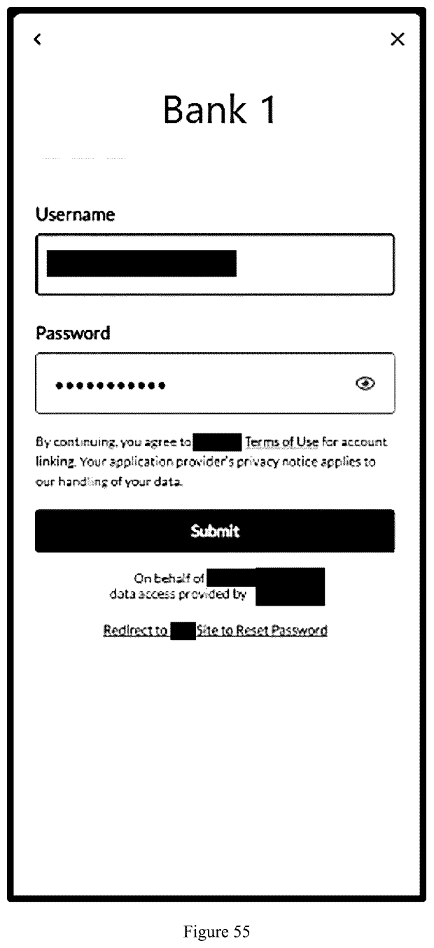

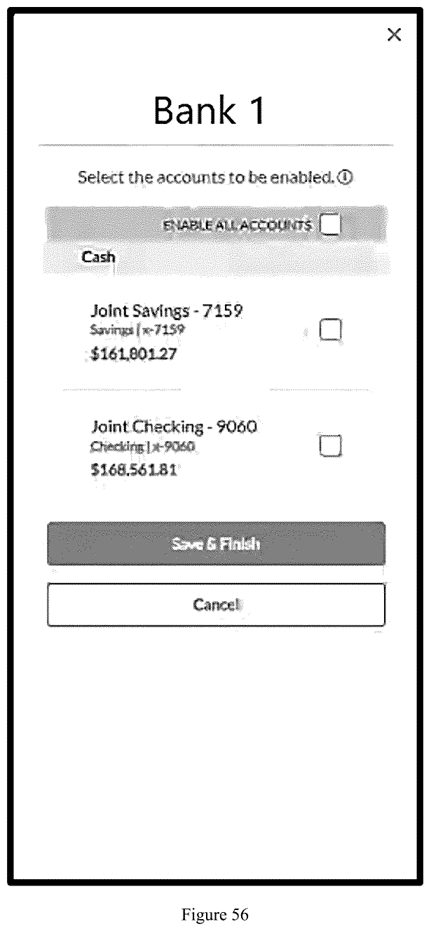

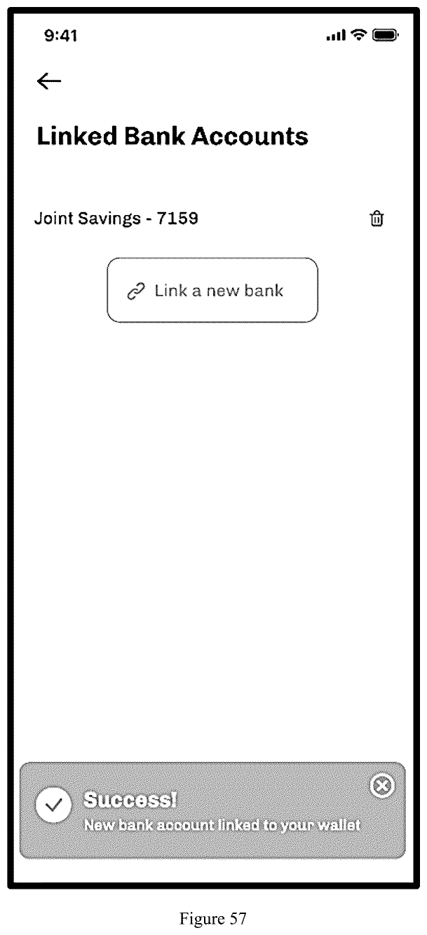

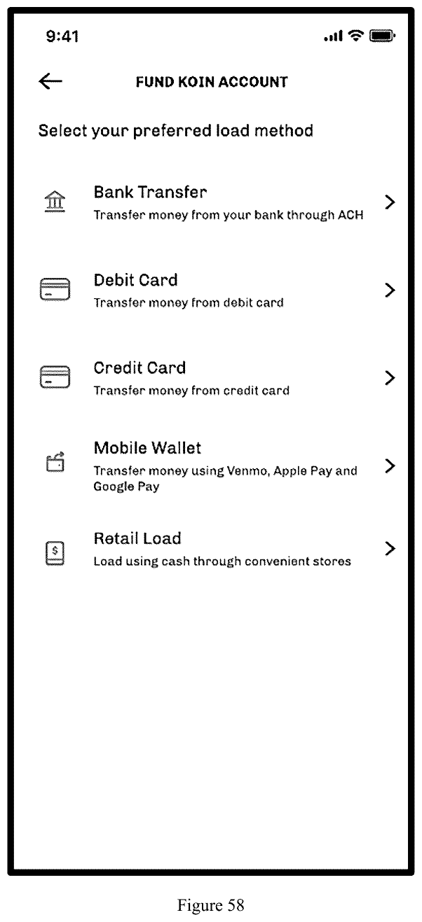

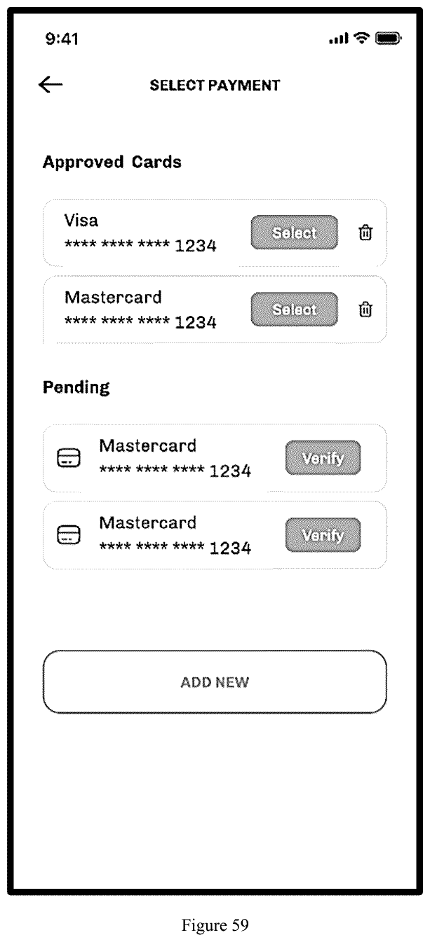

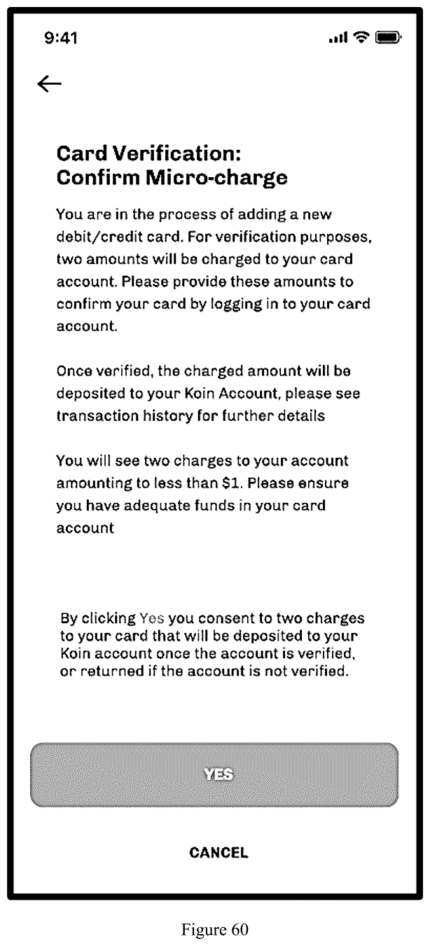

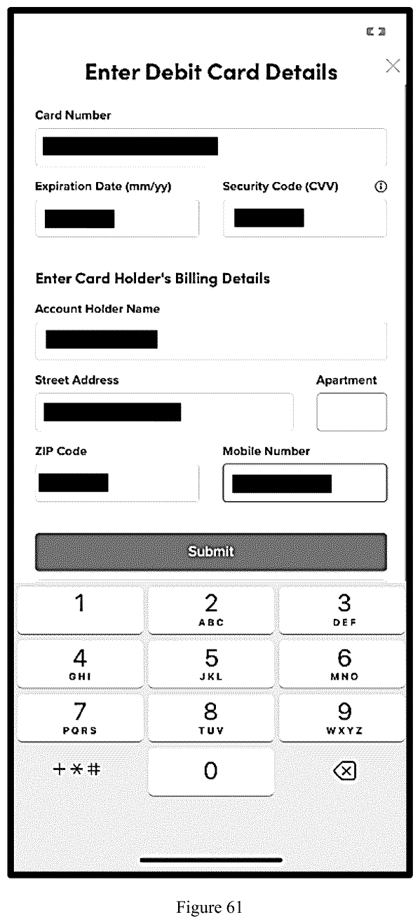

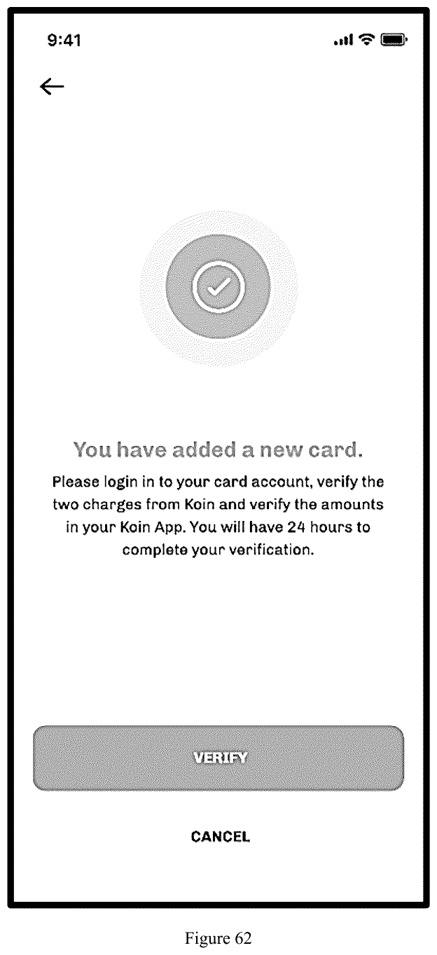

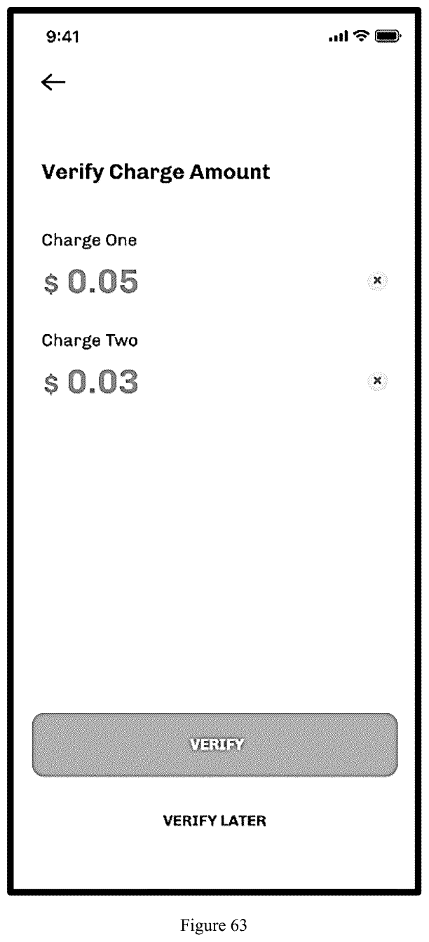

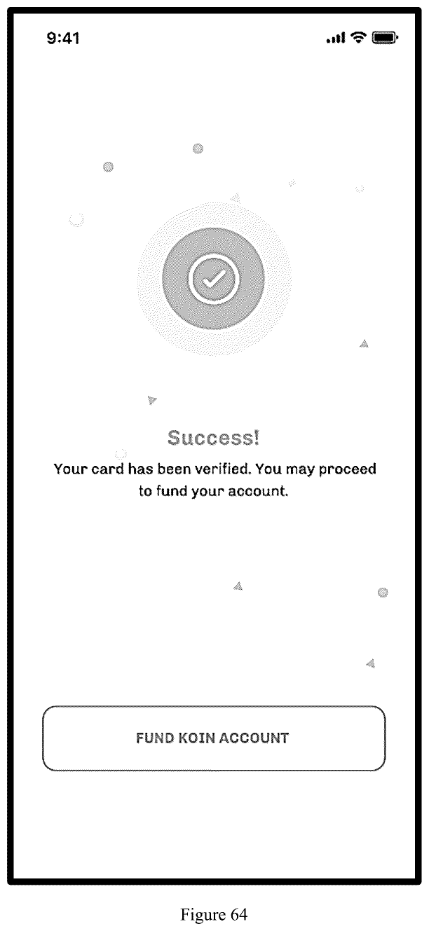

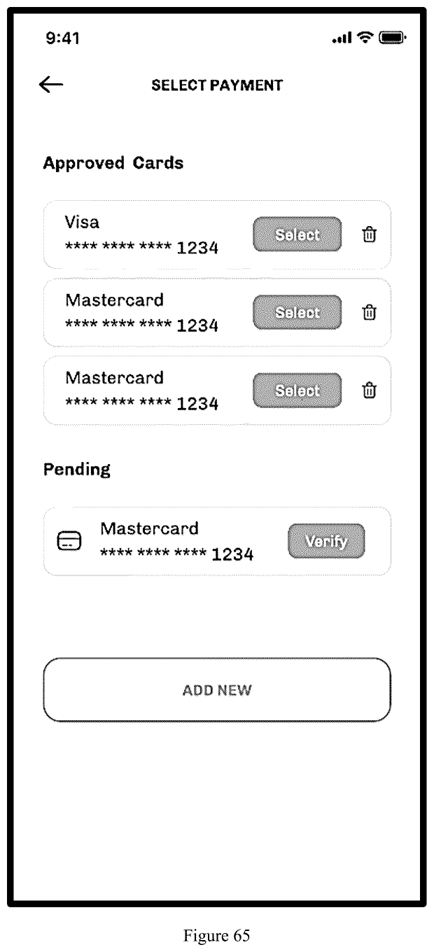

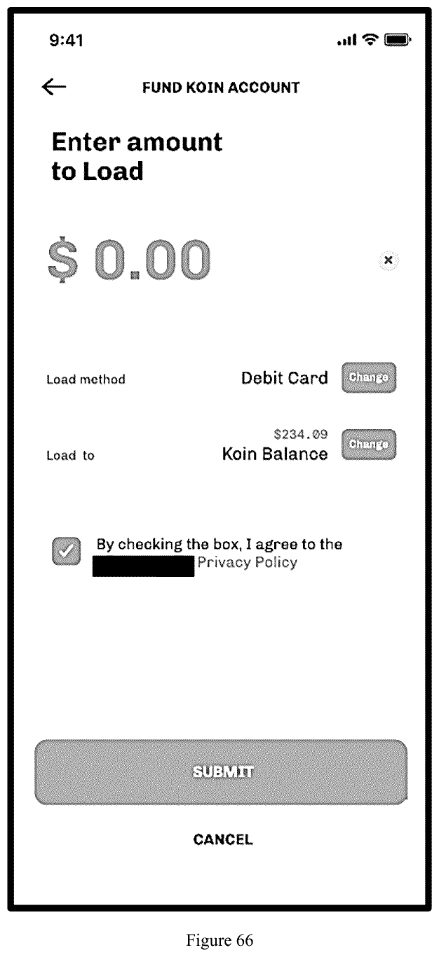

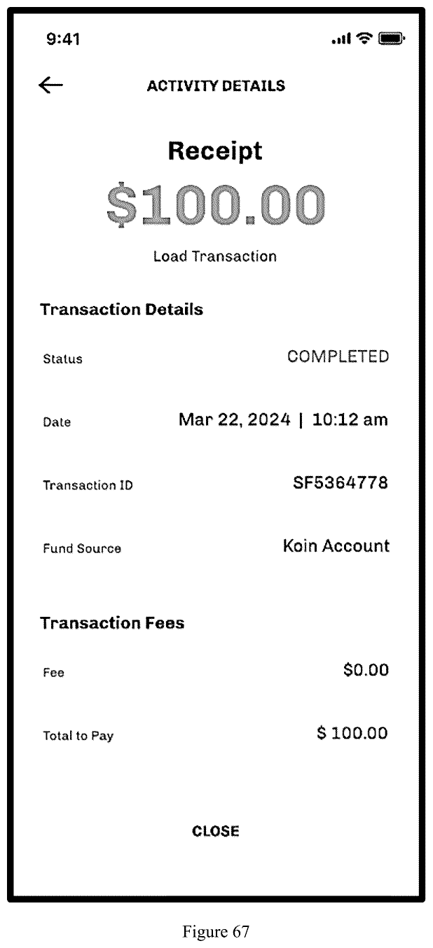

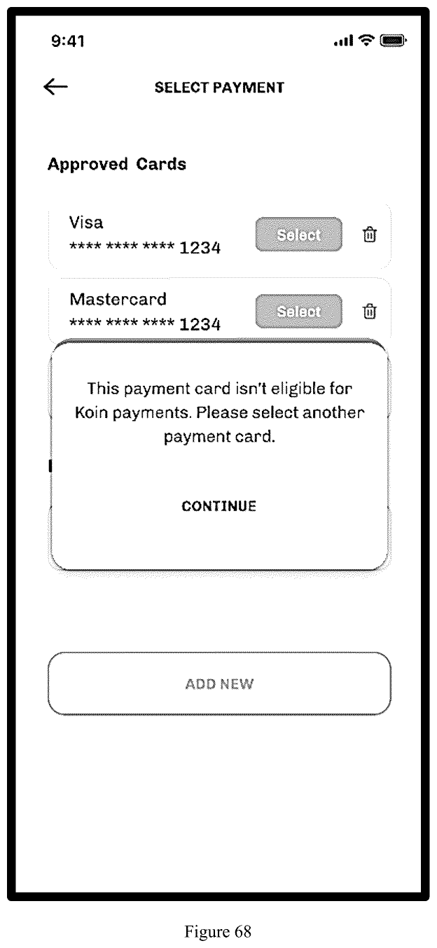

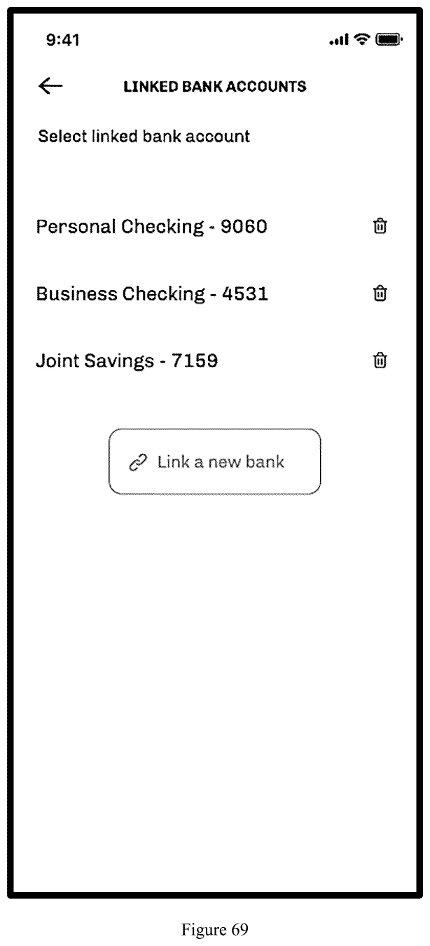

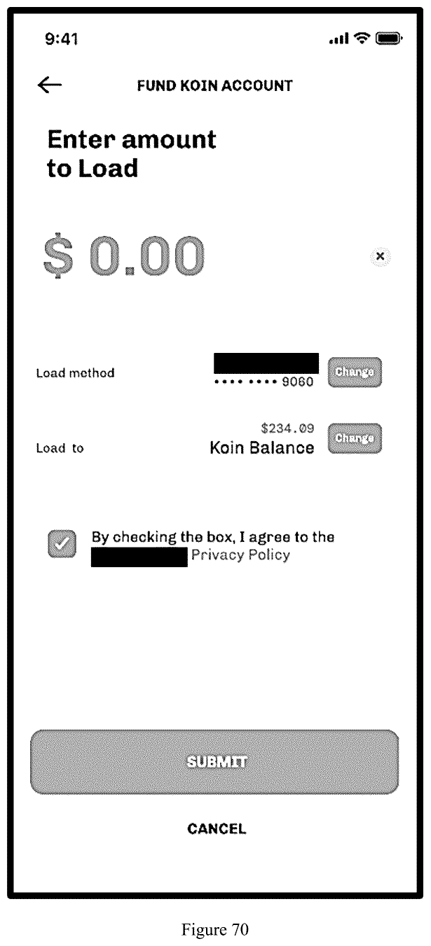

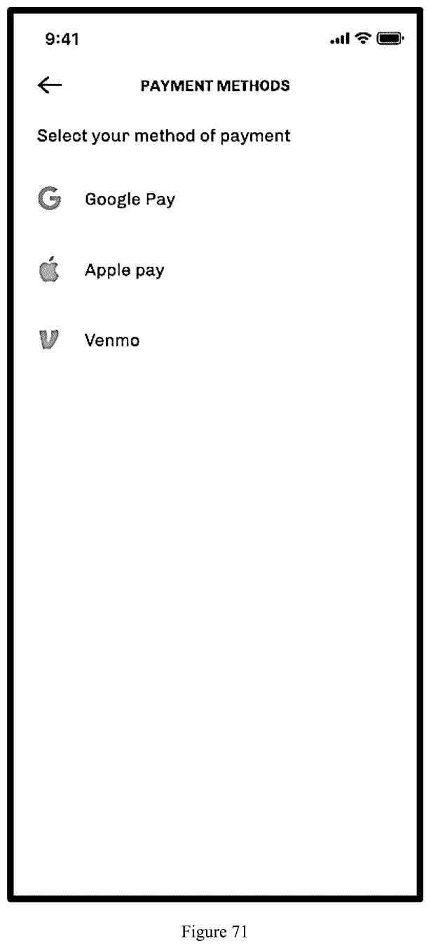

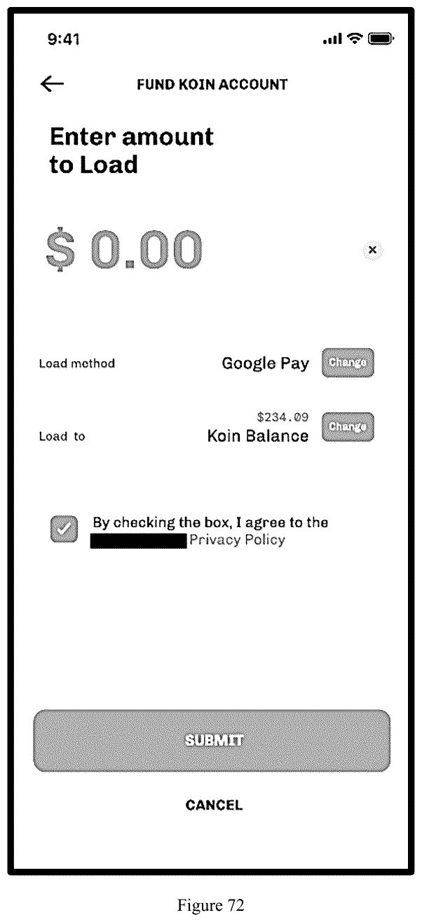

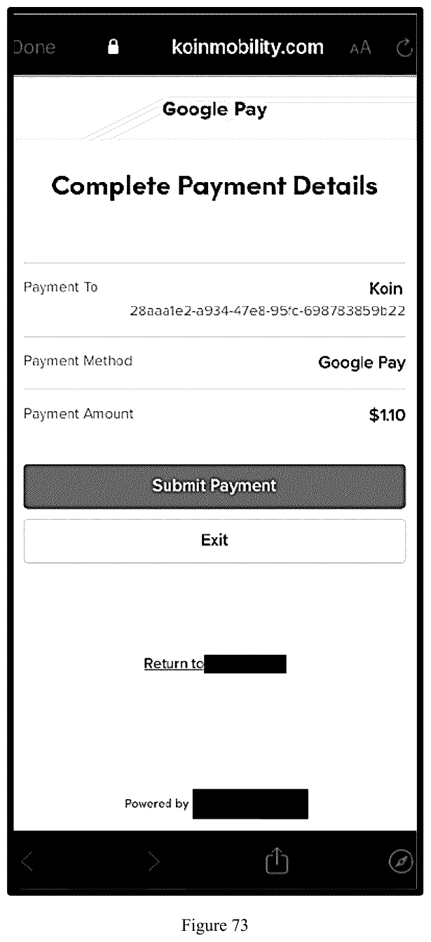

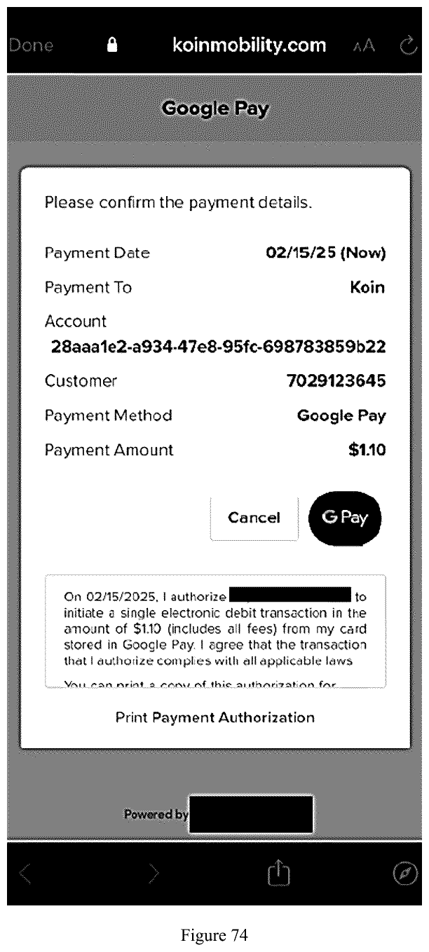

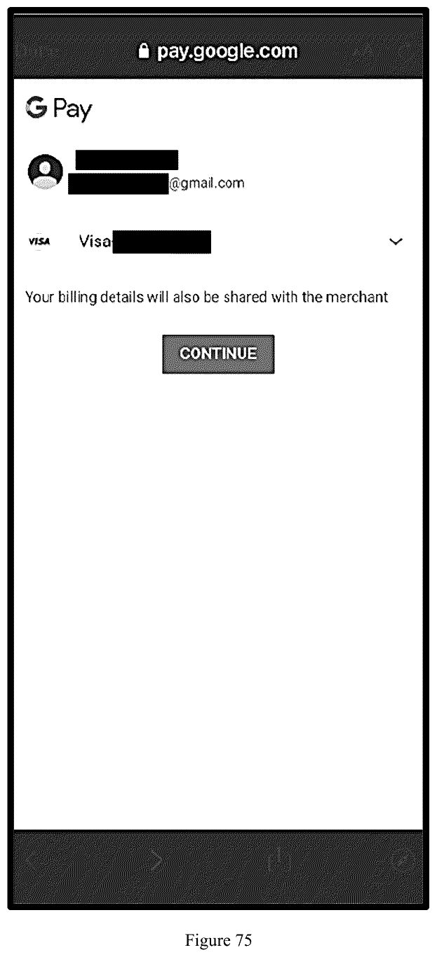

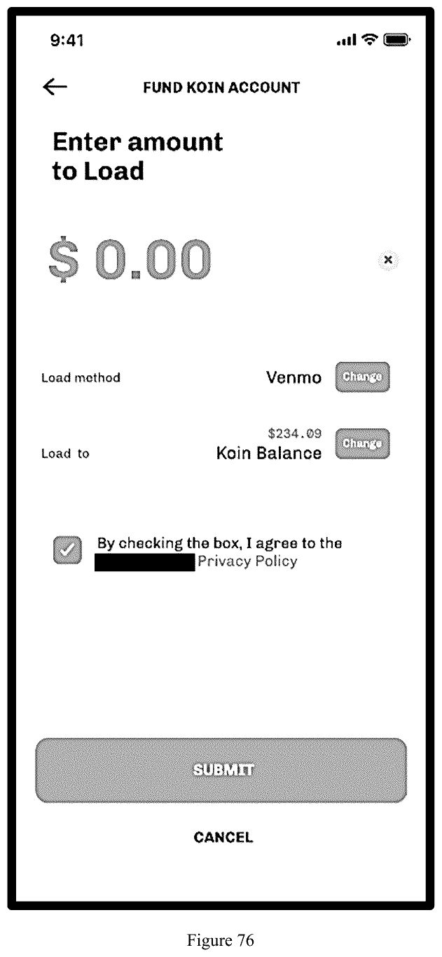

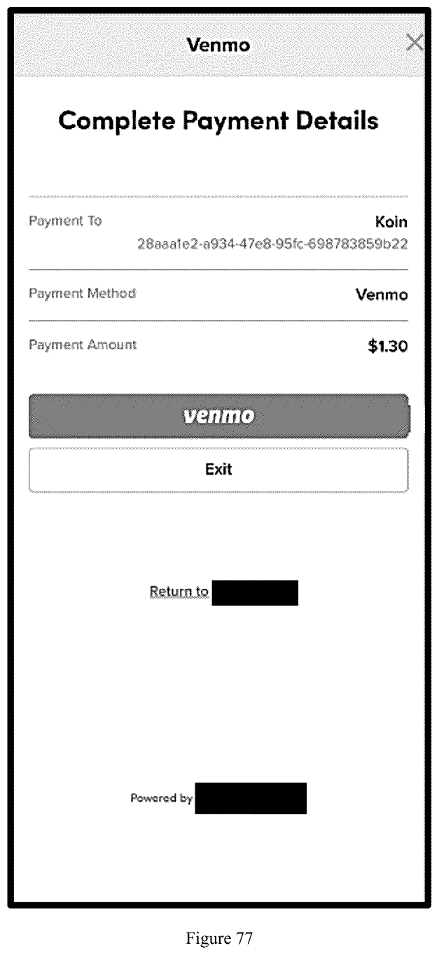

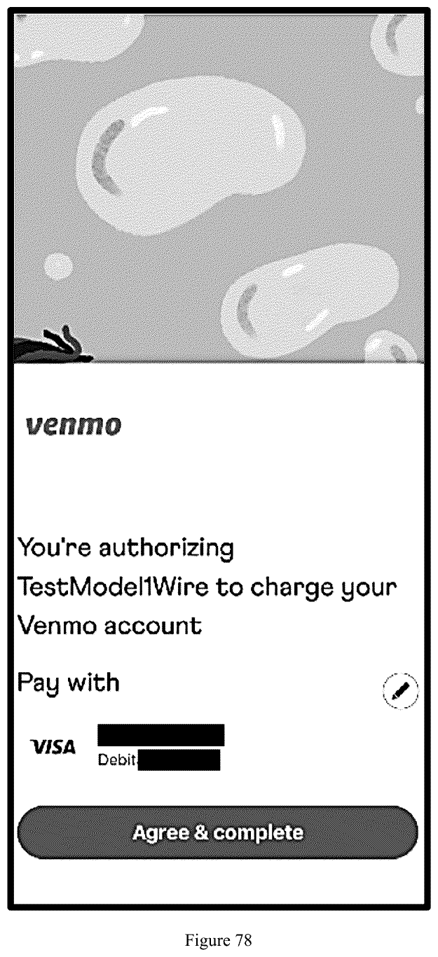

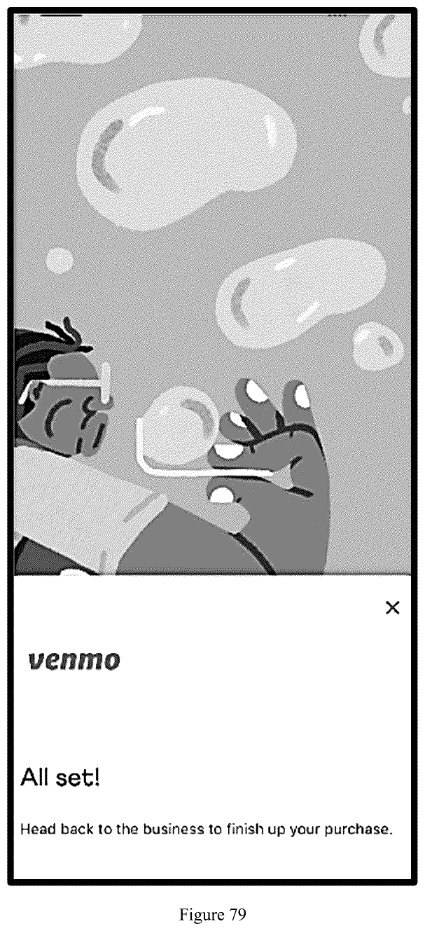

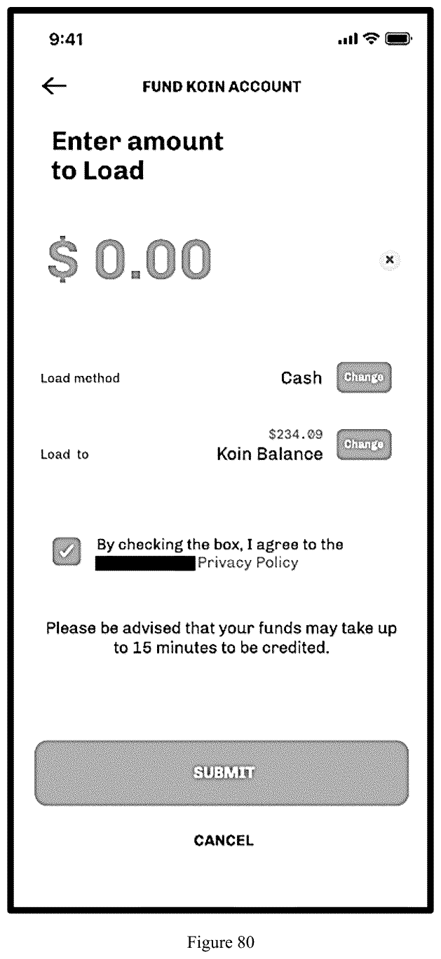

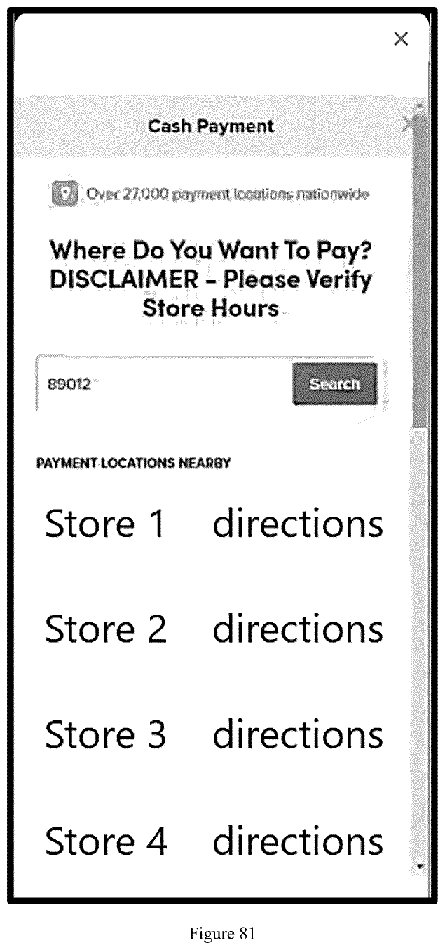

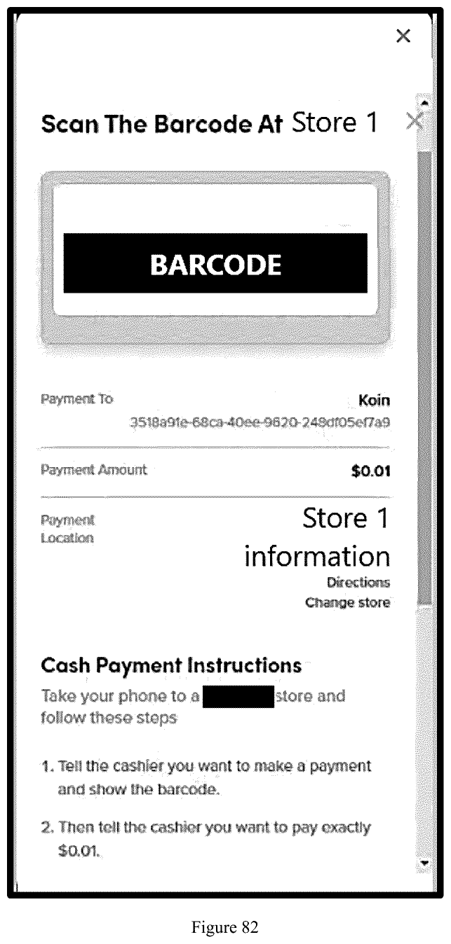

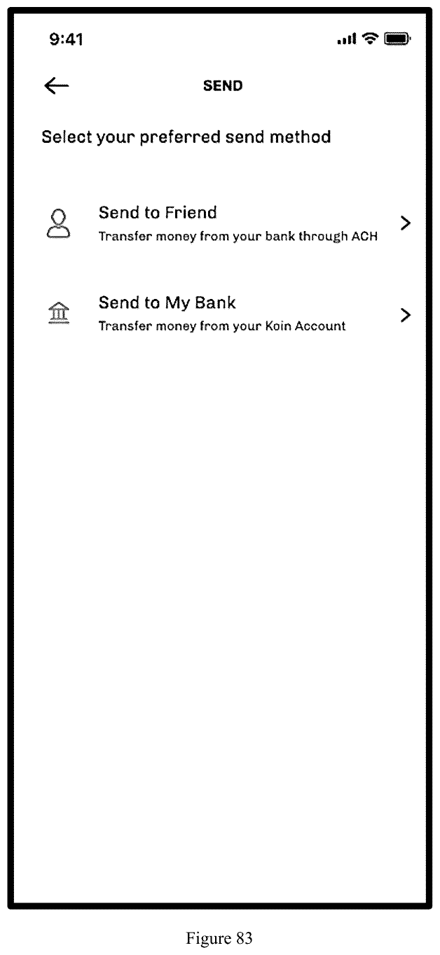

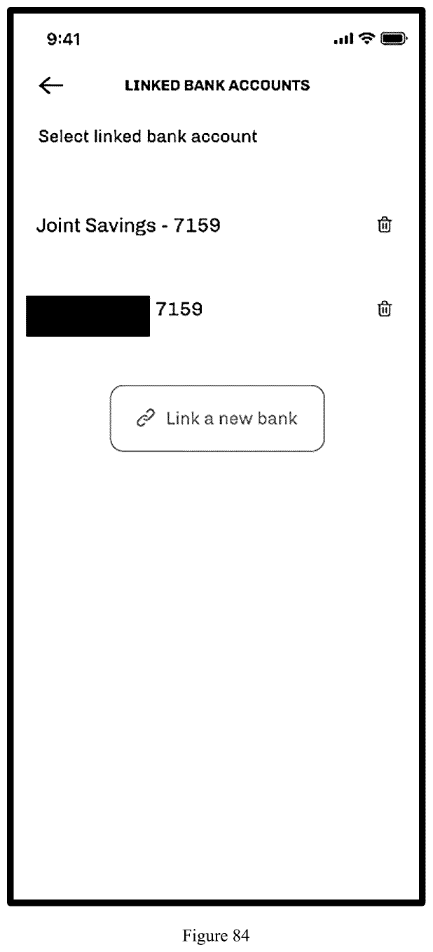

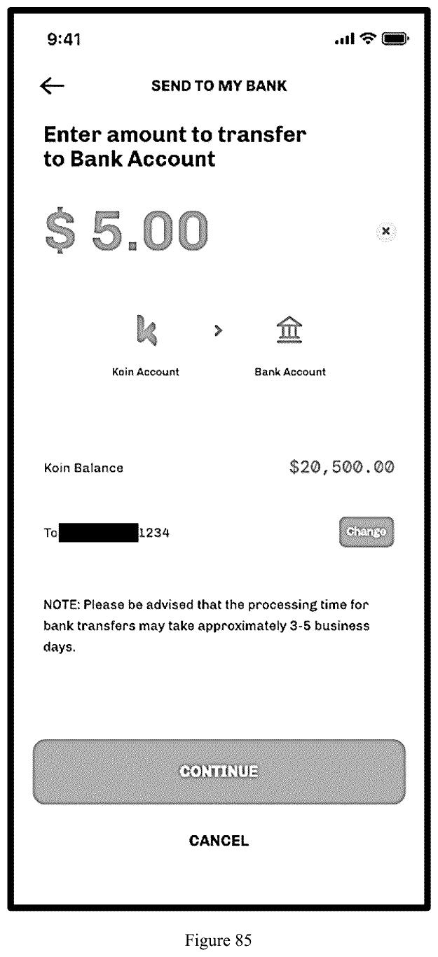

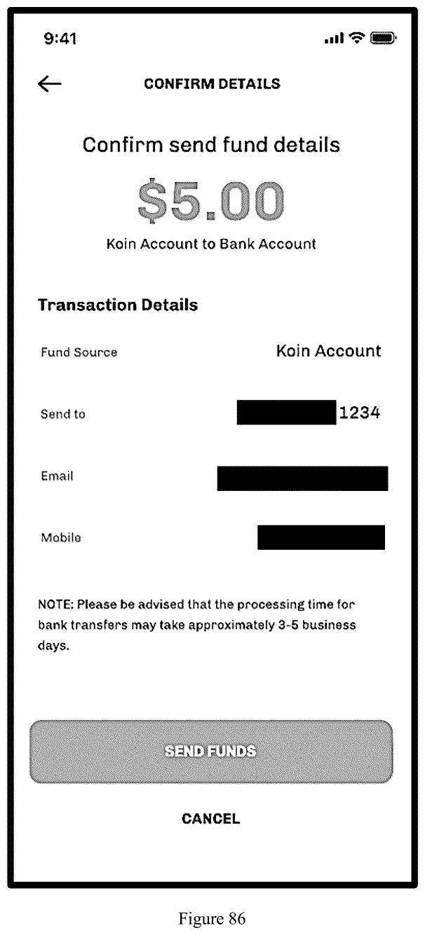

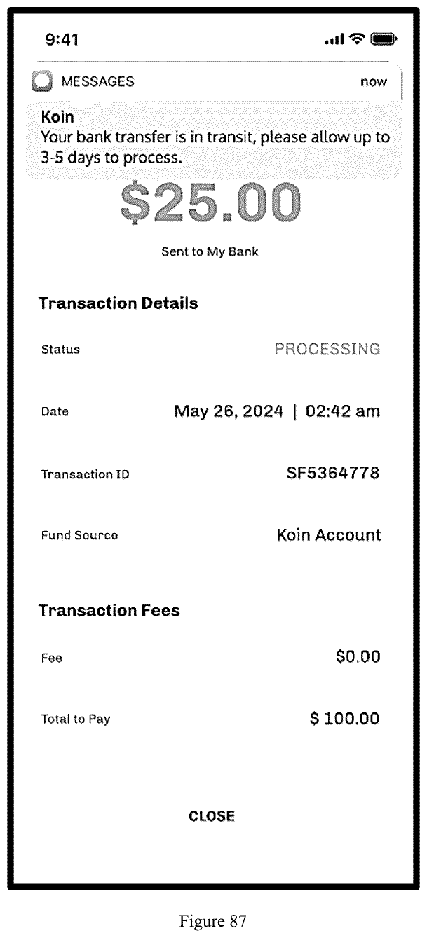

Next the mobile app is further described with reference to screenshots depicted in FIGS. 8-87. It should be appreciated that the mobile app as discussed herein may be used both for a system and/or electronic wallet of this disclosure. In some embodiments, the system of this disclosure will include an electronic wallet. In some embodiments, the system may not incorporate an electronic wallet. In some embodiments, the electronic wallet may accomplish functionalities of the system, such as, for example, the functionality of the rules engine. As such, at times the terms system and electronic wallet may be used interchangeably. First, FIG. 8 depicts a representative login screen, which allows an account holder to log into the mobile app, for example, using a mobile number or email address and a password. When the account holder lacks credentials to log into the mobile app, or when the account holder wishes to register a new account with the mobile app, then the account holder may click the “register now” button on the screen of FIG. 8, for example, to enroll the new account. Clicking the “register now” button takes the account holder to a registration screen such as the screen depicted in FIG. 9. The registration screen allows the account holder to enter a player's club account number or other identification number or information to begin the registration process. Upon submitting a player's club account number, the mobile app may then prompt the account holder to enter a pin number associated with the player's club account such as with a screen depicted, for example, in FIG. 10. Upon entering the correct pin number, the mobile app may display a screen to collect and/or confirm identifying information such as a social security number (SSN), gender, mobile number, and email address as depicted, for example, in FIG. 11. The fields of FIG. 11 may optionally auto-populate based on information retrieved from the player's club account of the account holder. Alternatively, the fields of FIG. 11 may be used to confirm the identity of the account holder, and, if the information entered does not match information recorded in the player's club account, then the mobile app may end the registration process and optionally display an error message such as the message depicted in FIG. 12.

Depending upon the gaming jurisdiction, the mobile app may request a copy of a government-issued identification during the enrollment process. After the account holder enters identifying information such as into the screen depicted in FIG. 11 and after the mobile app optionally verifies the identifying information, then the mobile app may prompt the account holder to photograph the government-issued identification. The photography may advantageously be performed by third-party software such as integral software of the mobile device and/or third-party software that is either optionally embedded in the mobile app or accessible from the internet. FIG. 13 depicts an optional message stating that the mobile app will use third-party software to capture both a photograph of the government-issued identification and a photograph of the account holder (a “selfie”). The mobile app may optionally allow the account holder an opportunity to review and agree upon a privacy policy prior to photographing the government-issued identification and account holder, which privacy policy may optionally set forth information regarding how the photograph of the government-issued identification, the photograph of the account holder, personal identifiable information, and/or other information related to the account holder will be stored and used. A representative screen that allows an account holder an opportunity to review a privacy statement, and that only allows the account holder to continue with the registration process if the account holder agrees with the privacy statement, is depicted in FIG. 14. Different forms of government-issued identification might be used to register a mobile app account depending upon the gaming jurisdiction and/or other considerations, and FIG. 15 depicts a mobile app screen that prompts the account holder select a form of government-issued identification selected from a driver's license, identification card, passport, residency permit card, and temporary visa. The mobile app may optionally display a screen that provides instructions for capturing a photograph of the government-issued identification such as the screen depicted in FIG. 16. Next, FIG. 17 depicts a screen of a mobile app that allows the account holder to photograph the government-issued identification. Depending upon the type of government-issued identification to be photographed, the gaming jurisdiction, and/or other considerations, the mobile app may require different images of the government-issued identification. FIG. 17 depicts a prompt to take a photograph of the front of a driver's license, and FIG. 18 depicts a prompt to take a photograph of the back of the same driver's license. Following the photography of the government-issued identification, the mobile app may one or more of verify the readability of the photographs (for example, as depicted in the screen of FIG. 19), upload the photographs to a database that stores the registration information (for example, as depicted in the screen of FIG. 20), and verify the information in the government-issued identification such as verifying security features of the identification as depicted in FIG. 21. If the mobile app cannot verify the government-issued identification, then the mobile app may either prompt the account holder to use a different identification or end the registration process such as by displaying the screen depicted in FIG. 12.

The mobile app may also request a photograph of the account holder to register a new account on the mobile app or to access certain features of the mobile app. FIG. 22 depicts a screen that requests to use a camera of the mobile device on which the mobile app is running to take the photograph (i.e., “selfie”). One or more other screens may allow the account holder to take the photograph with prompts analogous to those set forth in FIGS. 17 and/or 18. After taking the photograph, the mobile app then typically uploads the photograph to a database as depicted in the screen of FIG. 23. The mobile app then verifies or requests verification that the photograph depicts a person and/or that the photograph corresponds to the account holder such as by comparing features of the photograph of the account holder taken by the camera of the mobile device to features of a picture of the account holder depicted in the photograph of the government-issued identification. When all of the requested personal identifiable information corresponding to the account holder is collected and verified, then the mobile app may optionally display a success screen such as in the screen depicted in FIG. 24. The mobile app may also then display the collected personal identifiable information of the account holder such as in the screen depicted in FIG. 25.

The mobile app may also request the account holder to agree to various terms and conditions including privacy policies, e-signature agreements, and terms of use for one or more of the entity that provides the mobile app, financial institutions that allow transactions on the mobile app, and wager gaming providers that allow transactions on the mobile app. FIG. 26 depicts a screen that allows account holders to agree to various agreements. The mobile app may also display the various agreements and/or allow the various agreements to be downloaded. FIG. 27, for example, depicts a screen that displays an agreement with an electronic wallet provider (Koin) as well as an “agree” button to allow an account holder to agree to the agreement. FIG. 28 depicts a screen that displays a privacy policy for the electronic wallet provider as well as an “agree” button to allow an account holder to agree to the privacy policy. FIG. 29 depicts an agreement to fees that the electronic wallet provider will collect as well as an “agree” button to allow an account holder to agree to the fees. FIG. 30 depicts an agreement regarding electronic signatures as well as an “agree” button to allow an account holder to agree to the provisions therein. FIG. 31 depicts an agreement required by a linked casino as well as an “agree” button to allow an account holder to agree to the agreement with the casino.

As an additional verification and security precaution, the mobile app can be configured to verify the mobile telephone number of the account such as by texting a verification code to the telephone number. FIG. 32 depicts a screen that allows the account holder to enter a code sent to the mobile telephone number, and FIG. 33 depicts a screen that confirms that the mobile number has been verified. The mobile app may similarly allow for verification, for example, of an email address.

The mobile app generally requires a password or other security measure to log into the mobile app. FIG. 34 depicts a screen that allows the account holder to select a password, and FIGS. 35 and 36 depict screens that allow users to create biometric identifiers such as a face scan or a fingerprint, respectively, to allow the account holder to log into the mobile with the biometric(s).

After completing one or more of the various preceding steps as described with reference to FIGS. 8-36 as may be required by the administrator of the mobile app, one or more financial institutions that allow transactions on the mobile app, and/or one or more casinos that allow transactions on the mobile app, the mobile app may optionally display a confirmation screen that confirms that the mobile app account is ready for use as depicted, for example, in FIG. 37.

After an account holder enrolls a mobile app account, the mobile app account allows functionality to both fund wager gaming and to withdrawal funds from a wager gaming account. The mobile app generally provides a “home page” screen that allows access to various options such as the screen depicted in FIG. 38. In some embodiments, either the player's club account, the mobile app account, or both are associated with a virtual bank card, a physical bank card, or both. Clicking on the “My Card” button of FIG. 38 may direct the mobile app to display a virtual bank card, a physical bank card, or both as shown, for example, in FIG. 39. FIG. 39 also shows an option for the account holder to order a physical bank card associated with either a player's club account, the mobile app account, or both. Upon receipt of the physical bank card, the mobile app may optionally provide an interface to activate the card and add the card to the mobile app account as depicted, for example, in FIG. 40. Upon activation and addition of the physical bank card to the mobile app account, the mobile app typically provides a screen to display information related to the physical bank card and to allow its use as depicted, for example, in FIG. 41.

The mobile app of this disclosure typically provides electronic wallet features of this disclosure that allow the transfer of electronic currency for wager gaming. By clicking on a button on a screen of the mobile app such as the “transfer funds to player card” button on the home page screen of FIG. 38, an account holder may transfer electronic currency to a casino player's club account for use in wager gaming. FIG. 43 depicts an example screen that might be displayed after clicking a “transfer funds to player card” or analogous button on a mobile app. The screen of FIG. 42 provides options to load electronic currency (“funds”) to a casino player's club account (“player card”) from the virtual bank card of the mobile app. Following the selection of an amount to transfer, the account holder presses the “transfer now” button on the screen of FIG. 42 to initiate the transfer. The mobile app may optionally require entry of a pin number or other authenticating input such as a password, biometric, or the like to verify and complete the transfer as depicted, for example, in FIG. 43. Following completion of the transfer, the mobile app may display a verification screen such as the screen depicted in FIG. 44 that allows the account holder to either view a receipt (by clicking the “view receipt” option) or return to the home page (by clicking the “back to home” button) to return back to the home screen as depicted, for example, in FIG. 38. When the account holder clicks the option to view the receipt, then the mobile app may display transaction details as depicted, for example, in FIG. 45.

The mobile app of this disclosure may also provide electronic wallet features of this disclosure that allow the transfer of electronic currency from a casino player's club account back into the wallet. By clicking on a button on a screen of the mobile app such as the “transfer funds to Koin account” button of the home page screen of FIG. 38, an account holder may transfer electronic currency from a casino player's club account back into the electronic wallet. The electronic currency in the casino player's club account might include, for example, one or both of unused electronic currency and winnings from wager gaming. The screen of FIG. 46 provides options to withdraw electronic currency (“funds”) from a casino player's club account (“player card”) and to deposit the electronic currency into an account identified in the mobile app. Following the selection of an amount to transfer, the account holder presses the “transfer now” button on the screen of FIG. 46 to initiate the transfer. The mobile app may optionally require entry of a pin number or other authenticating input such as a password, biometric, or the like to verify and complete the transfer as depicted, for example, in FIG. 47. Following completion of the transfer, the mobile app may display a verification screen such as the screen depicted in FIG. 48 that allows the account holder to either view a receipt (by clicking the “view receipt” option) or return to the home page (as shown, for example, in FIG. 38) by clicking the “back to home” button. When the account holder clicks the option to view the receipt, then the mobile app may display transaction details as depicted, for example, in FIG. 49.

The mobile app may provide additional ways to view transaction summaries and receipts. The home page screen of FIG. 38, for example, depicts recent transactions and includes a “view all” option, which, when pressed, may provide additional details such as the exemplary details set forth in the screen of FIG. 50. The mobile app may allow the account holder to click any specific transaction such as in the screen of FIG. 50 to provide transaction receipts such as those depicted in FIGS. 45 and 49. The mobile app may allow account holders to filter the displayed transactions such as by clicking the filter icon in the top right corner of the screen of FIG. 50, which might display a screen similar to that depicted in FIG. 51.

The mobile app may also provide electronic wallet features of this disclosure such as by linking bank accounts. Clicking the gear “settings” icon in the top right corner of the home page screen of FIG. 38 may be configured to display a settings screen similar to the screen depicted in FIG. 52. By clicking on the “linked bank accounts” option in the settings screen, an account holder may view linked bank accounts accessible through the mobile app. FIG. 53 displays such a screen for an account holder who has not yet linked a bank account. The screen of FIG. 53 nevertheless provides a “link a new bank” button to link a new bank account. Clicking the “link a new bank” button displays a screen to initiate the process of linking a bank account such as the screen depicted in FIG. 54. The screen of FIG. 54 includes a search box, which may be used, for example, to search for a specific bank with which the account holder holds a bank account. The screen of FIG. 54 may display, for example, a default list of banks or search results. Clicking on a bank in the screen of FIG. 54 may cause the mobile app to display a login screen such as the screen depicted in FIG. 55. The login screen allows the account holder to enter credentials associated with a user account at the selected bank. After entering valid credentials into the mobile app such as in the screen depicted in FIG. 55, the mobile app may display one or more different bank accounts associated with the user account at the selected bank as depicted, for example, in FIG. 56. The account holder may then select one or more different bank accounts at the selected bank to link to the mobile app. Upon selecting one or more different bank accounts and clicking “save and finish” in the screen of FIG. 56, then the mobile app may redisplay the linked bank accounts page similar to FIG. 53 but with the addition of the linked one or more bank accounts as depicted in FIG. 57, which also displays a popup message stating “Success! New bank account linked to your wallet.”

The mobile app may also allow account holders to link third party bank cards. Clicking the “fund Koin account” button on the home page screen of FIG. 38, for example, may direct the account holder to different funding options as exemplified, for example, in FIG. 58. Clicking the “Debit Card” option in FIG. 58 may direct the account holder to a screen as exemplified, for example, in FIG. 59, which displays “approved cards” as well as debit cards pending verification. The screen of FIG. 59 also depicts an “add new” button, which may be clicked to add a new debit card to the mobile app. Clicking the “add new” button optionally may result in the display of a confirmation screen as exemplified, for example, in FIG. 60, which requests agreement for transactions with a new debit card to allow verification that the account holder actually possess the bank account associated with the debit card. FIG. 60 provides a “yes” button to agree to the transactions, and clicking the “yes” button may result in the display of a screen as depicted, for example, in FIG. 61, which allows the account holder to enter details to identify the debit card including the card number, expiration date, security code (CVV), and the debit card owner name, address, and mobile number. FIG. 61 also depicts a “submit” button to submit the information. Clicking the “submit” button may result in a screen as depicted, for example, in FIG. 62, which confirms that the mobile app identified the debit card and informs the account holder that transactions were initiated to allow verification of the card. The debit card would then optionally be listed as a “pending” debit card such as in the screen depicted in FIG. 59. Clicking on a “pending” debit card may allow the account holder to verify the debit card by identifying amounts of one or more transactions (typically two transactions, which are less than one dollar each) with the debit card by accessing the account records of the debit card and entering the amounts into the mobile app interface such as the interface depicted in FIG. 63. FIG. 63 also includes a “verify” button that the account holder would click after entering the amounts into the mobile app interface, and, if the amounts are accurate, then the mobile app may display confirmation that the debit card was successfully verified as in FIG. 64. The mobile app may then update the debit card screen as depicted in FIG. 59 to list the verified debit card as an “approved card” instead of as a “pending” card as depicted, for example, in FIG. 65. The mobile app might similarly allow the addition of credit cards to the electronic wallet, for example, when a user clicks the “credit card” option in FIG. 58 instead of the “debit card” option.

An account holder may fund the electronic wallet with a debit card or a credit card when allowable, for example, by the issuing institution, gaming jurisdiction, and casino. FIGS. 59 and 65 each feature “select” buttons that allow an account holder to select a specific debit card to fund the electronic wallet of the account holder. Upon clicking “select” for one of the cards, the mobile app may display a screen that allows the transfer of electronic currency from the selected debit card to the electronic wallet as depicted, for example, in FIG. 66. Upon entering the amount to be transferred, the account holder may click the “submit” button as depicted, for example, in FIG. 66, which process the transaction. The mobile app may then display a confirmation page similar to those depicted in FIGS. 44 and 48, or the mobile app may display a transaction receipt as depicted, for example, in FIG. 67. When the issuing institution of a bank card, the gaming jurisdiction, or the provider of the mobile app disallows the funding of the electronic wallet with the debit card (or a credit card), then the mobile app may display an error message as depicted, for example, in FIG. 68, which states, “This payment card isn't eligible for Koin payments. Please select another payment card.”

An account holder may similarly fund the electronic wallet with a bank account. FIG. 69 depicts a bank account screen that is analogous to the screen depicted in FIG. 53 after three bank accounts have been added to the mobile app. The account holder may click on one of the bank accounts of FIG. 69 to fund the electronic wallet with the selected bank account. FIG. 70 depicts a screen analogous to the screen in FIG. 66, which allows the account holder to select an amount of funds to transfer from the bank account into the electronic wallet. After selecting an amount to load and clicking the “submit” button as depicted, for example, in FIG. 70, the mobile app may then display a confirmation page similar to those depicted in FIGS. 44 and 48, or the mobile app may display a transaction receipt as depicted, for example, in FIG. 67.

The mobile app may also allow account holders to fund the electronic wallet with other electronic payment sources such as GooglePay, Apple Pay, and/or Venmo as depicted in FIG. 71, which screen may be accessible, for example, by clicking the “mobile wallet” option in the screen of FIG. 58. Clicking the “Google Pay” option on the screen of FIG. 71 may result in a screen that allows entry of an amount of funds to transfer from GooglePay into the electronic wallet as depicted, for example, in FIG. 72. Upon clicking the submit button in FIG. 72, the mobile app may then open a web browser to process the payment as depicted, for example in FIG. 73. The browser may present one or more confirmation screens depending, for example, upon the software and entity that facilitates a GooglePay transaction, and exemplary confirmation screens are depicted in FIGS. 73-75. After clicking through the one or more confirmation screens, the mobile app may then display a confirmation page similar to those depicted in FIGS. 44 and 48, or the mobile app may display a transaction receipt as depicted, for example, in FIG. 67.

The mobile app may also allow account holders to fund the electronic wallet with Venmo as depicted in FIG. 76, which screen may be accessible, for example, by clicking the “mobile wallet” option in the screen of FIG. 58. Clicking the “Venmo” option on the screen of FIG. 71 may result in a screen that allows entry of an amount of funds to transfer from Venmo into the electronic wallet as depicted, for example, in FIG. 76. Upon clicking the submit button in FIG. 76, the mobile app may then open a Venmo app to process the payment as depicted, for example in FIG. 77. The browser may present one or more confirmation screens depending, for example, upon the Venmo App, and exemplary confirmation screens are depicted in FIGS. 77-79. After clicking through the one or more confirmation screens, the mobile app may then display a confirmation page similar to those depicted in FIGS. 44 and 48, or the mobile app may display a transaction receipt as depicted, for example, in FIG. 67.

The mobile app may also allow account holders to fund the electronic wallet with cash, for example, by clicking the “retail load” option in the screen of FIG. 58. Clicking the “retail load” option may first direct the account holder to a screen that allows entry of an amount of cash to transfer into the electronic wallet as depicted, for example, in FIG. 80. The mobile app may then display nearby locations that can process the transaction such as convenience stores and other brick- and-mortar businesses that generally process transactions on behalf of other entities (such as by selling and activating third-party gift cards) as shown, for example, in FIG. 81. FIG. 81 also provides an option to search for nearby locations by address or zip code. This screen may also provide information about the locations including their names, addresses, and/or distances as well as an optional clickable link to display directions to the locations, for example, by automatically populating an address in a map app of the mobile device running the mobile app. The mobile app may also display a scannable code such as a bar code or QR code as depicted, for example, in FIG. 82. Scanning the scannable code at a retail location allows the retail location to facilitate the transaction by receiving cash payment in the amount of the transaction and communicating the transaction to the operator of the electronic wallet as optionally facilitated by one or more intermediaries that clear the transaction. The mobile app may advantageously be configured to clear the transaction in real time, for example, to provide near instantaneous confirmation of the transaction in the mobile app. The mobile app may then display a confirmation page similar to those depicted in FIGS. 44 and 48, or the mobile app may display a transaction receipt as depicted, for example, in FIG. 67.

The mobile app may also allow the transfer of funds from a casino player's club account or an electronic wallet. The screen of FIG. 38, for example, includes a “send money” option, and clicking the option may direct the mobile app to a screen such as that depicted in FIG. 83, which contains two options, “send to friend” and “send to my bank.” Clicking the “send to my bank” option may result in the display of various bank accounts that are liked to the mobile app as depicted, for example, in FIG. 84. The account holder may select one of the linked bank accounts, which may cause the mobile app to display a screen as depicted, for example, in FIG. 85, which allows the account holder to enter an amount to be transferred from the mobile wallet to the selected bank account. After entering the amount to be transferred and clicking the “continue” button of FIG. 85, the mobile app may display a confirmation screen such as the screen depicted in FIG. 86, which provides details of the contemplated transaction as well as a “send funds” button. Upon clicking the “send funds” button, the mobile app may display a confirmation screen as depicted, for example, in FIG. 87. The mobile app may also cause one or more text messages to be sent as depicted in FIG. 87, to confirm the transaction and optionally to provide a timeframe for the transaction to process. The text message depicted in FIG. 87 states, for example, “Your bank transfer is in transit, please allow up to 3-5 days to process.”

The foregoing description of FIGS. 8-87 and the figures themselves are exemplary and set forth examples of how a mobile app may implement a system and/or electronic wallet of this disclosure to allow for transactions that fund wager gaming, reverse such transactions, and also electronically transfer any winnings back into financial accounts held by a wager gaming player. The system and/or electronic wallet may be configured to only accept funds from sources authorized, for example, by law and to reject funds from sources such as credit cards when a gaming jurisdiction disallows such payments or otherwise. The transfer of funds from the system and/or electronic wallet to a casino's players club account is notably “source agnostic” in that the electronic wallet deidentifies the source(s) of electronic currency transferred into players club accounts. The system and/or electronic wallet also deidentifies the use of funds transferred into the wallet from third-party financial institutions such that account holders may only initiate transactions between linked bank accounts, debit cards, and other external accounts as mediated by the electronic wallet. In some embodiments, the mobile app can therefore be advantageously configured such that third-party financial institutions cannot obtain information as to where the funds transferred into the electronic are used or even if the funds are used for wager gaming or an entirely different purpose. The mobile app also advantageously allows account holders to transfer a limited amount of electronic funds into a casino player's club account, for example, to mimic the limitation imposed by a cash carry such that the account holder can readily identify when funds set aside for wager gaming have been exhausted. The mobile app nevertheless advantageously allows account holders to transfer additional electronic funds into a casino player's club account after an initial tranche of funds has been exhausted without leaving either a game or a casino floor to obtain additional funds, which can increase the enjoyability of a wager gaming experience, for example, by minimizing anxiety associated with managing a finite bankroll of cash. The mobile app also allows account holders to select their preferred funding source(s) prior to wager gaming by loading their electronic wallet at their convenience and then transferring electronic currency back from the electronic wallet into the funding source(s) after completion of the desired wager gaming and other casino-related activity.

The mobile app of this disclosure provides numerous advantages over existing methods to fund wager gaming. First, the account holder need not carry cash to fund wager gaming. Second, when the account holder runs out of funds for wager gaming, then the account holder may transfer additional funds from one or more linked credit cards, debit cards, bank accounts, or other funding sources into a casino player's club account to continue wager gaming without any need to exit a game or leave the casino floor. Third, the casino or a third party may directly extend credit to the account holder through the mobile app based, for example, on financial history associated with the user account on the mobile app rather than requiring a personal interaction with a casino employee to request a marker in view of the limited information available to such casino employees. Fourth, the mobile app may prioritize repayment of any such credit above the transfer of electronic currency into other financial accounts held by the account holder, which can inhibit account holders from circumventing the repayment of utilized credit and enforce responsible gaming. Fifth, the mobile app may allow account holders to transfer any unused casino credit and/or winnings directly from a casino player's club account to the electronic wallet and/or linked accounts, which eliminates interactions with casino personnel at the casino cage as well as a cash carry of winnings thereby minimizing the risk of loss and theft. Sixth, the mobile app allows casinos and their agents to monitor the gaming velocity of an account holder to detect risky patterns in real time and also allows an electronic pinch point to instantaneously throttle or end wager gaming if high-risk activity is detected. Seventh, the mobile app compiles all of the information required for regulatory reporting related to a specific account holder, allows for fully-automated regulatory reporting, and disallows the avoidance of regulatory reporting through structured transactions, which thereby permits robust regulatory compliance and inhibits criminal activity. Eighth, the mobile app compiles data on the gaming activity of specific account holders, which can provide information, for example, to improve direct marketing that incentivizes changes in gaming activity and/or to advertise additional products and services to account holders. Ninth, the mobile app can compile data on gaming activity across account holders, for example, to optimize the financial performance of a casino by incentivizing wager gaming as well as other products and services during off peak hours and by offering similar incentives to drive additional revenue during peak hours. The combined effects of two or more of the foregoing advantages display tremendous opportunities for casinos to reduce risk for themselves and their patrons, reduce overhead, for example, by reducing reliance upon casino personnel to manage, monitor, and secure cash, and increase revenue by informing better marketing and decision making. The combined effects provide similar advantages to casino patrons largely for the same reasons. The combined effects similarly provide tremendous advantages for regulators due to the transparency of financial reporting that digitalization allows. Furthermore, while the mobile app provides these opportunities with a simple software integration into existing CMSs of practically any casino, the systems of this disclosure provide the same advantages and also reduce the friction of user adoption by potentially minimizing or eliminating the need for mobile app functionality.

From the foregoing Detailed Description, it can thus be seen that, in some embodiments, the disclosed system and method provide both a bi-lateral payment gateway and a reporting platform for data and statistics that are measured and/or calculated based upon, for example, (1) transactions mediated by the system and method and (2) accounts held on the system.

In some embodiments, the system and method simultaneously optimize the transfer of electronic currency and allow for the measurement and calculation of statistics that (1) assist with regulatory compliance such as by automatically generating reports required by tax and gaming regulations and/or that (2) assist with supporting responsible gaming such as by automatically identifying changes in the wagering patterns of an individual that prompt action such as one or both of (a) real-time scrutiny of the wagering of the individual and (b) an intervention such as one or more of (i) implementation of a protocol for casino personnel to speak with the individual to assess whether the individual is wagering responsibly, (ii) limiting the magnitude of wagers placed by the individual, (iii) refusing to accept additional wagers from the individual, and (iv) limiting or throttling the amount of currency or other credit that the individual can access for wager gaming.

Some systems, method, and electronic wallet of this disclosure advantageously allow the monitoring of wager gaming activity of a wager gaming player across various platforms, which was previously not viable. Historically, when a wager gaming player was active on various different platforms including, for example, one or more conventional casinos and one or more online sportsbooks, then a single entity was previously unable to effectively track the cumulative wager gaming activity such as cumulative velocity across various platforms. The same entity could only track wager gaming activity on platforms that it controls. What may have appeared to be responsible wager gaming behavior on a single platform might nevertheless constitute risky wager gaming behavior when aggregated across platforms. The electronic wallet of this disclosure may be used across various different wager gaming platforms, which advantageously provides new opportunities to identify cumulative wager gaming behavior across platforms in real time. The system of this disclosure similarly allows the identification of cumulative wager gaming behavior that corresponds to a single system, for example, including a physical casino and online sportsbook associated with the same casino property, as well as the identification of cumulative wager gaming behavior across different systems, for example, when the same mobile app is used to interface with the different systems or when the same entity operates multiple different systems. The electronic wallet, system, and mobile app therefore present new opportunities to monitor cumulative wager gaming behavior, optionally in real time, to better enforce responsible gaming.

A single entity was also previously unable to throttle access to funds and wager games on platforms that it did not control. The electronic wallet and mobile app of this disclosure now provide a pinch point that allows a single entity to throttle access to funds- and therefore access to wager games—in response to the real-time detection of risky wager gaming activity. This innovation provides better solutions, which did not previously exist, to the problem of risky wager gaming. The innovation also anticipates future regulatory requirements to one or both of track wager gaming activity across platforms and throttle access to funds and/or wager games based on wager gaming activity across platforms, for which no means to comply with such future regulatory requirements previously exists. Only the electronic wallet, system, and mobile app of this disclosure allow the development of new regulations to track wagering gaming activity across platforms and throttle access to funds and/or wager games based on wager gaming activity across platforms.

The system, method, electronic wallet, and mobile app also provide new opportunities to identify the consumption habits of a wager gaming player to allow for targeted marketing such as by promotional, rewards, and loyalty programs. Historically, when a wager gaming player was active on various different platforms including, for example, one or more conventional casinos and one or more online sportsbooks, then a single entity was previously unable to effectively track the cumulative wager gaming activity such as cumulative velocity across various platforms. The same entity could only track wager gaming activity on platforms that it controls. What may have appeared to be nominal wager gaming behavior on a single platform might nevertheless constitute significant wager gaming behavior when aggregated across platforms. The electronic wallet of this disclosure may be used across various different wager gaming platforms, which advantageously provides new opportunities to identify cumulative wager gaming behavior across platforms in real time. The system of this disclosure similarly allows the identification of cumulative wager gaming behavior that corresponds to a single system, for example, including a physical casino and online sportsbook associated with the same casino property, as well as the identification of cumulative wager gaming behavior across different systems, for example, when the same mobile app is used to interface with the different systems or when the same entity operates multiple different systems. The electronic wallet, system, and mobile app therefore present new opportunities to monitor cumulative wager gaming behavior, optionally in real time, to better inform marketing activities.

A single entity was also previously unable to identify wager gaming activity on platforms that it did not control. The electronic wallet and mobile app of this disclosure now allow for data collection across platforms, which can identify, for example, high-value wager gaming players to whom a casino might desire to target with marketing for promotional, rewards, and loyalty programs to attempt to increase their patronage. The electronic wallet or mobile app might identify that a wager gaming player uses a sportsbook of a first platform and wager gaming machines of a second platform; this information is valuable to each platform, which might target the wager gaming player with marketing, for example, of a promotion, a rewards program, or a loyalty program in an attempt to consolidate the wager gaming activity of the player at a single platform. An entity that operates multiple different systems of this disclosure would be capable of identifying similar data.

The electronic wallet and mobile app of this disclosure can also identify trend information that a wager gaming platform may use to increase its business. The electronic wallet or mobile app might identify, for example, that wager gaming players generally use wager gaming machines of a first platform and sportsbooks of one or more different platforms, which might provide reason for the first platform to market its sportsbook to the wager gaming players that already use its wager gaming machines or to improve the experience of its sportsbook. Such information has high value and can provide insights that improve wager gaming experiences generally by identifying platforms that wager gaming players prefer and/or disfavor for various different wager gaming activities. An entity that operates multiple different systems of this disclosure would be capable of identifying similar data.

The system and method generally simplify payment on transactions for both operators of the system and method as well as account holders. In some embodiments, the system and method simplify payment on transactions by creating a single account or electronic wallet from which an individual account holder may draw. In some embodiments, an account holder may fund the single account or electronic wallet from various external accounts prior to use and distribute one or both of remaining funds and gaming winnings from the single account or electronic wallet back to the various external accounts at a later time, which obviates decision-making regarding a source of funds to use when entering into a transaction because an external source of funds may be selected prior the transaction- and prior to even contemplation of the transaction by the consumer. The system and method may also advantageously allow deferral of decision-making regarding a source of funds, for example, by settling a transaction against an account that allows subsequent settlement against an external source of funds. An account holder may maintain a deposit balance or available credit associated with a system account or electronic wallet, for example, from which the account holder may draw to settle a transaction and then subsequently replenish the balance or pay back the credit. The system account or electronic wallet may allow include “buy now pay later” features, for example, which allow account holders to access an amount of credit from which an account holder may draw and subsequently repay. The system account may also allow an overdraft product, for example, which allows an account holder to access an amount of gaming credit as requested by the account holder even if that amount is unavailable from authorized external funding sources. The system may advantageously block cash-out events from transferring electronic currency back into an external funding source until after the overdraft product or “buy now pay later” credit is repaid. The reduction of real-time decision-making regarding funding of transactions improves the experience of consumers in an environment such as a casino, for example, because the consumers may focus their attention on their entertainment, desirable consumption, and their wager gaming experience while minimizing distraction created by managing one or more of cash, casino tokens, and bank cards. The reduction of real-time decision making reduces friction associated with transactions, which generally increases the speed and likelihood of a transaction and therefore generally increases the number of transactions and associated revenue.

In some embodiments, the system and method simplify payment on transactions for operators of the system and method by allowing prior validation of funds available to an account holder and credit-worthiness of the account holder prior to entering into a transaction. A system account, for example, may be linked to one or more of an electronic wallet of this disclosure and third-party funding sources, which linkage may advantageously disclose to the system operator one or both of external funds and external credit that are available to an account holder from the electronic wallet and third-party funding sources.

The systems and methods of this disclosure generally enhance the security of electronic funds transfer beyond ordinary bank card transactions. The system and method are generally configured, for example, to verify the identity of an account holder both to access one or more external accounts and to create an account on the system, which verification process is generally more rigorous than simply using a credit card. Security is enhanced by the relationship between the account holder and the system operator, for example, because account holders are generally patrons of a casino, hotel, spa, and/or resort associated with the operator, and the relationship fosters interactions that verify and corroborate the identity of the account holder such as interactions involving a player's club account, hotel reservations, spa appointments, and resort use. Security is also enhanced by co-localization of the system with products and services that may be purchased with a system account; a consumer generally must be physically present in a casino, for example, to play wager games in the casino, a consumer generally must be physically present in a hotel to benefit from a hotel room, a consumer generally must be physically present in a spa to benefit from products and services offered by the spa, and a consumer generally must be physically present at a resort to enjoy the environment of the resort.

The enhanced security of the systems and methods of this disclosure mitigate the need for real-time security precautions such as fraud prevention during transactions that occur over the system, for example, which improves consumer experience by alleviating casino personnel from heightened vigilance that was historically required to ensure the integrity of the payment process. Upon receiving cash, for example, casino personnel must simultaneously ensure that the cash does not include counterfeit currency, accurately count the cash, and securely manage the cash, which necessarily distracts their attention away from optimizing and personalizing the experience of the cash-paying consumer. Upon receiving a bank card for payment, casino personnel must verify that the bank card processor approves the transaction and attempt to identify situations in which a consumer might not match the account holder named on the bank card, which distracts their attention away from optimizing and personalizing the experience of the bank-card-paying consumer. Bank-card transactions that require a third-party processor generally require an internet connection to verify the transactions, and one or both of internet disruptions and processor disruptions may slow the verification process. The risk reduction fostered by the systems and methods of this disclosure allows greater confidence in the integrity and validity of a payment, which allows casino personnel to devote the short period of time that they spend assisting consumers with transactions to optimizing consumer experience rather than ensuring the integrity and validity of the payment. Consumers may similarly feel compelled to monitor cash given to casino personnel or to monitor their bank cards and card-processing machines while a third-party processor electronically verifies payment such as by watching messages on a card-processing machine while the machine processes a transaction, which deteriorates the experience of a purchase or game play. The streamlining and risk reduction allowed by the systems and methods of this disclosure provide opportunities to alleviate consumers from transaction-based vigilance and any associated anxiety, which also improves consumer experience. The combination of improved opportunities for casino personnel to optimize and personalize consumer experience during transactions and the mitigation of transaction-associated vigilance and anxiety that a consumer might ordinarily experience synergistically combine to improve the quality of experience perceived by consumers during transactions mediated by the systems and methods of this disclosure. The improved quality of the experience of transactions fosters additional transactions, which generally increases revenue.

Account holders may advantageously fund wager gaming and make other purchases with conventional credit cards and bank cards as meditated, for example, by magnetic strips, EMV chips (“Europay, Mastercard, and Visa′ chips), RFID (radio-frequency identification) credentials, NFC (near-field communication) credentials, UWB (ultra-wideband) credentials as well as the tap to pay features of a mobile device. The inventors contemplate that current and future regulatory environments will generally require a system of this disclosure to mediate transactions that fund wager gaming using the methods of the immediately-preceding sentence, for example, (1) to maintain an appropriate level of security such that an unauthorized user cannot fund a wager gaming machine with the bank card of another and then cash out the gaming credit into cash or cash equivalents, (2) to track wager gaming activity for regulatory compliance purposes, and (3) to track wager gaming activity to enforce responsible gaming. In some embodiments, a card reader or contactless payment terminal meditates the transaction. In some embodiments, the card reader or contactless payment terminal interfaces with a system of this disclosure such that only the system may process a transaction mediated by the card reader or contactless payment terminal. The card reader or contactless payment reader may optionally interface with a system of this disclosure indirectly, for example, through one or both of a controller and slot machine interface board (SMIB) as described elsewhere in this disclosure. A wager gaming machine may be directly or indirectly associated, for example, with a card reader or contactless payment terminal to allow the card reader or contactless payment terminal to access funds from an external funding source identified by a credit card, debit card, other bank card, or other RFID, NFC, or UWB credentials. In such embodiments, a system account holder generally must login to a system account as described herein to allow the card reader or contactless payment terminal to process payments through the system. In the absence of any alternative functionality to process payments, the card reader or contactless payment terminal are unable to process payments without access to the system as mediated by an active system account of an account holder. This structure therefore only allows account holders to access external accounts as mediated, for example, by a credit card when the account holder has an active system account session, which thereby allows tracking of the transactions of the account holder as may be required for regulatory compliance and/or the enforcement of responsible gaming. The system may advantageously be configured to cross-check system account information of an account holder against external funding source account information of a credit card, debit card, other bank, card, or other RFID, NFC, or UWB credentials, for example, to verify that the account holder is authorized to use the external funding source such as by verifying that the name, zip code, or other identifier of the account holder matches the owner or other authorized user of the external funding source account. In the event that the account information of the system account and owner or other authorized user of the external funding source fail to match, the system may simply decline to process a requested transaction.

Various aspects of this disclosure relate to a wager gaming machine comprising one, two, or each of a RFID, NFC, and UWB reader that is configured to read one, two, or each of RFID, NFC, and UWB credentials, respectively, and that is configured to interface with a system of this disclosure. In some specific embodiments, the wager gaming machine is configured to read one, two, or each of RFID, NFC, and UWB credentials of a payment method such as a credit card, debit card, other bank card, or RFID, NFC, and UWB functionality of mobile device that allows for contactless payments.

The systems and methods of this disclosure generally allow for reduced operating costs for retail sales and other transactions. The systems and methods notably minimize the risks posed by inaccurate cash counting, counterfeit currency, cash management, inefficiencies posed by transactions cleared by third-party banks and processors, and fraudulent bank card transactions, which reduce the risk of loss and therefore reduce associated costs. The systems and methods also reduce the time and attention required by personnel to verify and monitor transactions, which reduces the staff-hours necessary to facilitate transactions and therefore reduces associated costs. The reduction of time necessary to verify and monitor a transaction may be spent on other tasks that create value such as other business operations to allow for better allocation of human resources and corresponding reduced costs.

The systems and methods of this disclosure generally allow for complete regulatory compliance, for example, by providing a single system that records all of the transactions and wager gaming winnings of individual account holders, which allows for automated identification of transactions that require reporting and can also advantageously automatically generate and file required reports.

The systems and methods of this disclosure generally allow for safeguards that foster responsible wager gaming, for example, by automatically monitoring the wagering velocity of individual consumers in real time to identify uncharacteristic or potentially problematic wager gaming by an individual wager gaming player that might prompt scrutiny or remedial action.

The systems and methods of this disclosure are generally configured to integrate directly with one or both of existing casino management systems (CMSs) and existing player account management (PAM) systems, which eliminates operator technical burden in adopting a cashless environment. CMSs generally manage wager gaming machines, live games, daily operations, security systems, and data. CMSs are generally secure, closed networks that allow integration with the systems and methods of this disclosure. In some embodiments, a system of this disclosure is configured to integrate with an existing CMS to provide a single channel to transfer electronic currency into and from an account associated with the CMS, which single channel provides access to a variety of different funding sources including, for example, third-party bank accounts such as checking and/or savings accounts, wager gaming credit accounts such as MarkerTrax™ and/or Moolah™ Play accounts, credit card accounts, and an electronic wallet. In some embodiments, a system of this disclosure is a CMS that is modified (1) to host individual accounts from which individual consumers may draw when entering into transactions facilitated by one or more of wager gaming machines, operators of table wager games, restaurants, hotels, and shops of the casino that operates the CMS and (2) to fund the individual accounts, for example, from sources selected from third-party bank accounts such as checking and/or savings accounts, wager gaming credit accounts such as MarkerTrax™ and/or Moolah™ Play accounts, credit card accounts, and an electronic wallet.

In some embodiments, the systems and methods of this disclosure are configured to integrate with an existing PAM system. PAM systems are generally used to manage online gaming accounts and therefore generally utilize robust data security. Individual accounts on a PAM system are generally only capable of use for wager gaming. In some embodiments, a system of this disclosure is configured to integrate with an existing PAM system to provide a single channel to transfer electronic currency into and from the PAM system, which single channel provides access to a variety of different funding sources including, for example, third-party bank accounts such as checking and/or savings accounts, wager gaming credit accounts such as MarkerTrax and/or Moolah Play accounts, credit card accounts, and an electronic wallet. In some embodiments, a system of this disclosure is a PAM system that is modified such that individual accounts may be used to fund transactions in a secure, closed network of a casino facilitated by one or more of wager gaming machines, operators of table wager games, restaurants, hotels, and shops of the casino, and which allows individual accounts to be funded, for example, from sources selected from third-party bank accounts such as checking and/or savings accounts, wager gaming credit accounts such as MarkerTrax and/or Moolah Play accounts, credit card accounts, and an electronic wallet.

It should be appreciated that systems and aspects of the present specification can be implemented in other environments, including non-wagering environments as well. For example, some embodiments may be implemented in connection with businesses that would like to provide, through these embodiments cashable credit that may be generally useable and trackable credit that can only be used according to certain rules. The rules may include preventing of cashing out or trackable credit and other credit until the trackable credit is paid back to desired entity, such as the account of a funding source that provided the trackable credit. The rules for use of trackable credit may also provide that the latter may only be used for one or more of certain goods or services or of particular locations or businesses, which may be physical or virtual.

The foregoing is a detailed description of some embodiments and aspects of this specification and is not intended to be limiting. Many other embodiments are possible and within the skill of those in the art.

### General Terminology and Interpretative Conventions

Any methods described in this specification should not be interpreted to require the steps to be performed in a specific order unless expressly stated otherwise. Also, the methods should be interpreted to provide support to perform the recited steps in any order unless expressly stated otherwise.

Certain features described in the context of separate implementations can also be implemented in combination in a single implementation. Conversely, various features that are described in the context of a single implementation can also be implemented in multiple implementations separately or in any suitable subcombination. Moreover, although features may be described above in certain combinations and even initially claimed as such, one or more features from a claimed combination can be excised from the combination, and the claimed combination may be directed to a subcombination or variation of a subcombination.

The example configurations described in this document do not represent all the examples that may be implemented or that are within the scope of the claims. The term “example” shall be interpreted to mean “serving as an example, instance, or illustration,” and not “preferred” or “advantageous over other examples.”

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The phrase “based on” shall be interpreted to refer to an open set of conditions unless unequivocally stated otherwise (e.g., based on only a given condition). For example, a step described as being based on a given condition may be based on the recited condition and one or more unrecited conditions.

The terms have, having, contain, containing, include, including, and characterized by should be interpreted to be synonymous with the terms comprise and comprising—i.e., the terms are inclusive or open-ended and do not exclude additional unrecited subject matter. The use of these terms should also be understood as disclosing and providing support for narrower alternative implementations where these terms are replaced by “consisting” or “consisting essentially of.”

Unless otherwise indicated, all numbers or expressions, such as those expressing dimensions, physical characteristics, and the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and by applying ordinary rounding techniques.

What is claimed is:

1. A digital wallet product operable on a mobile device adapted to communicate with a credit transaction system, the digital ewallet product comprising in combination:
at least one non-transitory computer-readable medium having computer-readable program code portions embodied therein, the computer-readable program code portions:
A. provide two-factor authentication by (i) a digital wallet user providing the digital wallet user's login information to a user account provided by a user account provider and (ii) the digital wallet user procuring access through the digital wallet product to a user funding source, the user account providing regulatory compliance information to a third party regulatory entity;
B. configured to:
allow the digital wallet user account provider to reject a wallet funding source identified by the digital wallet product to the digital wallet user's account provider;
identify use of the amount of wallet funding from the or another wallet funding source and not identifying to the wallet funding source the digital wallet users' particular application of the wallet funding;
provide user wager credit from the digital wallet product for use in a third party wager activity provided by a third-party wager activity provider;
when particular wallet funding is used for wagering by the digital wallet user, reverse any remaining unused such particular wallet funding to the particular wallet funding source; and
when winnings for wagering winnings exceed predetermined debt funding, allow the digital wallet user to transfer such exceeding winnings.

2. The digital wallet product of claim 1 also configured to identify to the third party wager activity provider a total of particular digital wallet wager activity by the digital wallet user during a period of time.

3. The digital wallet product of claim 1 also configured to collect data on the digital wallet user for use in marketing to the digital wallet user.

4. The digital wallet product of claim 1 also configured to provide user wager credit from the digital wallet product for use in one or more third party wager activities provided by a third-party wager activity provider at one or more differing physical or virtual wager activity properties.

5. The digital wallet product of claim 1 wherein the user account regulatory compliance information includes a copy of a government-issued identification of the digital wallet user.

6. The digital wallet product of claim 1 wherein the transfer of such exceeding winnings comprises transfer by an actual or virtual document requiring identification of information related to the digital wallet user's user account.

7. A computer program product providing a game payment gateway configured to utilize at least one cashable credit funding source and separately use and track at least one trackable credit funding source, the computer program product comprising:
at least one non-transitory computer-readable medium having computer-readable program code portions embodied therein, the computer-readable program code portions comprising:
a casino management system configuration for storing data for establishing a connection with a casino management system;
a payment connector configured to interface with one or more differing external funding sources including the at least one type of cashable credit funding and the at least one type of trackable credit funding to prevent the at least one type of trackable credit funding from being used contrary to one or more rules unique to the trackable credit funding;
an API router configured to route transactions from the one or more external funding sources and the universal payment connector;
an authentication engine configured to authenticate and establish a secure connection between the payment gateway and the one or more external funding sources;
a cashless gaming interface configured to interface between the gaming provider and the payment gateway;
a mobile application interface configured to allow an account holder to view a system account via a mobile app, the system account including information that corresponds to the account holder;
a reporting engine configured to generate statistics and data derived from one or more API logs and one or more CMS logs and generate one or more reports used to comply with gaming regulations and enforce responsibly gaming by flagging changes in a wager gaming velocity;
a system configuration configured to store the overall configuration of the payment gateway and limit the mobile app interface;
a transaction service configured to include a set of APIs for recording transactions and process transactions between a point of sale of the gaming provider and the one or more external funding sources through the cashless gaming interface;
a control panel configured as a web-based administration for roles and permissions; and
a rules engine configured to determine the priority of a transaction and determine whether a specific external funding source of the one or more external funding sources is usable for a specific transaction.

8. The computer program product of claim 7 wherein a restriction rule unique to the trackable credit funding restricts transfer of trackable credit funding except as permitted by the prevention rule.

9. The computer program product of claim 7 wherein the restriction or another limiting rule allows transfer of winnings credit when trackable credit funding has not been transferred to or for the benefit of the trackable credit funding external funding source.

10. The computer program product of claim 7 wherein the cashless gaming interface comprises a CMS connector detachably communicable with a casino management system.

11. The computer program product of claim 8 wherein the CMS connector is adapted to translate inbound and outbound data.

12. The computer program product of claim 7 wherein the cashless gaming interface of the payment gateway is configured to be communicable with a player's casino club account interface, a casino management system, and a player payment interface and a wager game provided by a casino.

13. The computer program product of 12 wherein a user can initiate a wager game by selecting an external funding source through the player payment interface and thereby have the player payment interface transfer game play credit to the casino management system.

14. The computer program product of claim 13 wherein the external funding source is configured to be any of a debit card account, a credit card account, or a trackable debt credit source.

15. The computer program product of claim 14 wherein the use trackable debt credit from the trackable debt credit source is controlled by a use rule restricting transfer of the trackable debt credit.

16. The computer program product of claim 15 wherein electronic credit is transferred from the external funding source to the casino when the transaction is verified by the player service engine, the rules engine, and the authentication engine of the payment gateway.

17. The computer program product of claim 16 wherein the verified transaction is logged by the reporting engine.

18. A computer program product providing a game payment gateway configured to utilize at least one cashable credit funding source and separately use and track at least one trackable credit funding source, the computer program product comprising:
at least one non-transitory computer-readable medium having computer-readable program code portions embodied therein, the computer-readable program code portions comprising:
a casino management system configuration for storing data for establishing a connection with a casino management system;
a payment connector configured to interface with one or more differing external funding sources including the at least one type of cashable credit funding and the at least one type of trackable credit funding to prevent the at least one type of trackable credit funding from being used contrary to one or more rules unique to the trackable credit funding; and
an API router configured to route transactions from the one or more external funding sources and the universal payment connector.

19. An automated process to transfer funds between a gaming machine and an external account, comprising:
providing a gaming machine that comprises a user interface;
providing a computing network in electronic communication with the user interface, wherein the computing network is configured to process financial transactions;
by the user interface, receiving a login input from a user, wherein the login input logs the person into a casino account;
by the user interface, receiving payment account information from physical storage media, wherein the payment account information provides information to access electronic credit or electronic currency from a funding source selected from a credit account, a bank account, and an electronic wallet, and the user interface receives the payment account information by reading the physical storage media or a wireless transmission thereof;
by the user interface, receiving confirmation of a transaction amount, wherein the user confirms the transaction amount;
by the user interface, automatically transmitting the login input, the payment account information, and the transaction amount from the user interface to the computing network;
by the user interface, automatically receiving confirmation from the computing network that the transaction amount is available for use on the gaming machine;
by the gaming machine, automatically displaying a wager game;
by the gaming machine, receiving instructions to deduct one or more wagers from the transaction amount for use in wagering on the wager game;
by the user interface, receiving cash out instructions, wherein the gaming machine has a remaining balance when the cash out instructions are received;
by the user interface, automatically transmitting the cash out instructions to the computing network;
by the user interface, automatically receiving confirmation from the computing network that an amount of the remaining balance was transferred back to the funding source; and
by the user interface, automatically displaying confirmation that the amount of the remaining balance was transferred back to the funding source.

20. An automated process to comply with financial reporting requirements, comprising:
performing the process of claim 1; and
by the computing network, automatically preparing a document that displays (1) information that identifies the person and (2) one, two, or each of the transaction amount, the remaining balance, and the amount of the remaining balance that was transferred back to the funding source.

21. The automated process of claim 20, comprising, by the computing network, automatically filing the document with a regulator.

22. An automated process to comply with one or more financial reporting requirements, comprising:
performing the process of claim 1 at least twice to result in at least two different performances, wherein the user and the computing network are the same during each performance; and
by the computing network, automatically preparing a document that displays (1) information that identifies the person and (2) one, two, or each of (a) a sum of each transaction amount for each performance, (b) a sum of each remaining balance for each performance, and (c) a sum of each amount of the remaining balance that was transferred back to each funding source for each performance.

23. The automated process of claim 22, comprising, by the computing network, automatically filing the document with a regulator.

24. The automated process of claim 22, wherein the gaming machine is different for at least two different performances.

25. The automated process of claim 24, wherein the casino account is different for at least two different performances.

26. The automated process of claim 24, wherein:
the performances comprise a first performance and a second performance;
a first entity provides the wager game during the first performance;
a second entity provides the wager game during the second performance; and
the wager game of the first performance is different from the wager game of the second performance at least because the wager game of the first performance and the wager game of the second performance are provided by different entities.

27. The automated process of claim 26, wherein:
the first entity is a first casino, and the gaming machine of the first performance is located in the first casino; and
the second entity is a second casino, and the gaming machine of the second performance is located in the second casino.

28. An automated process to enforce responsible gaming, comprising:
performing the process of claim 19;
by the user interface, automatically receiving confirmation of a second transaction amount, wherein the user confirms the second transaction amount subsequent to receiving the confirmation that the transaction amount is available for use on the gaming machine;
by the user interface, automatically transmitting the second transaction amount from the user interface to the computing network;
by the user interface, automatically receiving confirmation from the computing network that the second transaction amount was declined by the computing network; and
by the user interface, automatically displaying a notification that the second transaction amount exceeds a maximum amount that can be transferred by the person.

29. The automated process of claim 28, comprising:
by the computing network, automatically recording a transaction time associated with the transaction amount; and
by the computing network, automatically recording a second request time associated with the second transaction amount,
wherein:
the second transaction amount would not exceed the maximum amount that can be transferred by the person; and
the second transaction amount is declined because a sum of the transaction amount and the second transaction amount exceeds the maximum amount that can be transferred by the person during a period of time that includes both the transaction time and the second request time.

30. An automated process to enforce responsible gaming, comprising:
performing the process of claim 19 to result in a performance;
by the computing network, automatically receiving a second transaction amount from a second user interface of a second gaming machine, wherein the user confirmed the second transaction amount on the second user interface subsequent to receiving the confirmation that the transaction amount is available for use on the gaming machine;
by the computing network, automatically declining the second transaction amount; and
by the computing network, automatically transmitting confirmation to the second user interface that the second transaction amount was declined because the second transaction amount exceeds a maximum amount that can be transferred by the user.

31. The automated process of claim 30, comprising:
during the performance, by the computing network, automatically transmitting a request to a third-party provider to process payment of the transaction amount from the funding source to a recipient account,
wherein:
the computing network does not transmit a request to any third-party provider to authorize payment of the second transaction amount.

32. The automated process of claim 30, comprising:
by the computing network, automatically recording a transaction time associated with the transaction amount; and
by the computing network, automatically recording a second request time associated with the second transaction amount,
wherein:
the second transaction amount alone would not exceed the maximum amount that can be transferred by the user; and
the second transaction amount is declined because a sum of the transaction amount and the second transaction amount exceeds the maximum amount that can be transferred by the user during a period of time that includes both the transaction time and the second request time.

33. The automated process of claim 30, wherein:
an entity provides the wager game during the performance, and
the entity does not provide any wager game on the second gaming machine.

34. The automated process of claim 33, wherein:
the entity is a first casino;
a second casino provides a wager game on the second gaming machine; and
the second casino is different from the first casino.

35. The automated process of claim 19, wherein receiving a login input comprises (1) receiving a players club card or account information stored on the players club card and (2) receiving a password or PIN number.

36. The automated process of claim 19, wherein receiving payment account information from physical storage media comprises one or more of:
reading a magnetic strip of a bank card or prepaid card, wherein the physical storage media is the magnetic strip;
reading an EMV chip of a bank card or prepaid card, wherein the physical storage media is the EMV chip;
reading an RFID or NFC transmission from an RFID or NFC chip of a bank card, prepaid card, fob, or mobile device, wherein the physical storage media is the RFID or NFC chip;
receiving an NFC transmission from an NFC antenna, wherein the physical storage media is media of a mobile device, and the mobile device is in electronic communication with the NFC antenna; and
receiving a UWB transmission from a mobile device, wherein the physical storage media is media of a mobile device, and the mobile device is in communication with the UWB antenna.

37. An automated process to transfer wager gaming funds, comprising:
providing a computing network in electronic communication with a plurality of user interfaces that comprise a user interface of a gaming machine;
by the computing network, automatically receiving payment account information and a transaction amount from the user interface of the gaming machine, wherein the payment account information provides necessary and sufficient information to access electronic credit or electronic currency from a funding source selected from a credit account, a bank account, and an electronic wallet;
by the computing network, automatically transmitting the payment account information, recipient account information, and the transaction amount to a third-party provider to process payment of the transaction amount from the funding source to a recipient account identified by the recipient account information;
by the computing network, automatically receiving confirmation from the third-party provider that the payment has been processed;
by the computing network, automatically transmitting confirmation to the user interface of the gaming machine that the transaction amount is available for use on the gaming machine;
by the computing network, automatically receiving cash out instructions from the user interface, wherein the gaming machine has a remaining balance, and the cash out instructions comprise the remaining balance;
by the computing network, automatically transmitting the payment account information, recipient account information, and an amount of the remaining balance to the third-party provider to process a reverse payment of the amount from the recipient account to the funding source;
by the computing network, automatically receiving confirmation from the third-party provider that the reverse payment has been processed; and
by the computing network, automatically transmitting confirmation to the user interface that the amount of the remaining balance was transferred back to the funding source.

38. An automated process to comply with financial reporting requirements, comprising:
performing the process of claim 19 to result in a performance, wherein a person is logged into the gaming machine during at least a portion of the performance; and
by the computing network, automatically preparing a document that displays (1) information that identifies the person and (2) one, two, or each of the transaction amount, the remaining balance, and the amount of the remaining balance that was transferred back to the funding source.

39. The automated process of claim 37, comprising, by the computing network, automatically filing the document with a regulator.

40. An automated process to comply with financial reporting requirements, comprising:
performing the process of claim 37 at least twice to result in at least two different performances, wherein the computing network is the same during each performance; and
by the computing network, automatically preparing a document that displays one, two, or each of (1) a sum of each transaction amount for each performance, (2) a sum of each remaining balance for each performance, and (3) a sum of each amount of the remaining balance that was transferred back to the funding source for each performance.

41. The automated process of claim 40, comprising, by the computing network, automatically filing the document with a regulator.

42. The automated process of claim 40 wherein the gaming machine is different for at least two different performances.

43. The automated process of claim 42, wherein:
the performances comprise a first performance and a second performance;
a first entity provides one or more wager games on the gaming machine of the first performance;
the first entity does not provide any wager game on the gaming machine of the second performance;
a second entity provides one or more wager games on the gaming machine of the second performance; and
the second entity does not provide any wager game on the gaming machine of the first performance.

44. The automated process of claim 43, wherein:
the first entity is a first casino;
the gaming machine of the first performance is located in the first casino;
the second entity is a second casino; and
the gaming machine of the second performance is located in the second casino.

45. An automated process to enforce responsible gaming, comprising:
performing the process of claim 37 to result in a performance, wherein a person is logged into the gaming machine during at least a portion of the performance;
by the computing network, automatically receiving a second transaction amount from the gaming machine subsequent to transmitting confirmation that the transaction amount is available for use on the gaming machine; and
by the computing network, automatically transmitting confirmation to the gaming machine that the second transaction amount is declined because the second transaction amount exceeds a maximum amount that can be transferred by the person.

46. The automated process of claim 45, comprising:
by the computing network, automatically recording a transaction time associated with the transaction amount; and
by the computing network, automatically recording a second request time associated with the second transaction amount,
wherein:
the second transaction amount alone would not exceed the maximum amount that can be transferred by the person; and
the second transaction amount is declined because a sum of the transaction amount and the second transaction amount exceeds the maximum amount that can be transferred by the person during a period of time that includes both the transaction time and the second request time.

47. An automated process to enforce responsible gaming, comprising:
performing the process of claim 37 to result in a performance, wherein a person is logged into the gaming machine during at least a portion of the performance, and the plurality of user interfaces comprise a second user interface of a second gaming machine;
by the computing network, automatically receiving a second transaction amount from the second gaming machine subsequent to transmitting confirmation that the transaction amount is available for use on the gaming machine; and
by the computing network, automatically transmitting confirmation to the gaming machine that the second transaction amount is declined because the second transaction amount exceeds a maximum amount that can be transferred by the person.

48. The automated process of claim 47, wherein the computing network does not transmit a request to any third-party provider to process payment of the second transaction amount.

49. The automated process of claim 47, comprising:
by the computing network, automatically recording a transaction time associated with the transaction amount; and
by the computing network, automatically recording a second request time associated with the second transaction amount,
wherein:
the second transaction amount alone would not exceed the maximum amount that can be transferred by the person; and
the second transaction amount is declined because a sum of the transaction amount and the second transaction amount exceeds the maximum amount that can be transferred by the person during a period of time that includes both the transaction time and the second request time.

50. The automated process of claim 47, wherein:
an entity provides a wager game on the gaming machine during the performance, and
the entity does not provide any wager game on the second gaming machine.

51. The automated process of claim 50, wherein:
the entity is a first casino;
a second casino provides a wager game on the second gaming machine; and
the second casino is different from the first casino.

52. The automated process of claim 37, wherein:
the user interface receives the payment account information from physical storage media and then automatically transmits the payment account information to the computing network; and
the physical storage media is selected from a bank card, a prepaid card, and storage media of a fob or mobile device.

53. A system for wager gaming with electronic currency, comprising:
a gaming machine comprising a display for displaying one or more wager games;
a user interface in electronic communication with the gaming machine, wherein the user interface is configured to receive a login input that logs a person into a casino account, and the user interface is configured to receive payment account information from physical storage media; and
a controller in electronic communication with the user interface, wherein the controller is configured to interface with a computing network to process payments made.

54. The system of claim 53, wherein the user interface comprises a credit card reader that is configured to one, two, three, four, or each of:
read a magnetic strip of a bank card or prepaid card, wherein the physical storage media is the magnetic strip;
read an EMV chip of a bank card or prepaid card, wherein the physical storage media is the EMV chip;
read an RFID or NFC transmission from an RFID or NFC chip of a bank card, prepaid card, fob, or mobile device, wherein the physical storage media is the RFID or NFC chip;
receive an NFC transmission from an NFC antenna, wherein the physical storage media is media of a mobile device, and the mobile device is in electronic communication with the NFC antenna; and
receive a UWB transmission from a mobile device, wherein the physical storage media is media of a mobile device, and the mobile device is in communication with the UWB antenna.

55. The system of claim 53, wherein the user interface comprises a card reader.

56. The system of claim 53, wherein the computing network comprises a reporting computer that comprises a processor and storage media that stores instructions that, when executed, cause the processor to prepare a document that compiles information regarding one or more transactions processed by the computing network based on payment account information received from the user interface.

57. The system of claim 56, comprising the reporting computer.

58. The system of claim 56, wherein:
the computing network is in electronic communication with a plurality of controllers;
the plurality of controllers comprises the controller;
each controller of the plurality of controllers is in electronic communication with at least one gaming machine such that the plurality of controllers is in electronic communication with a plurality of gaming machines;
the plurality of gaming machines comprises the gaming machine;
the plurality of gaming machines are in electronic communication with a plurality of user interfaces such that each gaming machine of the plurality of gaming machines is in electronic communication with at least one user interface of the plurality of user interfaces, wherein each user interface is configured to receive a login input that logs a person into a casino account, and each user interface is configured to receive payment account information from physical storage media; and
when executed, the instructions cause the processor to prepare a document that compiles information regarding transactions processed by the computing network based on payment account information received from multiple different user interfaces of the plurality of user interfaces.

59. The system of claim 58, wherein the reporting computer is in electronic communication with the world wide web such that the computing network can transmit the document to a regulator.

60. The system of claim 53, wherein:
the computing network comprises a payment computer;
the payment computer is in electronic communication with the world wide web;
the payment computer comprises a processor and storage media that stores instructions that, when executed by the processor, cause the processor to transmit the payment account information and a transaction amount over the world wide web to a third-party provider to process payment of the transaction amount from a funding source identified by the payment account information to a recipient account.

61. The system of claim 60, comprising the payment computer.

62. The system of claim 35, wherein the computing network comprises a rules computer comprising a processor and storage media that stores instructions that, when executed by the processor, cause the processor to either process a payment or decline to process a payment.

63. The system of claim 62, wherein:
when executed, the instructions cause the processor to process a first transaction amount from a funding source identified by the payment account information; and
when subsequently executed, the instructions cause the processor to decline to process a subsequent transaction amount from the funding source.

64. The system of claim 63, wherein:
when executed during a period of time, the instructions cause the processor to process a first transaction amount from a funding source identified by the payment account information; and
when subsequently executed during the period of time, the instructions cause the processor to decline to process a subsequent transaction amount from the funding source because a sum of the first transaction amount and the subsequent transaction amount exceeds a maximum amount that can be transferred by a single user during the period of time.

65. The system of claim 53, wherein the gaming machine comprises the user interface.

66. A game payment gateway system configured to track and report game related activity and funding including from a plurality of funding sources, comprising in combination:
at least one non-transitory computer-readable medium having computer-readable program code portions embodied therein, the computer-readable program code portions comprising:
a casino management system configuration storing configuration data for CMS communication between the game payment gateway system and a casino management system;
a payment connector providing an interface for funding information between the game payment gateway system and the plurality of funding sources; and
a reporting engine providing gaming regulatory reporting on a jurisdictional basis and game vertical basis;
a rules engine providing money laundering and user identity regulatory compliance; and
a rules and reporting engine tracking and reporting the game related funding sources.

67. The game payment gateway system of claim 66 wherein the game related activity and funding includes wager game related activity and funding.

68. The game payment gateway system of claim 66 wherein the game related funding includes trackable loan credit and untracked loan credit, whereby the transfer of trackable loan credit can be restricted.
